(19) United States
(12) Patent Application Publication
(10) Pub. No.: US 2023/0191364 A1
(43) Pub. Date: Jun. 22, 2023

(54) FUNCTIONAL CARBON MATERIALS AND METHODS OF MAKING THE SAME

(71) Applicant: The University of Southern Mississippi, Hattiesburg, MS (US)

(72) Inventors: Zhe Qiang, Hattiesburg, MS (US); Mark Robertson, Hattiesburg, MS (US); Paul Smith, Hattiesburg, MS (US)

(73) Assignee: The University of Southern Mississippi, Hattiesburg, MS (US)

(21) Appl. No.: 18/112,446

(22) Filed: Feb. 21, 2023

Related U.S. Application Data
(63) Continuation-in-part of application No. 17/848,342, filed on Jun. 23, 2022.
(60) Provisional application No. 63/311,804, filed on Feb. 18, 2022.
(60) Provisional application No. 63/214,145, filed on Jun. 23, 2021.

(51) Int. Cl. B01J 20/20; B82Y 40/00; B82Y 35/00; B01J 20/28; B01J 20/30

(52) U.S. Cl. CPC B01J 20/205; B82Y 40/00; B82Y 35/00; B01J 20/28061; B01J 20/28083; B01J 20/28095; B01J 20/3078; B01J 2220/4812

(57) ABSTRACT

Carbon materials formed using various templates of precursor materials are described in addition to method and process for producing the same.

### CROSS-REFERENCE TO RELATED APPLICATION

This application claims priority to U.S. application Ser. No. 17/848,342 to Zhe Qiang et al. filed on Jun. 23, 2022, which claims priority to U.S. Provisional Application No. 63/214,145 to Zhe Qiang et al. filed on Jun. 23, 2021, and to U.S. Provisional Application No. 63/311,804 to Zhe Qiang et al. filed on Feb. 18, 2022. The contents of these applications are incorporated herein by reference in their entirety.

### FIELD

The present subject matter generally relates to functional carbon materials, namely a sulfonated and carbonized carbon material, and a method of making the same.

### BACKGROUND

Porous carbon has been used across many applications such as water purification, CO₂ capture, supercapacitors and battery technologies. Generally, increasing the specific surface area and pore volume of porous carbons make them more effective in their applications. For instance, increased pore volume and surface area allows for CO₂ to interact with more sites within a porous carbon matrix, resulting in greater amounts of CO₂ being captured by the carbon sorbents, and more efficiently scrubbing commercial production process streams. Highly porous carbon with large pore volumes has been synthesized through a variety of techniques with varied starting materials. These processes typically involve costly processing steps or starting materials that are expensive, making these materials difficult to produce at a commercially-relevant scale. Additionally, methods of enhancing the pore characteristics, such as activation, typically involve harsh chemicals and additional processing steps.

Current methods for synthesizing porous carbon materials for CO₂ capture often involve complex or specialized starting materials, such as metal-organic frameworks or activation procedures that can involve many steps and harsh chemicals like potassium hydroxide (KOH). While it has been shown previously that sulfonating polymers, such as polyethylene, through exposure to sulfuric acid can allow these materials to be converted to carbons, such carbon materials are only produced with a two-step sulfonation treatment.

Moreover, carbon materials are important and commonly used across a variety of high-performance industries, including the automobile, additive manufacturing (e.g., 3D printing), and aerospace industries. Their ability to provide durability while being lightweight makes carbon composites potential alternatives to heavier metal counterparts. Currently, carbon fibers are mostly made from relatively expensive precursors (polyacrylonitrile) and require multiple energy-intensive steps for fabrication, hindering the ability to produce low-cost carbon fibers.

### BRIEF DESCRIPTION

According to some aspects of the present disclosure, a structure comprising one or more carbonized materials having a shape based on a polymer based template structure and formed of a chemical compound having the structure shown in FIG. 34, wherein each carbonized material has been crosslinked and has an average pore size diameter of about 10 nm to about 50 nm.

According to some aspects of the present disclosure, a structure comprising one or more carbonized materials each formed of a chemical compound having the structure shown in FIG. 35, wherein each of the carbonized materials is retains a shape and structure of a template material, wherein each carbonized material has a pore structure comprising an average surface area greater than about 200 m²/g.

According to some aspects of the present disclosure, a method of manufacturing carbonized materials comprising the steps of preparing a precursor material, sulfonating the precursor material at a temperature of about 140° C. to about 160° C. to form a sulfonated material for about 2 hours to about 12 hours, and carbonizing the precursor material at a temperature of about 600° C. to about 800° C. to form a carbonized material.

These and other features, aspects, and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 illustrates a scheme that outlines the processing steps for the development of highly porous carbon materials using mask as templates.

FIG. 2 is a graphical representation of preliminary data of nitrogen adsorption isotherms of carbonized materials as a function of resol-content present in a solution used for coating an initial structure template.

FIG. 3 depicts SEM micrographs of pristine surgical mask fibers and mask fibrous structures after sulfonation and carbonization using a method disclosed herein.

FIG. 4A depicts a demonstration of the flexibility of a neat surgical mask.

FIG. 4B depicts a demonstration of the flexibility of a deformed carbonized surgical mask.

FIG. 4C depicts a demonstration of the flexibility of a carbonized surgical mask after deformation illustrating the retention of the shape of the carbonized surgical mask.

FIG. 5 is a graphical representation of results of a thermogravimetric analysis (TGA) (under N₂ atmosphere) for sulfonated masks after exposure for 0 hours, 4 hours, 6 hours, and 10 hours.

FIG. 6 is a graphical representation of mass gain of an initial structure formed of polypropylene (PP) masks as a function of sulfonation reaction time at 155° C.

FIG. 7 is a graphical representation of an FTIR spectra of sulfonated structures at various reaction times where peaks are highlighted to monitor reaction progression.

FIG. 8 is a schematic depiction of conversion of an initial polymer to a sulfonated carbonized material via a crosslinking mechanism of polypropylene that is initiated through a sulfonation step which is followed by olefination and subsequent addition/rearrangement.

FIG. 9A illustrates a fibrous structure of an initial structure prior to sulfonation.

FIG. 9B illustrates a fibrous structure of an initial structure after 2 hours of sulfonation.

FIG. 9C illustrates a fibrous structure of an initial structure after 12 hours of sulfonation.

FIG. 10 is a graphical representation of TGA thermograms of pristine PP initial structures and sulfonated PP structures (from masks) after different crosslinking times.

FIG. 11 illustrates an SEM image of carbonized fibers after 2 hours of sulfonation, leading to the decomposition of the unreacted center portions of the fiber. The inset image depicts a hollow fiber which results from insufficient crosslinking.

FIG. 12 illustrates an SEM image of carbonized fibers after 12 hours of sulfonation which results in complete crosslinking, and continuous fibers.

FIG. 13 is a graphical representation of EDAX mapping of carbon element of carbonized fibers after 12 hours of sulfonation.

FIG. 14 is a graphical representation of EDAX mapping of sulfur element of carbonized fibers after 12 hours of sulfonation.

FIG. 15 is a graphical representation of an XPS spectrum of carbonized fibers after 12 hours of sulfonation.

FIG. 16 is a graphical representation of Raman spectroscopy employed to characterize the degree of graphitization of carbonized fibers.

FIG. 17 is a graphical representation of nitrogen adsorption-desorption isotherm of carbonized fibers.

FIG. 18 is a graphical representation of hysteresis that occurs at the partial pressure range from 0.6 to about 1.0 for carbonized fibers.

FIG. 19 is a graphical representation of associated pore size distribution determined using the Barrett, Joyner and Halenda (BJH) model.

FIG. 20 is a graphical representation of temperature of a carbonized material as a function of voltage.

FIG. 21A illustrates a water angle measured from carbonized materials.

FIG. 21B illustrates a water angle measured from carbonized materials exposed to chloroform.

FIG. 22 is a graphical representation of oil uptake capacity of the carbonized mask fibers given as gram of sorbate per gram of sorbent.

FIG. 23 is a graphical representation of cycling performance of the oil adsorption performed by adsorbing chloroform, heating to remove the sorbate, and repeating this process for 5 cycles.

FIG. 24 is a graphical representation of N₂ adsorption isotherm of carbonized mask fibers after the activation process.

FIG. 25 is a graphical representation of dye adsorption study at a concentration of 0.15 mg/mL investigating the adsorption capacities as a function of time of activated carbon fibers compared to powder activated carbon (PAC).

FIG. 26 is a graphical representation of FTIR spectra of crosslinked polypropylene fibers with increasing sulfonation time.

FIG. 27 is a graphical representation of an XPS survey scan of crosslinked polypropylene fibers with increasing sulfonation time.

FIG. 28 is a graphical representation of a carbon yield of crosslinked polypropylene fibers with increasing crosslinking time.

FIG. 29A is a graphical representation of N₂ adsorption isotherm of carbonized mask fibers after 2 hours of crosslinking time.

FIG. 29B is a graphical representation of N₂ adsorption isotherm of carbonized mask fibers after 4 hours of crosslinking time.

FIG. 29C is a graphical representation of N₂ adsorption isotherm of carbonized mask fibers after 6 hours of crosslinking time.

FIG. 30 is a graphical representation of XPS survey scan spectra and heteroatom content of oxygen and sulfur in carbonized fibers with varying crosslinking times.

FIG. 31A is a graphical representation of high resolution XPS spectra and fitting results of carbon of carbon fiber masks, initially crosslinked for 6 hours.

FIG. 31B is a graphical representation of high resolution XPS spectra and fitting results of oxygen of carbon fiber masks, initially crosslinked for 6 hours.

FIG. 31C is a graphical representation of high resolution XPS spectra and fitting results of sulfur of carbon fiber masks, initially crosslinked for 6 hours.

FIG. 32 is a graphical representation of a CO₂ adsorption isotherm at room temperature of carbonized mask fibers, which were crosslinked after varying time.

FIG. 33 illustrates a scheme that outlines the processing steps for the development of highly porous, ordered mesoporous carbon materials (OMCs).

FIG. 34 illustrates changes in chemical structure of polystyrene-block-poly(ethylene-ran-butylene)-block-polystyrene (SEBS) materials through sulfonation, crosslinking, and carbonization.

FIG. 35 illustrates a scheme that outlines the processing steps for the development of carbonized materials derived from printed initial structures and the corresponding chemical structures of each stage.

FIG. 36 illustrates a scheme that outlines the processing steps for the development of carbonized materials have PP-CF as a precursor.

FIG. 37 is a graphical representation of FTIR spectra for pristine SEBS of an initial structure, SEBS after sulfonation for 30 minutes, and SEBS after sulfonation for 2 hours.

FIG. 38 is a graphical representation of nitrogen adsorption isotherms of SEBS and OMCs derived from SEBs.

FIG. 39 is a graphical representation of the uniform pore distribution of the OMCs derived from SEBS.

FIG. 40 is a graphical representation of mass gain and gel fraction of a SEBS material sulfonated at 150° C. as a function of sulfonation time.

FIG. 41 is a graphical representation of mass gain and gel fraction of a SEBS material sulfonated at 85° C. as a function of sulfonation time.

FIG. 42 is a graphical representation of mass gain and gel fraction of a SEBS material sulfonated at 125° C. as a function of sulfonation time.

FIG. 43 is a graphical representation of FTIR spectra of a SEBS material as a function of sulfonation time.

FIG. 44 is a graphical representation of FTIR spectra of a SEBS material as a function of sulfonation time.

FIG. 45 is a graphical representation of FTIR spectra of a SEBS material as a function of sulfonation time.

FIG. 46 is a graphical representation of FTIR spectra of a SEBS material sulfonated at 85° C. for 6 hours.

FIG. 47 is a graphical representation of FTIR spectra of a SEBS material sulfonated at at 125° C. for 12 hours.

FIG. 48 is a graphical representation of degree of sulfonation of a SEBS material as a function of sulfonation time.

FIG. 49 is a graphical representation SAXS patterns of a SEBS material as a function of crosslinking time at 150° C.

FIG. 50 is a graphical representation of SAXS patterns of a SEBS material as a function of crosslinking time at 150° C.

FIG. 51A is a graphical representation of domain spacing of a SEBS material as determined by the SAXS pattern of FIG. 49.

FIG. 51B is a graphical representation of cylinder diameter of a SEBS material as determined by the SAXS pattern of FIG. 49.

FIG. 52 is a graphical representation of TGA results calculated up to a temperature of 800° C. in N₂ atmosphere for samples of a neat SEBS material, sulfonated homopolymer polystyrene, and a crosslinked SEBS material

FIG. 53 is a graphical representation of FTIR spectra of the samples of FIG. 49.

FIG. 54 is a graphical representation SAXS patterns of a samples of calcinated SEBS material and carbonized SEBS materials.

FIG. 55 is a graphical representation of nitrogen adsorption isotherms of the samples of

FIG. 53.

FIG. 56 is a graphical representation of pore width and surface area of the samples of FIG. 53.

FIG. 57A is a graphical representation of nitrogen physisorption isotherms of SEBS-derived OMCs which were sulfonated for 1 hour, 2 hours, and 3 hours.

FIG. 57B is a graphical representation of pore size distribution of the SEBS-derived OMCs of FIG. 57A.

FIG. 57C is a graphical representation of TGA thermograms of sulfonated SEBS materials used to calculated the values shown in FIGS. 57A and 57B.

FIG. 58A is a graphical representation of pore size distribution determined using nitrogen physisorption and NLDFT models for SEBS-based materials calcinated and carbonized at a temperature of 400° C.

FIG. 58B is a graphical representation of pore size distribution determined using nitrogen physisorption and NLDFT models for SEBS-based materials calcinated and carbonized at a temperature of 800° C.

FIG. 58C is a graphical representation of pore size distribution determined using nitrogen physisorption and NLDFT models for SEBS-based materials calcinated and carbonized at a temperature of 1000° C.

FIG. 58D is a graphical representation of pore size distribution determined using nitrogen physisorption and NLDFT models for SEBS-based materials calcinated and carbonized at a temperature of 1200° C.

FIG. 59 is a graphical representation of raman spectra of an SEBS-based OMC carbonized at 800° C.

FIG. 60A is a graphical representation of FTIR spectra for an initial SEBS89 material structure and of the SEBS89 material structure after crosslinking.

FIG. 60B is a graphical representation of FTIR spectra for an initial SEBS100 material structure and of the SEBS100 material structure after crosslinking.

FIG. 60C is a graphical representation of FTIR spectra for an initial SEBS130 material structure and of the SEBS130 material structure after crosslinking.

FIG. 61A is a graphical representation of a TGA thermogram for a SEBS89 material structure after crosslinking.

FIG. 61B is a graphical representation of a TGA thermogram for a SEBS100 material structure after crosslinking.

FIG. 61C is a graphical representation of a TGA thermogram for a SEBS130 material structure after crosslinking.

FIG. 62A is a graphical representation of an SAXS profile of SEBS89-derived OMCs.

FIG. 62B is a graphical representation of an SAXS profile of SEBS100-derived OMCs.

FIG. 62C is a graphical representation of an SAXS profile of SEBS130-derived OMCs.

FIG. 63A is a graphical representation of a nitrogen sorption isotherm of SEBS89-derived OMCs.

FIG. 63B is a graphical representation of an SAXS profile of SEBS100-derived OMCs.

FIG. 63C is a graphical representation of an SAXS profile of SEBS130-derived OMCs.

FIG. 64A is a graphical representation of an SAXS profile of SEBS89-derived OMCs.

FIG. 64B is a graphical representation of an SAXS profile of SEBS100-derived OMCs.

FIG. 64C is a graphical representation of an SAXS profile of SEBS130-derived OMCs.

FIG. 65 is a graphical representation of mass gain and gel fraction of a SEBS material sulfonated at 100° C. as a function of sulfonation time.

FIG. 66 is graphical representation of mass gain and gel fraction of a SEBS material sulfonated at 150° C. as a function of sulfonation time.

FIG. 67 is a graphical representation of FTIR spectra of the material of FIG. 65.

FIG. 68 is a graphical representation of FTIR spectra of the material of FIG. 66.

FIG. 69 is a graphical representation SAXS patterns of a samples of neat polystyrene-block-polybutadiene-block-polystyrene (SBS) materials and SBS materials sulfonated at a temperature of 100° C. for 60 minutes.

FIG. 70 is a graphical representation of a TGA themogram of neat SBS materials, SBS materials sulfonated at a temperature of 100° C. for 60 minutes, and SBS materials sulfonated at a temperature of 150° C. for 20 minutes.

FIG. 71 is a graphical representation of nitrogen physisorption isotherms of samples of SBS materials sulfonated at a temperature of 100° C.

FIG. 72 is a graphical representation of nitrogen physisorption isotherms of samples of SBS materials sulfonated at a temperature of 150° C.

FIG. 73 is a graphical representation of NLDFT calculated pore size distribution of samples of SBS materials sulfonated at a temperature of 100° C.

FIG. 74 is a graphical representation of NLDFT calculated pore size distribution of samples of SBS materials sulfonated at a temperature of 150° C.

FIG. 75 is a graphical representation of XPS survey scans of samples of SBS materials sulfonated at a temperature of 100° C.

FIG. 76 is a graphical representation of XPS survey scans of samples of SBS materials sulfonated at a temperature of 150° C.

FIG. 77A is a graphical representation of high resolution S2p scans of samples of SBS materials sulfonated at a temperature of 100° C.

FIG. 77B is a graphical representation of high resolution S2p scans of samples of SBS materials sulfonated at a temperature of 150° C.

FIG. 78 is a graphical representation of FTIR results showing an initial structure formed from 3D printed materials is completely carbon.

FIG. 79 is a graphical representation of mass uptake of crosslinked PP samples as a function of sulfonation time and temperature.

FIG. 80 is a graphical representation of FTIR spectra of sulfonated PP sample as a function of reaction time at 150° C.

FIG. 81A is a graphical representation of DSC thermograms of sulfonated PP as a function of reaction time at 150° C. with second-heat traces shown.

FIG. 81B is a graphical representation of crystalinity of crosslinked PP samples as a function of sulfonation time and temperature

FIG. 82 is a graphical representation of gel content (remaining mass weight %) of PP crosslinked at 150° C. as a function of time.

FIG. 83 is a graphical representation of carbon yield as a function of sulfonation time and temperature for various model PP parts.

FIG. 84 is a graphical representation of Raman spectroscopy data of a final carbon derived from PP.

FIG. 85A is a graphical representation of an XPS survey scan of a final carbon derivce from PP.

FIG. 85B is a graphical representation of a high resolution XPS spectrum for C1s of a final carbon derivce from PP.

FIG. 85C is a graphical representation of a high resolution XPS spectrum for O1s of a final carbon derivce from PP.

FIG. 85D is a graphical representation of a high resolution XPS spectrum for S2p of a final carbon derivce from PP.

FIG. 86 is a graphical representation of a liquid nitrogen sorption isotherm of PP-derived carbon.

FIG. 87 is a graphical representation of a derive pore size distribution of the PP-derived carbon of FIG. 86.

FIG. 88 is a representative 3D image of a model gyroid specimen with printing directions identified.

FIG. 89 is a graphical representation of dimensional shrinkage and carbon yield of gyroid specimens sulfonated for 48 hours at 150° C. as a function cube size.

FIG. 90 is a graphical representation of dimensional shrinkage and carbon yield of gyroid cube specimens as a function of density of the gyroid structure.

FIG. 91 is a photograph of printed PP parts compared with the same PP parts after carbonization.

FIG. 92 is a graphical representation of mechanical properties of PP-derived carbon along the print, or Z, direction.

FIG. 93 is a graphical representation of a representative stress-strain curve of PP-derived carbon specimen compressed in the X-direction.

FIG. 94 is a graphical representation of Joule heating performance of PP-derived carbon showing time to heat and cool at 10 and 20 W.

FIG. 95 is a graphical representation of Joule heating temperature of the carbon materials of FIG. 93 as a function of supplied power.

FIG. 96 is a graphical

FIG. 97 is a graphical representation of DSC thermograms of 0.2 mm PP-CF model system as a function of sulfonation time.

FIG. 98 is a graphical representation of FTIR absorbance spectra of 0.2 mm PP-CF model system as a function of sulfonation time.

FIG. 99 is a graphical representation of mass gain and degree of crystallinity of PP-CF as a function of sulfonation time at 150° C.

FIG. 100A is a bar chart showing crack-to-crack distance in a sulfonated PP-CF model system.

FIG. 100B is a bar chart showing crack-to-crack distance in a carbonized PP-CF model system.

FIG. 101 is a graphical representation of an FTIR spectrum of PPCF-derived carbon.

FIG. 102 is a graphical representation of Raman spectrum of PPCF-derived carbon with representative disordered (D) and graphitic (G) peaks labeled.

FIG. 103 is a graphical representation of dimensional shrinkage of PP-CF gyroid cubes, dash lines represent unfilled PP shrinkage in the X/Y (22%) and Z directions (9%).

FIG. 104 is a graphical representation of a BET isotherm of PPCF-derived carbon framework.

FIG. 105 is a graphical representation of a compressive stress-strain curve of PP-CF derived carbon.

FIG. 106 is a graphical representation of dimensional shrinkage of resulting carbons, converted from PP containing with a variety of GF loading content.

FIG. 107 is a graphical representation of Joule heating performance of PP-CF derived carbon as a function of supplied power.

Repeat use of reference characters in the present specification and drawings is intended to represent the same or analogous features or elements of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

The generation of porous carbon materials can be crucial in a wide range of applications, including batteries, pollutant removal from water sources, catalyst support and CO₂ capture from commercial processes. Disclosed herein are carbon materials formed using a polypropylene surgical mask as a template and applying a combination of crosslinking and carbonization steps to result in porous carbon fibers. Also disclosed herein are carbon materials, specifically ordered mesoporous carbon materials (OMCs) having an average pore size greater than about 10 nm, and a method of forming the same using nanostructured thermoplastic elastomers (TPEs) as precursors. Also disclosed herein are carbon materials formed from 3D printed polypropylene-based structures, including 3D printed structures formed of polypropylene-based filament containing additives (e.g., carbon fiber fillers).

Each method involves using an initial structure formed of precursor material(s) as a template to fabricate resulting, multi-functional carbon materials. The precursor material may be any material having a polyolefin backbone, including but not limited to homopolymers, blended materials, and copolymers. For example, the precursor material(s) may be any one or more of the following: polypropylene (PP), PE, or thermoplastic elastomers (e.g., nanostructured thermoplastic elastomer containing crosslinked polyolefins, polystyrene-block-poly(ethylene-ran-butylene)-block-polystyrene (SEBS), polystyrene-block-polyisoprene-block-polystyrene (SIS), and polystyrene-block-polybutadiene-block-polystyrene (SBS), etc.). The precursor material(s) may include fiber filler or may be free of fiber filler. The initial material or template structure is one of a 3D printed structure, a fiber, a porous scaffold, an injection molded structure, an extruded structure, or a compression molded structure. In various examples, the initial material may be a structured plastic waste, such as polypropylene-based surgical masks or N95 masks. In other examples, the initial material may be a nanostructured thermoplastic elastomer, or structured plastics prepared using fused deposition modeling (FDM) and having a complex 3D shape, such as a gyroid-shape object. In some instances, the printed precursor material may be printed from polypropylene-carbon nanofiber filaments. Using FDM printed shapes allows production of nearly zero-shrinkage, lightweight carbon structures having highly tailorable geometry.

Efficient transformation of polyolefins precursors, such as the precursor materials discussed above, into carbonaceous products, such as the porous carbons disclosed herein, requires thermally stabilizing the polyolefin chains through crosslinking prior to carbonization. Accordingly, each of the methods disclosed herein includes a combination of sulfonation, cross-linking, and carbonization steps to fabricate resulting, multi-functional carbon materials.

In a first method for generating porous carbons having surface areas of about 500 m²/g to about 2500 m²/g and pore volumes of about 5 cm³/g to about 45 cm³/g, the initial structure used is a structured plastic wastes (e.g. nonwoven polypropylene mats) including fibers exhibiting controlled pore sizes and formed of a precursor material such as, for example, polypropylene. This method utilizes stabilization via cross-linking combined with carbonization to convert a coating applied to the precursor materials of the initial structure into porous carbon materials. Specifically, a commercially-available phenolic resin coating, resol, is applied to the initial structure to coat the fibers by submerging the initial structure into a precursor-containing solution, such as a resol-ethanol solution for about 2 minutes. The solvent is then allowed to evaporate from the initial structure, leaving a resol-coated initial structure. The resol-coated initial structure is then cross-linked at about 100° C. to about 150° C. for about 2 hours to about 24 hours and is subsequently carbonized by heating the resol-coated initial structure to a carbonization temperature of about 800° C. at a rate of about 5° C./min. The carbonization temperature is maintained at about 800° C. for about 2 hours.

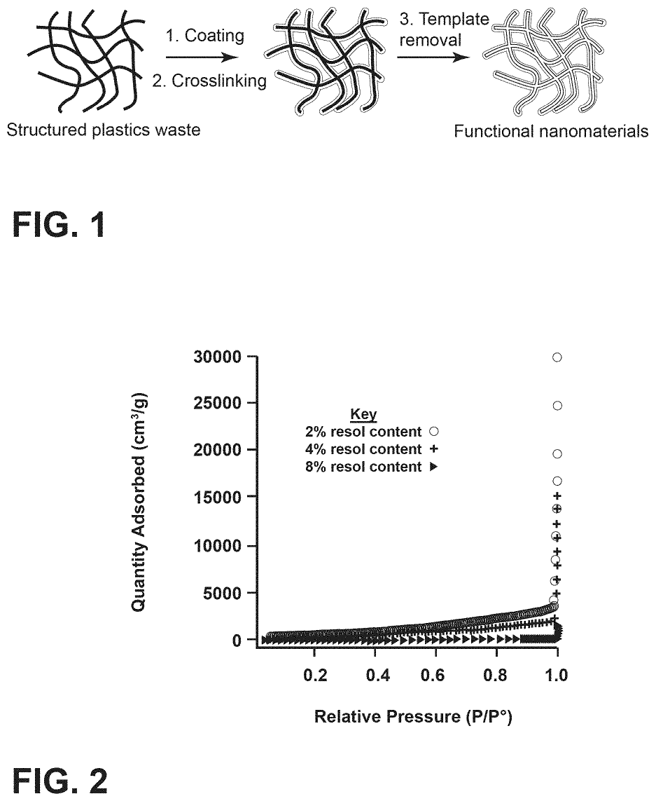

Using structured plastic waste as the initial structure allows the structured plastic waste to act as a template and, when crosslinked and carbonized, the polymers that make up the fibers of the structured plastic waste undergo pyrolysis. As shown in FIG. 1, this transforms the cross-linked resol coated structured plastic waste into hollow fibril materials (also referred to herein as porous carbon fibers) that maintain the original porous structure of the fibers of the structured plastic waste. The hollow fibril materials are formed of the crosslinked resol coating. In various examples, the resulting porous carbon fibers may be functionalized using a doping assembly, an activation process, and/or a co-operative assembly with other polymers and/or inorganic agents. It is contemplated that these porous carbon fibers may be scaled up to large-scale productions. It is further contemplated that the carbonization temperature can be varied to tailor the product to different applications. The porous carbon fibers produced through this technique exhibit a surface area and pore volume that exceeds that of commercially-available porous materials, as discussed in more detail elsewhere herein. Specifically, the carbon fibers or any other carbonized materials produced using this method may have a pore structure having an average surface area of about 500 m²/g to about 2700 m²/g (e.g., about 500 m²/g to about 2500 m²/g, 2500 m²/g to about 2700 m²/g, about 2592 m²/g, etc.) and having an average pore volume of about 5 cm³/g to about 45 cm³/g (e.g., about 40 cm³/g to about 45 cm³/g, about 43 cm³/g, etc.).

The increased surface area and pore volume of the hollow fibril materials may make the resulting hollow fibril materials more efficient in various applications. For instance, increased pore volume and surface area may allow for CO₂ to interact with more sites within a porous carbon matrix, resulting in greater amounts of CO₂ being captured by the fibril materials, and more efficiently scrubbing commercial production process streams. In addition to exhibiting a higher surface area and a higher pore volume as compared to known porous carbons, the resulting porous carbon fibers are produced for a similar cost. Moreover, both the simplicity of the processes and highly affordable starting materials allow the resulting porous carbon fibers to be produced by these methods in amounts that can easily be scaled to larger processes.

In a second method, porous carbons are produced through selective sulfonation and thermal stabilization of matrix species in the precursor materials of the initial structure and degradation of uncrosslinked parts of the polymer domains within the material. The crosslinking mechanism of precursor material is initiated through a sulfonation step which is followed by olefination and subsequent addition/rearrangement. Polyolefin based chains can then crosslink, followed by ring closure and degradation of functional groups at elevated temperatures. This process is shown in FIG. 8, which shows the process of taking a material having a polyolefin backbone and converting the material to a carbonized material having the chemical structure shown in FIG. 8 after carbonization.

The initial structure is generally prepared based on the specific precursor materials included. For example, the initial structure may be thermally stabilized (e.g., through thermal annealing) to prevent deconstruction of the defined structures of the initial structure. The initial structures may further be resized or reshaped (e.g., through trimming), printed, or otherwise prepared.

After the initial structure is prepared, the precursor materials of the prepared initial structure may be crosslinked. Crosslinking the precursor materials may include using a nonvolatile solvent (e.g., concentrated sulfuric acid) to selectively crosslink chemical species of the precursor material, allowing for specific constituents to degrade upon carbonization and the generation of pores.

In some examples, crosslinking may be achieved in conjunction with sulfonation of the prepared initial structure. The prepared initial structure may be submerged in a neat sulfuric acid solution at an elevated sulfonation temperature for one or more extended periods of time and at atmospheric pressures. It is contemplated that other solutions may be used for sulfonation, including fuming acid and diluted sulfuric acid, without departing from the scope of the present disclosure. The elevated sulfonation temperature ranges from about 100° C. to about 200° C. For example, the elevated sulfonation temperature may be about 140° C., about 150° C., about 155° C., about 160° C., about 165° C., about 170° C., about 175° C., about 180° C., about 185° C., about 190° C., about 195° C., about 200° C. or any value or range of values therebetween. The period of time for which the initial structure may be submerged may be about 2 hours, about 6 hours, or about 12 hours. However, it is contemplated that the sulfonation time may range from about 15 minutes to about 72 hours without departing from the scope of the present disclosure. This submersion in the neat sulfuric acid sulfonates the initial structure. After or during sulfonation, the initial structure is stabilized through crosslinking. For example, where the initial structure is a PP-based mask, the sulfonation effectively crosslinks the polypropylene fibers prior to carbonization.

In other examples, the prepared initial structure may be sulfonated at an elevated sulfonation temperature for one or more extended periods of time and at atmospheric pressures. The sulfonated initial structure may then be de-sulfonated. De-sulfonation may include heating in the initial structure to a predetermined de-sulfonation temperature for a period of time. For example, the initial structure may be heated to about 120° C. for about one hour. De-sulfonation eliminates sulfur, oxygen, and hydrogen to yield unsaturated polyolefin, providing the reaction sites for effectively crosslinking the matrix. In various examples, the crosslinked and/or sulfonated structure may be rinsed with water prior to carbonization.

To briefly describe the thermal stabilization mechanism, the initial sulfonation reaction of polypropylene proceeds by reacting with the secondary/tertiary carbons along the polymer backbone, followed by the homolytic dissociations of sulfonyl groups, which results in unsaturated bonds within the polymer chain. These double bonds from sulfonation continue to react through a secondary addition, rearrangement, and dissociation, leading to formation of radical species that directly couple with other reactive groups from surrounding polymer chains, effectively producing crosslinked network structures. These crosslinked polymers can then be converted to carbons upon pyrolysis, potentially stripping away functional groups upon exposure to elevated temperatures in inert atmospheres.

In various examples, the sulfonation-crosslinking step may also impart additional functionality into the carbon fibers, such as inherent incorporation of sulfur heteroatoms into the carbon framework. Sulfur doping of the carbonized materials can enhance the functionality of associated carbon-based materials in many applications, including energy storage, catalysis, and CO₂ adsorption.

The crosslinked and/or sulfonated structure (e.g., a sulfonated polyolefin) is then converted to carbonaceous materials (e.g., porous carbons) using carbonization processes, including without limitation, pyrolysis under N₂. In various examples, the crosslinked and/or sulfonated structure is carbonized by heating the sulfonated structure from an initial temperature to a carbonization temperature at a predetermined rate. The initial temperature may be about 25° C., and the carbonization temperature may be any temperature or temperature range of about 800° C. to about 1400° C. The predetermined rate may have a range of about 1° C./min to about 10° C./min. For example, the predetermined rate may be 5° C./min. In some examples, various rates may be used to reach one or more temperatures during carbonization (e.g., heating the crosslinked and/or sulfonated structure to a first temperature at a first rate and then heating the crosslinked and/or sulfonated structure from the first temperature to a second temperature at a second rate). The carbonization temperature may then be maintained for a predetermined holding time. For example, the carbonization temperature may be maintained for about 2 hours. In general, increasing the carbonization temperatures can enhance the degree of graphitization, which improves the electrical and thermal conductivities, as discussed in more detail elsewhere herein.

Throughout this process, the initial fibril structures of the masks can be completely retained, resulting in a carbon fiber mat with mechanical flexibility. In fact, the resulting carbon fibers exhibit retention of the shape of the initial structure, increased flexibility and durability, and a greater than 50% carbon yield from the initial structure. During the carbonization process, gaseous products are released through the decomposition of the fiber, which may induce porosity, as well as enhanced surface areas. For example, the carbonized fiber or other materials may have a pore structure having an average surface area greater than about 200 m²/g and an average pore volume less than about 1 cm³/g. In some examples, the average surface area may be about 250 m²/g to about 700 m²/g.

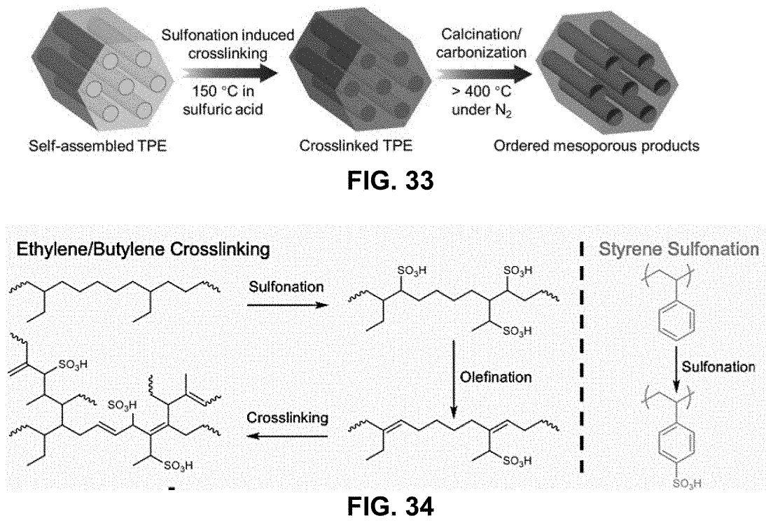

In a third method, at least portions of the second method may be applied to form porous carbons, specifically ordered mesoporous carbons (OMCs), using nanostructured TPEs as precursor materials. For example, due to the immiscibility between different segments, SEBS can self-assemble into nanostructures, including spheres, cylinders, and/or gyroids, that can serve as the starting precursor materials. Then the aggregated PS domains can efficiently serve as physical crosslinkers to enhance the TPE's mechanical properties. Additionally, these block copolymers (BCPs) have higher molecular weights and domain spacing ranging from about 20 nm to about 50 nm, which are larger than typical sizes of surfactant micelles. FIG. 33 shows the process of taking a material having a polyolefin backbone and converting the material to a carbonized material having the chemical structure shown in FIG. 34 after carbonization. This process is simple and scalable and uses low cost, commercially available materials.

The initial structure is generally prepared based on the specific precursor materials included. In various examples, the initial structure may be thermally stabilized (e.g., through thermal annealing) to prevent deconstruction of the defined structures of the initial structure. Where the precursor materials are thermoplastic elastomers, such as SEBS powders, being used to form ordered mesoporous carbons (OMCs), the powders may be treated using thermal annealing at about 160° C. for about 12 hours to obtain long-range ordering of the nanostructures. As previously noted, in various examples, the initial structures may further be resized or reshaped (e.g., through trimming), printed, or otherwise prepared.

After the initial structure is prepared, the precursor materials of the prepared initial structure may be crosslinked. Crosslinking the precursor materials may include using a non-volatile solvent (e.g., concentrated sulfuric acid) to selectively crosslink chemical species of the precursor material, allowing for specific constituents to degrade upon carbonization and the generation of pores. Where the precursor material is a SEBS precursor material, polymer crosslinking may be performed through submerging the SEBS precursor material (e.g., SEBS powders or polystyrene-block-polybutadiene-block-polystyrene (SBS) pellets) in concentrated sulfuric acid for extended periods of time at elevated temperatures.

In some examples, crosslinking may be achieved in conjunction with sulfonation of the prepared initial structure. The prepared initial structure may be submerged in a neat sulfuric acid solution at an elevated sulfonation temperature for one or more extended periods of time and at atmospheric pressures. It is contemplated that other solutions may be used for sulfonation, including fuming acid and diluted sulfuric acid, without departing from the scope of the present disclosure. The elevated sulfonation temperature ranges from about 140° C. to about 200° C. For example, the elevated sulfonation temperature may be about 140° C., about 150° C., about 155° C., about 160° C., about 165° C., about 170° C., about 175° C., about 180° C., about 185° C., about 190° C., about 195° C., about 200° C. or any value or range of values therebetween. The period of time for which the initial structure may be submerged may be about 4 hours, about 6 hours, or about 12 hours. However, it is contemplated that the sulfonation time may range from about 10 minutes to about 72 hours without departing from the scope of the present disclosure. This submersion in the neat sulfuric acid sulfonates the initial structure.

After or during sulfonation, the initial structure is stabilized through crosslinking. For example, the crosslinking reaction may be configured to proceed through multiple mechanisms that occur in tandem throughout the sulfonation process. Initially, sulfonic acid groups are introduced to the polymer backbone, which is followed by elimination to form double bonds. These double bonds react through further additions and dissociations, consequently forming radical species that crosslink the polymer chains through intermolecular radical-radical coupling. The step of using sulfonation-enabled crosslinking to crosslink the initial structure can enable successful conversion to carbon upon exposure to high temperatures (>800° C.) in an inert atmosphere, resulting in a high carbon yield of PP and PE (i.e., up to about 70% wt), as discussed elsewhere herein.

Where the initial structure is formed of a TPE precursor material such as SEBS, the sulfuric acid used creates distinct reactions for PS and PEB blocks, as shown in FIG. 34, forming crosslinked networks while maintaining an ordered nanostructure. Specifically, sulfonation may be configured to selectively crosslink the olefinic block (PEB) of the SEBS forming the initial structure. The PS minority phase in SEBS is also sulfonated during the crosslinking reaction, where sulfonic acid groups can be installed to the aromatic ring of the PS repeat units. While this sulfonation of the PS segment does not contribute to the formation of carbon in the final OMC product, the sulfonation of PS plays an important role in determining the nanostructures of the crosslinked SBS domains, and the derived pores in the resulting OMCs after carbonization. The sulfonation reaction effectively alters the chemical composition of both PS and PEB blocks, thus changing the volume fraction of the PS minority phase. As the sulfonation reaction progresses, PEB crosslinking and the presence of ionic groups on polymer backbones can significantly hinder the polymer chain mobility for structural rearrangement, kinetically trapping the morphology of SEBS after relatively short sulfonation.

In various examples, the sulfonation-crosslinking step may also impart additional functionality into the precursor materials, such as inherent incorporation of sulfur heteroatoms into the carbon framework. Sulfur doping of the carbonized materials can enhance the functionality of associated carbon-based materials in many applications, including energy storage, catalysis, and CO₂ adsorption. Additionally, large-pore mesoporous materials having a range of pore characteristics can be fabricated using this method, as discussed in more detail in Examples #-#. The pore textures and doping content can be altered by varying the processing conditions and precursor identity.

The sulfonated initial structure may then be de-sulfonated. De-sulfonation may include heating in the initial structure to a predetermined de-sulfonation temperature for a period of time. For example, the initial structure may be heated to about 120° C. for about one hour. De-sulfonation eliminates sulfur, oxygen, and hydrogen to yield unsaturated polyolefin, providing the reaction sites for effectively crosslinking the matrix. In various examples, the crosslinked and/or sulfonated structure may be rinsed with water prior to carbonization.

The crosslinked and/or sulfonated structure may be calcinated under an inert atmosphere to selective decompose the PS minority phase to produce mesoporous polymers. The crosslinked and/or sulfonated structure may be heated at a predetermined rate to a calcination temperature for a predetermined amount of time. For example, the crosslinked and/or sulfonated structure may be heated to a temperature of about 400° C. for about 3 hours at a ramp rate of about 10° C./min. In other examples, the crosslinked and/or sulfonated structure may be heated to a temperature of about 600° C.

The crosslinked and/or sulfonated structure (e.g., a sulfonated polyolefin) may be converted to carbonaceous materials (e.g., porous carbons) using carbonization processes, including without limitation, pyrolysis under N₂. It is also contemplated that the crosslinked and/or sulfonated structure may be calcinated as described above before being converted to carbonaceous materials using carbonation processes. The crosslinked and/or sulfonated structure is carbonized by heating the sulfonated structure from an initial temperature to a carbonization temperature at a predetermined rate for a predetermined time. The carbonization temperature may be any temperature or temperature range of about 600° C. to about 1400° C. For example, the carbonization temperature may be about 600° C., about 800° C., about 1000° C., about 1200° C., or about 1400° C. The predetermined rate may have a range of about 1° C./min to about 10° C./min. For example, the predetermined rate may be about 5° C./min or about 10° C./min.

In some examples, various rates may be used to reach one or more temperatures during carbonization (e.g., heating the crosslinked and/or sulfonated structure to a first temperature at a first rate and then heating the crosslinked and/or sulfonated structure from the first temperature to a second temperature at a second rate).The carbonization temperature may then be maintained for a predetermined holding time. For example, the crosslinked and/or sulfonated structure may be heated to a temperature of about 600° C. at a rate of about 1° C./min and then subsequently heated from 600° C. to a second temperature at a ramp rate of about 5° C./min. The second temperature may be, for example, about 800° C., about 1000° C., or about 1200° C. The second temperature may be maintained for a predetermined time such as for about 3 hours or about 4 hours.

The production of OMCs through the third method described herein (e.g., sulfonation induced crosslinking and subsequent carbonization) is simple and scalable and can be extended to a broad selection of SEBS-based precursors. This enables the production of OMCs with multitudes of different pore characteristics. For instance, altering molecular weight of the constituents of the TPEs can produce OMCs with a broad range of pore sizes using the same processing methods. SEBS-derived OMCs to exhibit average pore sizes ranging from 4.7 nm to 16.1 nm, while the surface areas and degree or ordering of the SEBS-OMCs are reduced in comparison to other materials templated by surfactant-based molecules. Specifically, the resulting products have a higher molecular weight than traditional templates which provides enhanced mobility during the evaporation induced self-assembly process to establish well-ordered nanostructures. The increased pore size may enable use of the OMCs.

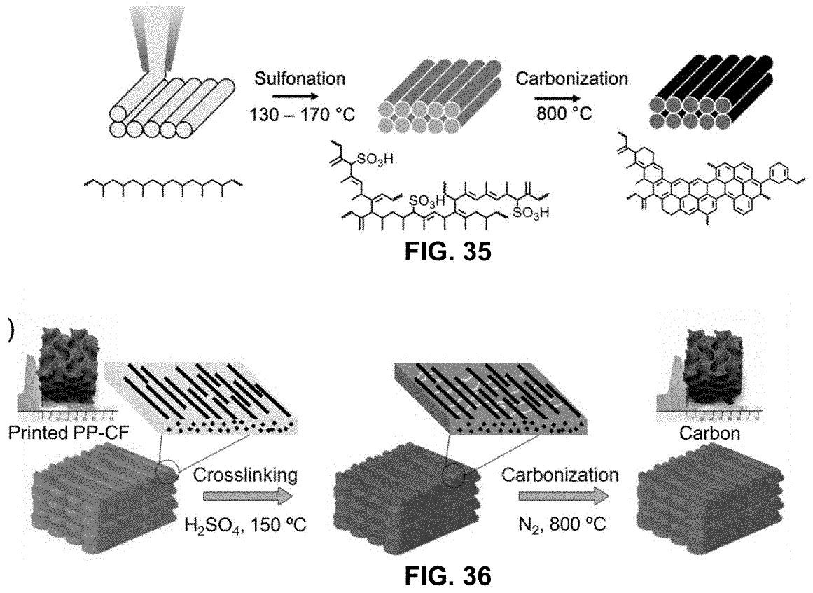

In a fourth method, by combining sulfonation-enabled crosslinking chemistry with a subsequent carbonization step, FDM-printed materials (such as, for example but not limited to, parts printed or otherwise formed using polyethylene, polypropylene, a combination thereof, and/or polypropylene-based filament, containing carbon fiber fillers) can be successfully converted to carbon materials, while retaining dimensional stability. FIG. 35 shows the process of taking a printed material and converting the material to a carbonized material having the chemical structure shown in FIG. 35 after carbonization. FIG. 36 shows a similar process for PP-CF parts. This process is simple and scalable and uses low cost, commercially available materials. Compared to current solutions, this method is highly advantageous due to the use of low-cost, widely available starting materials and 3D printing equipment, combined with simple and scalable manufacturing steps. Moreover, while the conversion of polymers to carbons often results in volumetric shrinkage of samples, the fourth method allows production of complex structure carbon matrices from the commodity PP. This can also be applied to recycled materials, such as plastic cups that have been recycled into PP 3D filament, as discussed in more details elsewhere herein.

The initial structure is generally prepared based on the specific precursor materials included. For example, the initial structure may be thermally stabilized (e.g., through thermal annealing) to prevent deconstruction of the defined structures of the initial structure, may be resized or reshaped (e.g., through trimming), printed, or otherwise prepared. Where the initial structure is prepared using 3D printed structured polypropylene materials as the precursor materials, the initial structure may be printed a 3D printer. The mass of the initial printed structure may be taken after the structure is prepared. In various examples, the PP materials may include carbon fiber filler or other additives (e.g., the materials may be polypropylene-carbon nanofibers). The precursor materials may also be prepared before the initial structure is formed. For example, the precursor materials may be recycled PP filament prepared from plastic waste, such as disposable cups.

After the initial printed structure is prepared, the precursor materials of the prepared initial structure may be crosslinked. Crosslinking the precursor materials may include using a nonvolatile solvent (e.g., concentrated sulfuric acid) to selectively crosslink chemical species of the precursor material, allowing for specific constituents to degrade upon carbonization and the generation of pores. For example, polymer crosslinking may be performed through submerging the printed structure in concentrated sulfuric acid for extended periods of time at elevated temperatures.

In some examples, crosslinking may be achieved in conjunction with sulfonation of the prepared initial structure. The prepared initial structure may be submerged in a neat sulfuric acid solution at an elevated sulfonation temperature for one or more extended periods of time and at atmospheric pressures. The printed structure remains wholly submerged during the entirety of the sulfonation reaction. It is contemplated that other solutions may be used for sulfonation, including fuming acid and diluted sulfuric acid, without departing from the scope of the present disclosure. The elevated sulfonation temperature ranges from about 130° C. to about 170° C. For example, the elevated sulfonation temperature may be about 130° C., about 135° C., about 140° C. , about 145° C., about 150° C., about 155° C., about 160° C., about 165° C., about 170° C. or any value or range of values therebetween. The period of time for which the initial structure may be submerged may be about 48 hours. However, it is contemplated that the sulfonation time may range from about 15 minutes to about 72 hours without departing from the scope of the present disclosure. This submersion in the neat sulfuric acid sulfonates the initial structure.

After or during sulfonation, the initial structure is stabilized through crosslinking. For example, the crosslinking reaction may be configured to proceed through multiple mechanisms that occur in tandem throughout the sulfonation process. Initially, at elevated temperatures sulfuric acid reacts with the PP backbone of the precursor materials, followed by the homolytic dissociations of sulfonyl groups, leading to the formation unsaturated bonds within the polymer chains. Subsequently, alkene groups from sulfonation may continue to react through one or more different mechanisms (e.g., secondary addition, dissociation, and rearrangement), resulting in the formation of radical species that can form crosslinked network structures through intermolecular couplings. This may also lead to some chain scissions of the PP during the sulfonation process. The step of using sulfonation-enabled crosslinking to crosslink the initial structure can enable successful conversion to carbon upon exposure to high temperatures (>800° C.) in an inert atmosphere, resulting in a carbon structure having substantially the same shape as the printed initial structure, as discussed elsewhere herein.

Where the initial structure is a 3D printed structure, the sulfonation process is also configured to create micro-size cracks within the structure. These cracks may have an average crack-to-crack distance of about 100 μm to about 200 μm or any value or range of values therebetween. The cracking of the initial structure allows for diffusion of the sulfuric acid which provides a mechanism for full crosslinking of the structure.

In various examples, the sulfonation-crosslinking step may also impart additional functionality into the sulfonated and/or crosslinked structure, such as inherent incorporation of sulfur heteroatoms into the carbon framework. Sulfur doping of the carbonized materials can enhance the functionality of associated carbon-based materials in many applications, including energy storage, catalysis, and CO₂ adsorption.

The sulfonated and/or crosslinked structure may then be de-sulfonated. De-sulfonation may include heating in the initial structure to a predetermined de-sulfonation temperature for a period of time. For example, the initial structure may be heated to about 120° C. for about one hour. De-sulfonation eliminates sulfur, oxygen, and hydrogen to yield unsaturated polyolefin, providing the reaction sites for effectively crosslinking the matrix. In various examples, the crosslinked and/or sulfonated structure may be rinsed with water prior to carbonization.

The crosslinked and/or sulfonated structure (e.g., a sulfonated polyolefin) may be converted to carbonaceous materials (e.g., porous carbons) using carbonization processes, including without limitation, pyrolysis under N₂. It is also contemplated that the crosslinked and/or sulfonated structure may be calcinated as described above before being converted to carbonaceous materials using carbonation processes. The crosslinked and/or sulfonated structure is carbonized by heating the sulfonated structure from an initial temperature to a carbonization temperature at a predetermined rate for a predetermined time. The carbonization temperature may be any temperature or temperature range of about 600° C. to about 1400° C. For example, the carbonization temperature may be about 600° C., about 800° C., about 1000° C., about 1200° C., or about 1400° C. The predetermined rate may have a range of about 1° C./min to about 10° C./min. For example, the predetermined rate may be about 5° C./min or about 10° C./min.

In some examples, various rates may be used to reach one or more temperatures during carbonization (e.g., heating the crosslinked and/or sulfonated structure to a first temperature at a first rate and then heating the crosslinked and/or sulfonated structure from the first temperature to a second temperature at a second rate).The carbonization temperature may then be maintained for a predetermined holding time. For example, the crosslinked and/or sulfonated structure may be heated to a temperature of about 600° C. at a rate of about 1° C./min and then subsequently heated from 600° C. to a second temperature at a ramp rate of about 5° C./min. The second temperature may be, for example, about 800° C., about 1000° C., or about 1200° C. The second temperature may be maintained for a predetermined time such as for about 3 hours or about 4 hours.

The production of carbon structures through the fourth method described herein (e.g., sulfonation induced crosslinking and subsequent carbonization of a printed structure) is simple and scalable and be used to generate complex, large-scale carbon structures. The fourth method allows PP-to-carbon conversion in thick PP-based structures with controlled dimensional shrinkage. This also produces carbons that may be used as heating elements and allows conversion of plastic waste. Due to the open design space and ease of customizability afforded by FDM, the fourth method has the capacity to create complex structures that can be transformed into carbons, directly enabling the ability of on-demand carbon manufacturing with customized macroscopic structures.

As described in more detail in Examples 1-37, a suite of characterization techniques has been employed to confirm the microstructures and properties of these resulting carbon structures. Furthermore, these microstructures and properties enable potential use of the carbon structures in several practical applications, including 3D-printing, oil sorbents, nanofillers for imparting electrical conductivity and Joule heating behaviors of composites, water purification, and energy storage. It will be understood that these steps may be applied to any initial structure formed of the precursor materials without departing from the scope of the present disclosure.

### EXAMPLE 1

In this Example 1, the initial structure was a structured plastic waste, namely common surgical masks formed of nonwoven polypropylene mats. Samples 1.1-1.3 (“S1.1”, “S1.2”, and “S1.3”, respectively) were taken of the mask. Each Sample was submerged into a precursor-containing solution, a resol-ethanol solution, for about 2 minutes. S1.1 was submerged in a solution containing about 2% resol, S1.2 was submerged in a solution containing about 4% resol, and S1.3 was submerged in a solution containing about 8% resol. The solvent was then allowed to evaporate from the Samples, leaving a resol-coated initial structure. The resol-coated initial structure of each Sample was then cross-linked at about 150° C. for about 2 hours. Each Sample was subsequently carbonized by heating the resol-coated initial structure to a carbonization temperature of about 800 ° C. at a rate of about 5° C./min. The carbonization temperature was maintained at about 800° C. for about 2 hours.

The N₂ adsorption-desorption behavior of the carbonized materials of each Sample was characterized using gas physisorption measurements, which can determine pore volume, pore size distribution, and surface area of the carbon samples. Results of the testing are shown in Table 1 below and can be seen in FIG. 2. Pore size distribution of samples was estimated from the adsorption isotherm using the Barrett, Joyner and Halenda (BJH) model, whereas the surface area was determined from the typical Brunauer Emmett and Teller (BET) analysis.

TABLE 1

| | | | | Maximum |
|---|---|---|---|---|
| Sample | % | Average Relative | Average Quantity | Quantity Adsorbed |
| Number | Resol | Pressure (P/P0) | Adsorbed (cm³/g) | (cm³/g) |
| S1.1 | 2.0 | 0.667 | 2531.402 | 29727.508 |
| S1.2 | 4.0 | 0.672 | 1799.481 | 15198.359 |
| S1.3 | 8.0 | 0.704 | 344.630 | 1632.561 |

As shown by the data from preliminary nitrogen adsorption experiments illustrated in Table 1 and FIG. 2, the resulting porous carbon fibers produced and tested in this Example 1 provide pore structures with high surface areas (about 2592 m²/g) and large pore volumes (about 43 cm³/g). Compared to the pore volumes of commercially-available activated carbons currently available, which have a pore volume of less than about 1 cm³/g and a surface area of less than about 1000 m²/g, these pore volumes of Samples 1.1-1.3 are nearly forty times as large and the surface areas are nearly three times as large as. Accordingly, these porous carbon fibers would offer better performance than currently available commercially-available activated carbons for adsorption.

### EXAMPLE 2

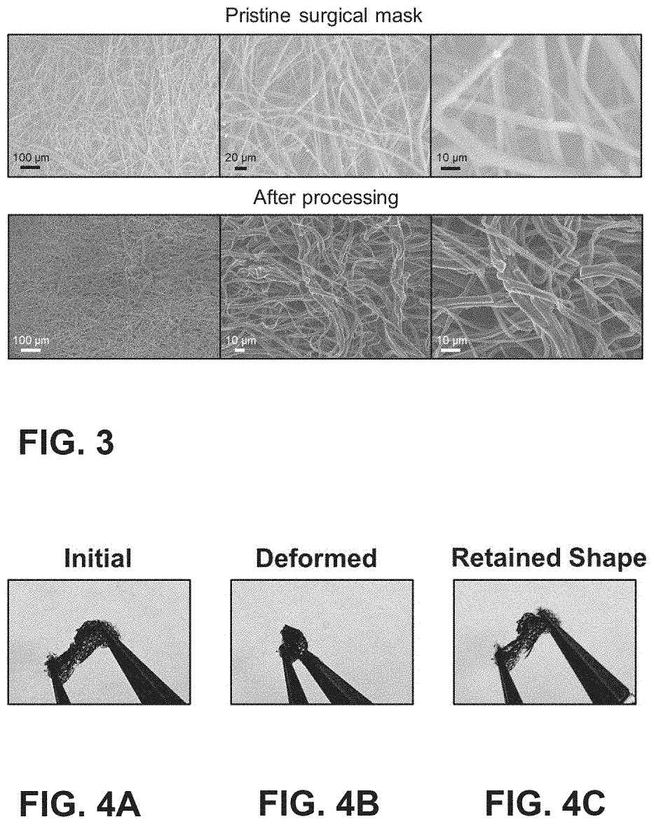

In this Example 2, the initial structure was a structured plastic waste, namely common surgical masks formed of a porous mat of polymer fibers (e.g., melt-blow polypropylene fibers). Each polymer fiber had well-defined fibril microstructures with an average fiber diameter of about 10 nm. These microstructures are shown in FIG. 3, which illustrates SEM micrographs of pristine surgical mask fibers compared with the mask fibrous structures after sulfonation and carbonization.

The initial structure was submerged in a neat sulfuric acid solution at a temperature of about 155° C. for various extended periods of time and at atmospheric pressures. This submersion in the neat sulfuric acid sulfonated the polymer fibers, which were then stabilized through crosslinking. The sulfonated polymer fibers were rinsed with water and carbonized by heating the sulfonated polymer fibers from 25° C. to 800° C. at a rate of 5° C./min. The temperature was maintained at about 800° C. for about 2 hours. In other examples, the sulfonated polymer fibers were carbonized by heating to 1000° C. for 2 hours.

The retention of the initial fibril structures of the polymer fibers of the initial structure after sulfonation is shown by comparison of the SEM images included in FIG. 3. The sulfonated polymer fibers could be continuously deformed and returned to the original position without resulting in irreparable damage to the structure. FIGS. 4A, 4B, and 4C together depict a sequence of photos illustrating this macroscopic flexibility and durability of a surgical mask after sulfonation. Moreover, after carbonization at 1000° C. for about 2 hours, the carbonized surgical masks completely retained their shape before exposure.

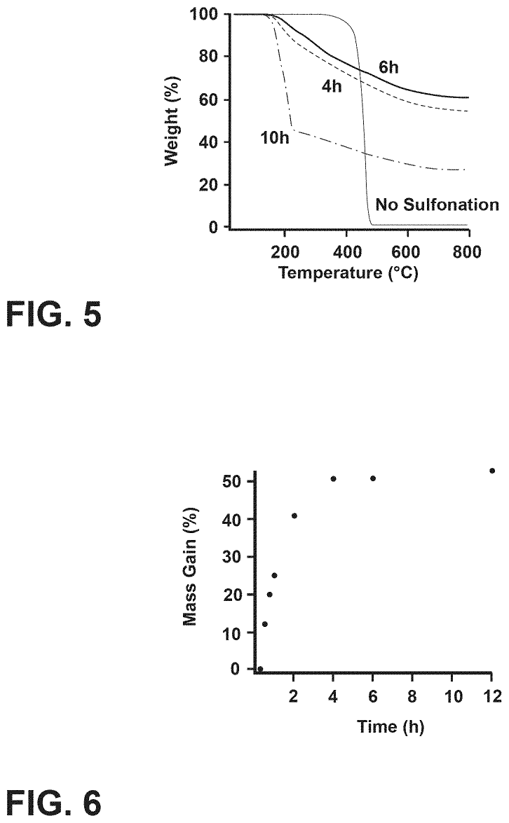

In addition to the increased flexibility and durability, the production of the carbon materials using this method resulted in minimal mass loss. Table 2 sets forth the results of the testing, which are shown in FIG. 5.

TABLE 2

| Sulfonation | Mass Retention |
|---|---|
| Time (hours) | (%) |
| 0 | 0.0 |
| 4 | 30.0 |
| 6 | 57.0 |
| 10 | 65.0 |

Under optimization, sulfonation for about 6 hours lead to about 65% mass retention after carbonization. Accordingly, about 2 grams of the polymer fibers produced about 1.2 grams to about 1.4 grams of the resulting carbon fibers. Generally, increasing the amount of exposure results in higher degrees of carbonization of the polypropylene fibers. At sufficiently long exposure times (about 10 hours), the structures and their performance deteriorated. However, as illustrated by FIG. 5, there was no carbon yield for polymers without the sulfonation step, as polymers with the sulfonation step exhibited 100% mass loss under elevated temperatures in an N₂ atmosphere.

### EXAMPLE 3

In this Example 3, the initial structure selected was PP-based surgical masks. During the step of preparing the initial structure step, the surgical masks were cut to remove the elastic bands and metal nosepiece. The resulting fabric was separated into three constituent layers, including two layers of non-woven fabrics and a melt-spun mat layer. In this Example, only outer layers were used to form 5 samples of the initial structure (each sample consisting of a section cut to have an average size of about 8 cm by about 5 cm).

To sulfonate the samples of the initial structure, these about 1 gram in total of the mask-formed initial structures were transferred into glass containers containing about 25 ml of concentrated sulfuric acid (98 wt %). In this step, a glass slide was placed on top of the mask-formed initial structures to keep the initial structures completely submerged in the sulfuric acid throughout the reactions. The glass containers were then placed in a muffle furnace and heated to about 155° C. During heating, a temperature ramp of about 1° C./min was used. Heating occurred for various amounts of time.

Upon sulfonation, the samples of the initial structure were removed from the muffle furnace and cooled down to room temperature. To wash the samples, sulfuric acid was first removed from the glass containers. Subsequently, the samples were carefully placed in a quartz funnel, where each sample was washed at least three times with deionized water in order to completely remove the residue acid. The neuralization was confirmed by pH papers. The samples were then dried by placing on a glass petri dish in a vacuum oven for overnight.

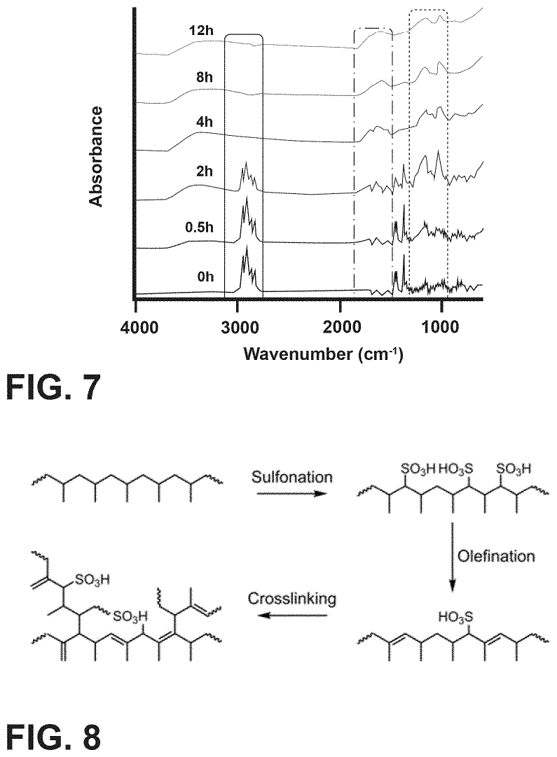

A PerkinElmer Frontier Attenuated Total Reflection (ATR) Fourier-transform infrared (FTIR) spectrometer was used to record the changes in chemical compositions of the sulfonated samples as a function of time. The scan range was 4000 cm⁻¹-600 cm⁻¹ with 32 scans and a resolution of 4 cm⁻¹. The progress of the sulfonation reaction was monitored by tracking mass gain as a function of sulfonation time, as well as through FTIR spectroscopy. Results of these monitoring methods are illustrated in FIGS. 6 and 7.

As shown in FIG. 6, at short time scales, the PP mass gain as a function of time increased rapidly as the sulfonation reaction progresses. After about 4 hours, the mass gain reached a plateau value of about 51%. This plateau value remained nearly constant (i.e., at about 52%) even after extending the reaction time to about 12 hours. As shown in FIG. 7, FTIR spectra also confirmed that sulfonation reaction results in the formation of double bonds and sulfonic acid groups in PP. Specifically, pristine PP fibers from masks exhibited peaks indicative of C—H stretching at about 2920 cm⁻¹ which diminished as the sulfonation/crosslinking reaction progressed and completely disappeared after about 4 hours of reaction time. Additionally, the appearance of three separate peaks can be attributed to the progress of reaction. The broad —OH stretching peak at about 3300 cm⁻¹ emerged after about 30 min, and its peak intensity increased with increasing reaction time. Peaks from about 1250 cm⁻¹ to about 1000 cm⁻¹ can be attributed to the presence of sulfonic acid groups. The addition of alkenes into the PP backbone were demonstrated by the emerging peaks at about 1600 cm⁻¹. Although the samples did not gain further mass after about 4 hours of reaction time, the FTIR traces suggest that the reaction continued to progress until about the 12 hour mark.

### EXAMPLE 4

In this Example 4, the samples from Example 3 were analyzed to determine the morphological changes of the fiber structure after various sulfonation time periods using a Zeiss Ultra 60 field emission scanning electron microscope (SEM). Specifically, the fiber structures of the initial samples of Example 3 and the sulfonated samples of Example 3 (including samples sulfonated for about 2 hours and for about 12 hours) were further investigated using SEM. During these measurements, energy dispersive X-ray spectroscopy (EDS) was coupled for determining the content of different elements within the materials after sulfonation. Additionally, fiber diameters were determined and recorded using ImageJ image analysis software. X-ray photoelectron spectroscopy (XPS) experiments were performed using a Thermo-Fisher ESCALAB Xi+ spectrometer equipped with a monochromatic Al X-ray source (1486.6 eV) and a MAGCIS Ar+/Arn+ gas cluster ion sputter (GCIS) gun. Measurements were performed using the standard magnetic lens mode and charge compensation. The base pressure in the analysis chamber during spectral acquisition was at 3×10-7 mBar. Spectra were collected at a takeoff angle of 90° from the plane of the surface. The pass energy of the analyzer was set at 150 eV for survey scans with an energy resolution of 1.0 eV; total acquisition time was 220 s. Binding energies were calibrated with respect to C1 s at 284.8 eV.

As shown in FIG. 8, the outer layers of the masks used to create the samples of the initial structure were composed of PP fibers with a relatively uniform diameter of about 25 μm (25.7±0.7 μm). Even when the initial samples were exposed to a slightly higher crosslinking/sulfonation temperature (about 156° C.), which approaches the onset of melting in the PP fibers, the sulfonated samples fully retained the fibral structures of the initial samples. After about 2 hours, the fiber diameter of the samples undergoing sulfonation slightly changed to about 21 μm (21.6 μm) and remained relatively constant after about 12 hours of sulfonation.

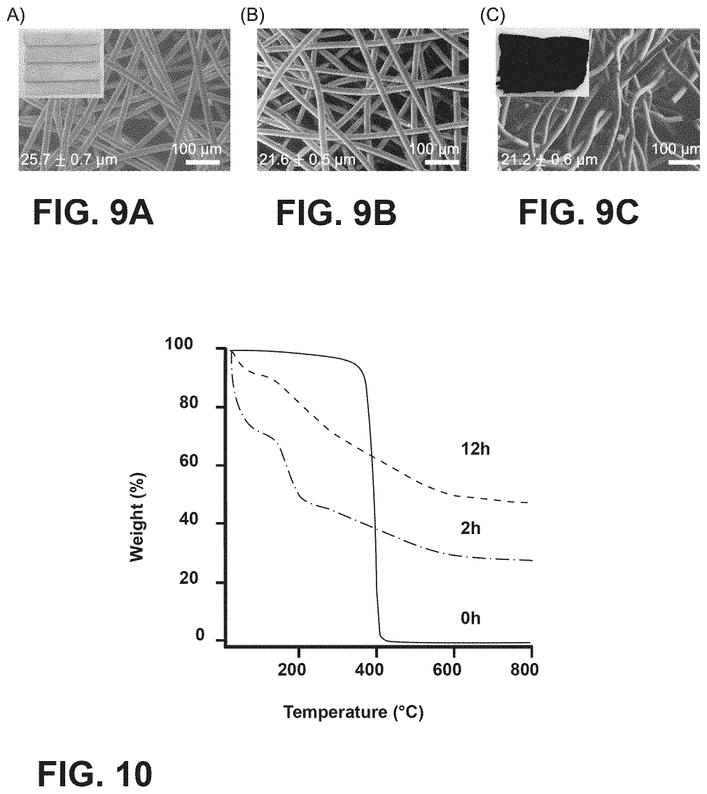

It was also found that extending the reaction time to about 12 hours did not alter the fiber diameters, and yet can result in slight distortion and curving of the fibers, as shown in FIG. 9C. Furthermore, as shown in the insets of FIGS. 9A-9C, the macroscopic structures are retained after each processing step. FIG. 9A demonstrates the neat PP mask and its initial structure prior to sulfonation, while the inset in FIG. 9C shows the form was maintained throughout the sulfonation process.

### EXAMPLE 5

In this Example 5, carbonization of the sulfonated and thermally stabilized samples from Example 4 was performed using an MTI Corporation OTF-1200X tube furnace under an N₂ atmosphere. The samples were heated at a rate of about 1° C./min until reaching a temperature of about 600° C. The samples were then heated at a rate of about 5° C./min until reaching a carbonization temperature of about 800° C. or higher. The carbonization temperature was maintained for a holding time of about 3 hours.

Samples from Example 4 were evaluated to determine carbon yield after two distinct crosslinking times (about 2 hours of sulfonation and about 12 hours of sulfonation). Carbon yield was determined using Thermogravimetric analysis (TGA) conducted using a Discovery Series TGA 550 (TA Instruments) to determine the mass loss of polymer precursors as a function of pyrolysis temperature. Sulfonated samples, approximately 10-20 mg in mass, along with a control sample of un-sulfonated PP were pyrolyzed under a N₂ environment, replicating the carbonization procedure used in the tube furnace.

All organic components of the control sample were completely degraded with 0% mass retention after exposure to about 800° C. under N₂. As shown in FIG. 10, the sulfonated samples having lower reaction times (i.e., 2 hours) exhibited a higher mass loss upon carbonization. This may be attributed to incomplete crosslinking of PP throughout the entire fiber structure of the samples. Specifically, sulfonated samples undergoing about 2 hours of sulfonation resulted in a carbon yield of about 51%, while sulfonated samples undergoing about 12 hours of sulfonation exhibited a carbon yield of about 58%. Both carbon yields were derived from the sulfonate state of the samples.

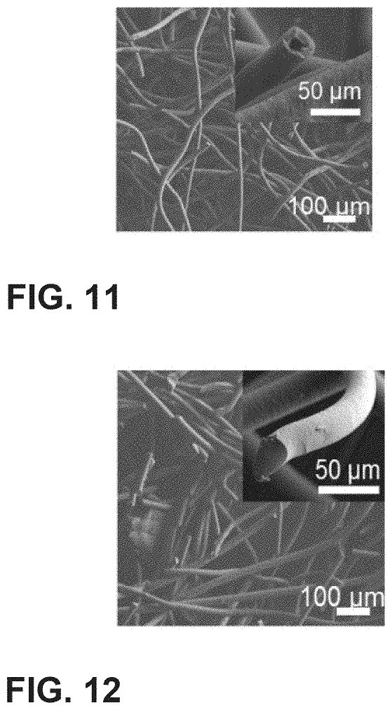

Additionally, the samples undergoing only 2 hours of sulfonation exhibited hollow structure carbon fibers (see FIG. 11) while the samples undergoing 12 hours of sulfonation resulted in carbon fibers with solid cores (see FIG. 12). Additionally, the TGA thermogram of the sulfonated samples undergoing about 12 hours of sulfonation exhibited no secondary thermal decomposition after 100° C. This may be attributed to the decomposition of unreacted polymer chains within the fibers of the samples.

Specifically, the fiber structures of the initial samples of Example 3 and the sulfonated samples of Example 3 (including samples sulfonated for about 2 hours and for about 12 hours) were further investigated using SEM. During these measurements, energy dispersive X-ray spectroscopy (EDX) was coupled for determining the content of different elements within the materials after sulfonation. Additionally, fiber diameters were determined and recorded using ImageJ image analysis software. X-ray photoelectron spectroscopy (XPS) experiments were performed using a Thermo-Fisher ESCALAB Xi+ spectrometer equipped with a monochromatic Al X-ray source (1486.6 eV) and a MAGCIS Ar+/Arn+ gas cluster ion sputter (GCIS) gun. Measurements were performed using the standard magnetic lens mode and charge compensation. The base pressure in the analysis chamber during spectral acquisition was at 3×10-7 mBar. Spectra were collected at a takeoff angle of 90° from the plane of the surface. The pass energy of the analyzer was set at 150 eV for survey scans with an energy resolution of 1.0 eV; total acquisition time was 220 s. Binding energies were calibrated with respect to C is at 284.8 eV.

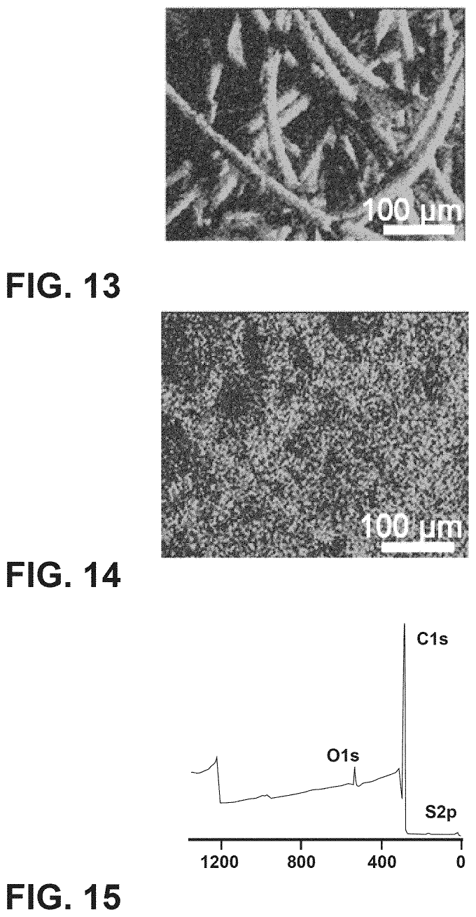

FIGS. 13 and 14 depict the elemental maps that correspond to both carbon and sulfur produced through EDX. The sulfur doping content was found to be about 5.6 wt % for the carbon fibers resulting from carbonized PP masks that underwent about 12 hours of sulfonation. The overlaid elemental map shown in FIGS. 13 and 14 also demonstrates that the heteroatoms are uniformly distributed within the carbon fibers. The presence of heteroatoms in the carbon framework of the mask waste derived carbon fibers was further investigated using x-ray photoelectron spectroscopy (XPS). FIG. 15 depicts the survey scan of the carbonized fibers after 12 hours of sulfonation, indicating the presence of carbon (284.09 eV), oxygen (532.20 eV), and sulfur (163.79 eV) moieties within the framework of the resulting carbon materials at 96.7 atom %, 2.9 atom %, and 0.4 atom %, respectively. The peaks at 163.5 eV and 164.7 eV shown in FIG. 15 suggest that the sulfur atoms are directly bonded to carbon as part of the framework rather than being bonded to oxygen which would be illustrated by the presence of peaks at slightly higher binding energies. When compared to the EDX results, this lower doping content from XPS measurements suggests that the surface of the resulting carbon fibers may have a lower sulfur content than the interior of the resulting carbon fibers.

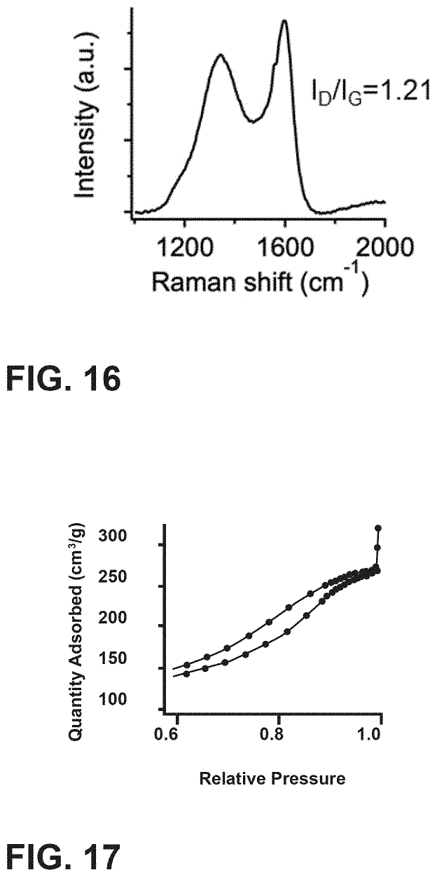

Furthermore, Raman spectroscopy was employed to characterize the degree of graphitization of the resulting carbon fibers. In general, carbon materials with higher degrees of graphitization can exhibit better electrical and thermal conductivity through facilitating the electron transport along the in-plane direction as opposed to the amorphous carbon counterparts. Results of the spectroscopy are shown in FIG. 16. As shown by the graph of FIG. 16, the ratio of the intensities of the disordered (at 1370 cm⁻¹) and graphitic bands (at 1597 cm⁻¹) was 1.21.

The N₂ adsorption-desorption behavior of the mask-derived carbon fiber was characterized using gas physisorption measurements, which can determine pore volume, pore size distribution, and surface area of the carbon samples. Specifically, pore size distribution of samples was estimated from the adsorption isotherm using the Barrett, Joyner and Halenda (BJH) model, whereas the surface area was determined from the typical Brunauer Emmett and Teller (BET) analysis.

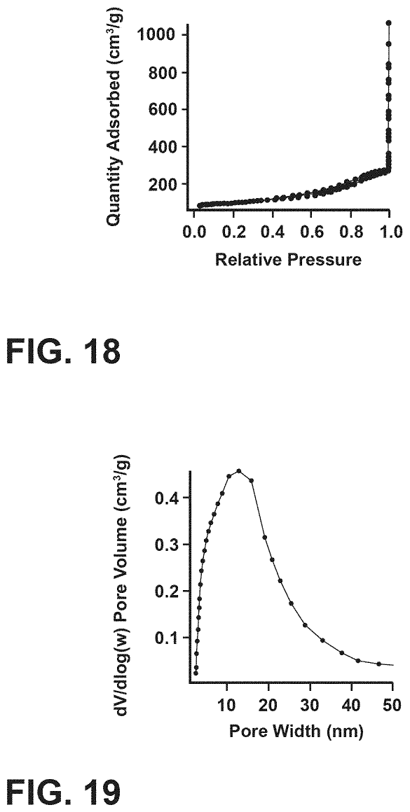

The sulfonated fibers prior to the carbonization possess no micropores. As shown in FIG. 17, the resulting carbon fibers exhibited a typical type V isotherm, suggesting the presence of both macropores and mesopores. The resulting carbon fibers further exhibited a surface area of about 295.46 m²/g. As shown in FIG. 18, hysteresis occurs at a partial pressure range from 0.6 to about 1.0. Furthermore, as shown in FIG. 19, the pore size distribution was relatively uniform and centered around about 12 nm. The generation of these pores occurred during the carbonization process when portions of the polymer chains were thermally degraded and gases (CO, CO₂, H₂O, SO₂) were evolved.

### EXAMPLE 6

To further demonstrate the use of derived carbon fibers in practical applications, experiments using the samples from Example 5 were performed to determine Joule heating. The ability of a material to reach elevated temperatures upon the application of low voltages through Joule heating provides great potential in several applications, including thermotherapy, crude oil recovery, and thermochromics. Joule heating is a result of electrons colliding with atoms within a conductor, and which generates heat in regions where current transmits. Equation 1 simplistically depicts the Joule heating of a current density j in an electrical field E in a material of electrical conductivity . . . σ.

Q=j·E=·E² Equation 1

This relationship demonstrates that the thermal energy produced from Joule heating is directly dictated by the conductivity of the material where enhanced conductivity results in increased output of energy in to form of Joule heating. In Joule heating experiments, carbonized mask fibers were subjected to different voltages, then allowed to be equilibrated. Specifically, the Joule heating capabilities of the carbonized mask fibers were determined by connecting the fibers

This relationship demonstrates that the thermal energy produced from Joule heating is directly dictated by the conductivity of the material where enhanced conductivity results in increased output of energy in to form of Joule heating. In Joule heating experiments, carbonized mask fibers were subjected to different voltages, then allowed to be equilibrated. Specifically, the Joule heating capabilities of the carbonized mask fibers were determined by connecting the fibers to a DC power supply using a glass slide as a support. The voltage was increased in increments of 1 V and the temperature was measured using a thermal camera (from HTI) until the equilibrium state was reached. This relationship demonstrates that the thermal energy produced from Joule heating is directly dictated by the conductivity of the material where enhanced conductivity results in increased output of energy in to form of Joule heating. In Joule heating experiments, carbonized mask fibers were subjected to different voltages, then allowed to be equilibrated. Specifically, the Joule heating capabilities of the carbonized mask fibers were determined by connecting the fibers to a DC power supply using a glass slide as a support. The voltage was increased in increments of 1 V and the temperature was measured using a thermal camera (from HTI) until the equilibrium state was reached.

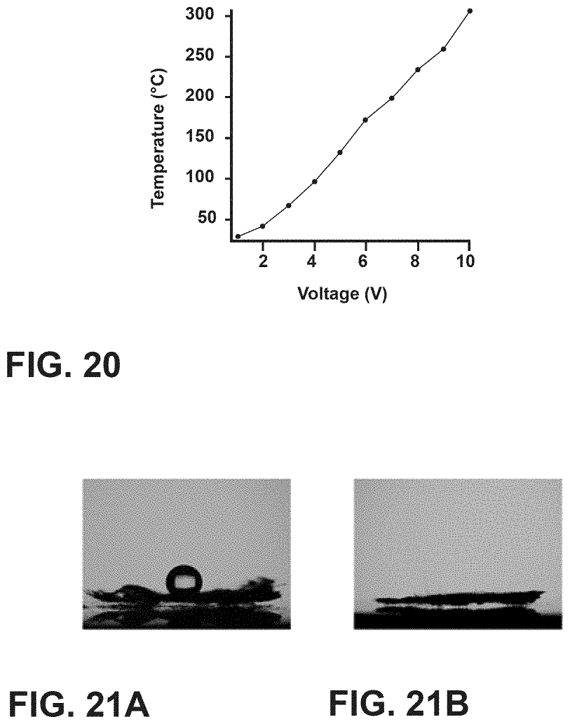

As shown in FIG. 20, with the application of increased voltage from 1 V to 10 V, the mask-derived carbon fibers can reach a broad temperature range from 29° C. to greater than 300° C. with the application of 10 V. For example, at 9 V, the temperature of the porous carbon fibers was at about 248° C. Due to the high conductivity of the carbon fibers, the heating happens rapidly and equilibrates in a matter of seconds. After the voltage is removed, heat dissipates quickly, and the porous carbon fibers return to room temperature in less than 10 seconds. These results suggest that the porous carbon fibers derived from a precursor material such as structured plastic waste could be employed as fillers in preparing Joule-heating composites. In various examples, the carbonized materials may exhibit a thermal conductivity of about 150 (W/mk).

### EXAMPLE 7

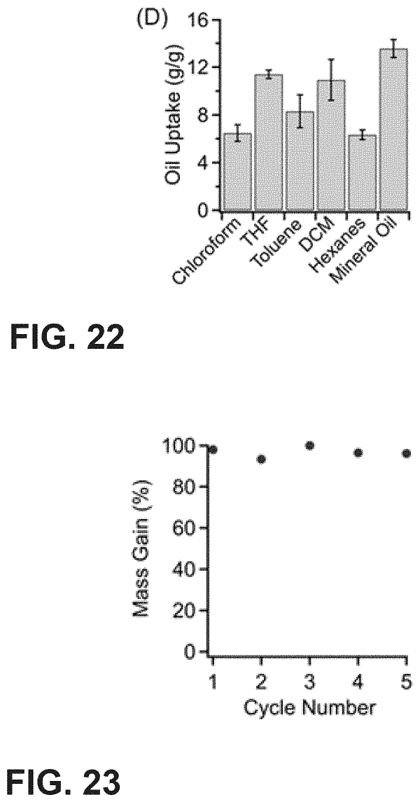

To further highlight the applications of the resulting carbon fibers from Example 5, water contact angle measurements were recorded and analyzed using a goniometer and Contact Angle software from Ossila. The carbonized mask fibers from Example 5 exhibit high water contact angles (FIG. 21A), but are easily wet by organic solvents, such as chloroform (FIG. 21B). The carbonized mask fibers were further tested for their ability to absorb organic solvents which acted as surrogates for oil-based pollutants. Acetone and chloroform were easily absorbed by simply placing the carbonized fibers into the solvent droplets. This behavior was consistent for many organic solvents, as demonstrated in FIG. 22.

Oil adsorption studies were performed by submerging carbonized mask fibers into 20 mL various organic solvents for at least 5 minutes, and recording the mass adsorbed immediately after removing from the solvent. The carbon mask fibers exhibited varied adsorption capacities for different organic solvents, with a maximum amount of up to 14 grams of mineral oil per gram of carbon fiber. The difference in the uptake capacity against different solvents is primarily associated with the surface energy of carbon surfaces and the interactions between the surface functional groups and solvent molecules.

The hydrophobicity of carbon materials enables their use for oil adsorption. The favorable interactions between organic solvents and hydrophobic carbon drives the adsorption of oils to the carbon surface. Additionally, this performance is highly cyclable, where the sorbate can be efficiently removed, and the carbon fibers can be reused in further adsorption. This advantageous property was confirmed in FIG. 23, where chloroform was been repeatedly adsorbed by a carbon fiber mat, recovered, and adsorbed again for five cycles.

### EXAMPLE 8

In this Example 8, samples of Example 6 were further tested through activation of the resulting carbon fiber product. The activation process was performed by physically grinding the previously produced carbon fiber product with potassium hydroxide (KOH) at a 1:2 mass ratio. After activation at 700° C. with a ramp rate of 1° C./min for 1 h, the product was washed with DI water, centrifuged, and then dried. This process was repeated 6 times. The carbonized masks were activated through reacting with KOH to enhance the porosity of the carbon fibers and increase surface area.

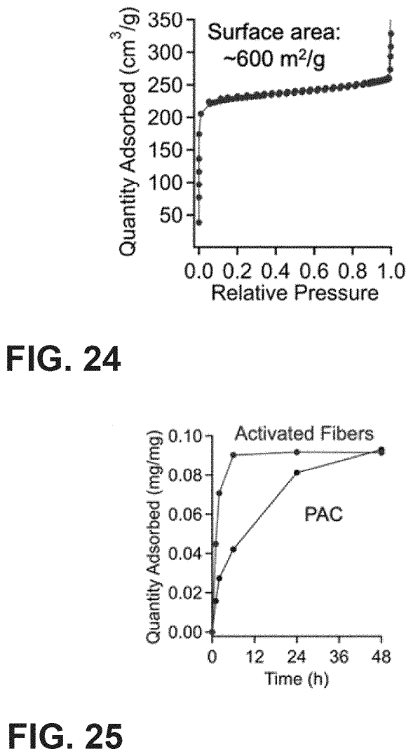

From the N₂ isotherm in FIG. 24, it is evident by the large increase in the quantity of N₂ adsorbed at low relative pressures (p/p₀: 0-0.1) that micropores have been generated in the fibers. The activation process significantly improves the surface area of these carbon fibers from 295 m²/g to 600 m²/g. After activation the fibral structures of these materials were well retained. It was also found that the oxygen content of carbon fibers increases from 0 wt % to 25.6 wt %, determined by the EDX measurements.

To gauge the performance of the activated mask in water remediation applications, dye adsorption studies were performed with a water-soluble dye, basic blue 17. The adsorption capacities as a function of time in 3 different dye concentrations were investigated, which were 0.07 mg/mL, 0.15 mg/mL, and 0.30 mg/mL. The activated mask fibers had adsorption capacities of roughly 0.033 mg/mg, 0.09 mg/mg, and 0.19 mg/mg for the 0.07 mg/mL, 0.15mg/mL, and 0.30 mg/mL solutions, respectively. Results for the 0.15 mg/mL solution are shown in FIG. 25.

The dye adsorption kinetics were fit to a pseudo first order model using Equation 2 where qₑ is the amount of dye adsorbed at equilibrium, qₜ is the amount of dye adsorbed at equilibrium, is the amount of dye adsorbed at time is the amount of dye adsorbed at time t, and k₁ is the first order equilibrium rate constant

$$log ( {q}_{e} - {q}_{t} ) = log {q}_{e} - \frac{{k}_{1}}{2.303} t \qquad Equation 2$$

At 0.15 mg/mL and 0.30 mg/mL, the rate constant of the dye adsorption by the activated fibers (0.649 hAt 0.15 mg/mL and 0.30 mg/mL, the rate constant of the dye adsorption by the activated fibers (0.649 hAt 0.15 mg/mL and 0.30 mg/mL, the rate constant of the dye adsorption by the activated fibers (0.649 h⁻¹ and 0.213 h⁻¹, respectively) was significantly higher than the adsorption by the standard commercially available PAC (0.076 h⁻¹ and 0.075 h⁻¹, respectively).

### EXAMPLE 9

In this Example 9, the initial structure selected was PP-based surgical masks. During the step of preparing the initial structure step, the surgical masks were cut to remove the elastic bands and metal nosepiece. The resulting fabric was separated into three constituent layers, including two layers of non-woven fabrics and a melt-spun mat layer. In this Example 10, only outer layers were used to samples of the initial structure with each sample weighing about 0.3 grams.

To sulfonate the samples of the initial structure, the samples were transferred into glass containers containing about 30 ml of concentrated sulfuric acid (98 wt %). In this step, a glass slide was placed on top of the mask-formed initial structures to keep the initial structures completely submerged in the sulfuric acid throughout the reactions. The glass containers were then placed in a muffle furnace and heated to about 145° C.

Upon sulfonation, the samples of the initial structure were removed from the muffle furnace and cooled down to room temperature. To wash the samples, sulfuric acid was first removed from the glass containers. Subsequently, the samples were washed at least three times with deionized water in order to completely remove the residue acid. The samples were then placed in a vacuum oven overnight to dry to ensure any residual water was removed.

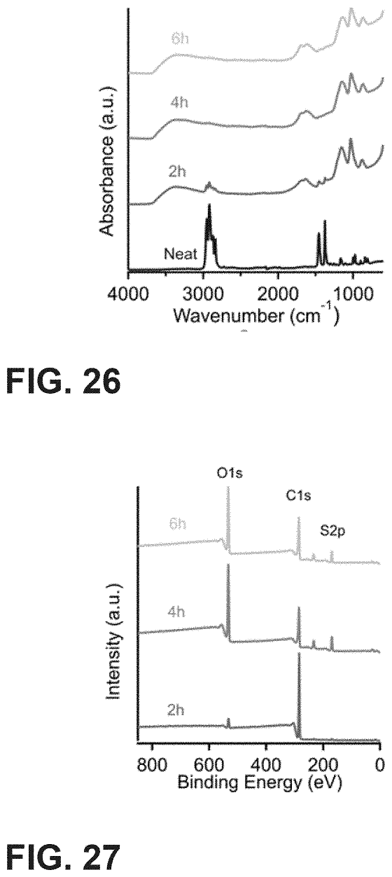

A PerkinElmer Frontier Attenuated Total Reflection (ATR) Fourier-transform infrared (FTIR) spectrometer was used to record the changes in chemical compositions of the sulfonated samples as a function of time. The scan range was 4000 cm⁻¹-600cm⁻¹ with 32 scans and a resolution of 4 cm⁻¹. The progress of the sulfonation reaction was monitored through FTIR spectroscopy. Results of this monitoring are illustrated in FIG. 26.

As shown in FIG. 26, FTIR spectra confirmed that sulfonation reaction results in the formation of double bonds and sulfonic acid groups in PP. Specifically, neat PP fibers from masks exhibited peaks indicative of C-H stretching at about 2920 cm⁻¹ which diminished as the sulfonation/crosslinking reaction progressed and completely disappeared after about 4 hours of reaction time. The intensity of these peaks first reduced after about 2 hours, indicating an incomplete crosslinking of PP fibers. After about 4 hours, these peaks completely disappeared. The peak at 3326 cm⁻¹ corresponds to the hydroxyl groups of the sulfonic acid moieties introduced to the polymer backbone and is further evidence of the sulfonation reaction. Additionally, the formation of alkenes is represented by the peak at 1604 cm⁻¹ and the formation of sulfonic acid groups is evidenced by the peaks from 1150-1000 cm⁻¹. It was found that after about 4 hours, the FTIR spectra remain nearly constant which suggests that the reaction is complete.

In addition to FTIR spectroscopy, the change in the chemical composition of crosslinked PP fibers as a function of reaction time was investigated through XPS. FIG. 27 illustrates survey scans of the crosslinked fibers with increasing sulfonation time. After about 2 hours of reaction time, low degree of sulfonation occurs with limited increase in levels of oxygen and sulfur to about 3.3 atom % (at about 532.23 eV) and about 0.6 atom % (at about 169.3 eV), respectively. Increasing reaction time to about 4 hours resulted in significantly more pronounced peaks corresponding to these two heteroatoms. After about 4 hours of sulfonation, the oxygen and sulfur content reached plateau values at about 42.2% and about 9.7%, respectively. Moreover, the oxygen to sulfur ratio of approximately 4 indicates that an additional oxygen containing functionality is incorporated into the polymer for every sulfonic acid group that is attached to the backbone. This is likely due to side reactions which can form ketone species or other functional groups.

### EXAMPLE 10

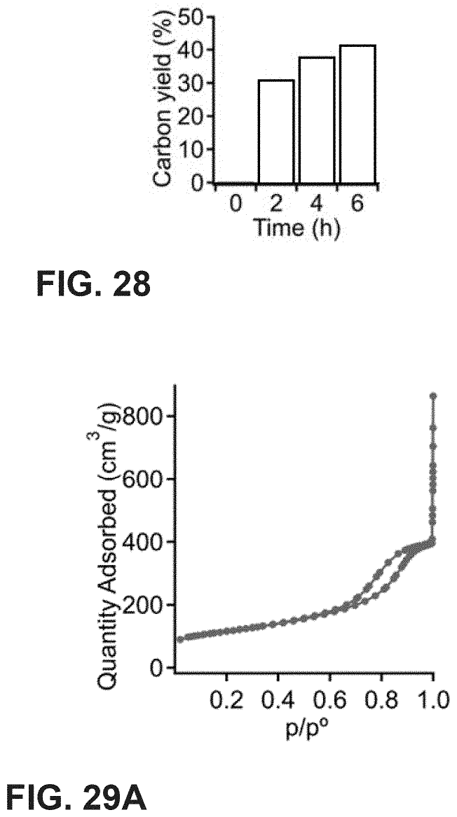

In this Example 10, after the sulfonation crosslinking reaction, the samples of Example 9 were washed and subsequently carbonized under N₂ atmosphere at about 800° C. The crosslinking reaction enabled carbon yields up to about 45% as shown in FIG. 28. Specifically, about 2 hours of sulfonation results in reduced carbon yield of about 30%. Shorter reaction times resulted in incomplete crosslinking of PP fibers, and the underreacted fiber in the core regions were susceptible to thermal degradation. After about 4 hours of sulfonation, the carbon yield reached a plateau at about 40%, confirming that about 4 hours of crosslinking using concentrated sulfuric acid at about 145° C. is sufficient to fully crosslink the PP fibers in the samples. While this temperature is lower than the melting temperature of PPs, attached sulfonic acid groups on polymer backbones makes PP becomes significantly more hydrophilic, which allows the efficient penetration of acid for further crosslinking.

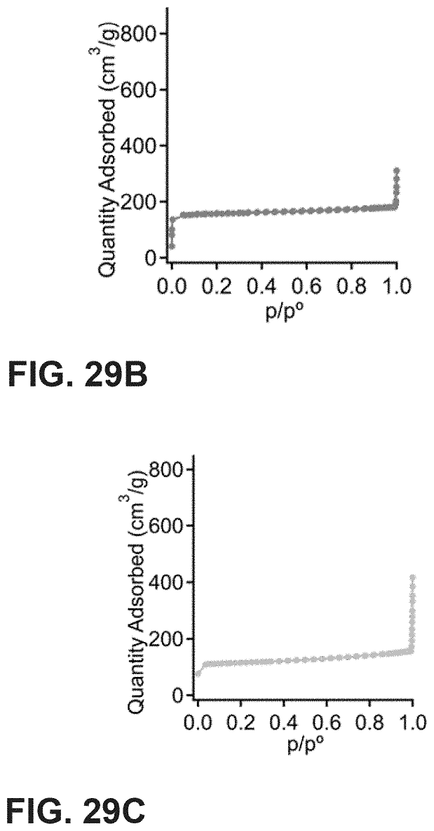

Nitrogen sorption isotherms at 77 K were used to determine the pore characteristics of the carbonized fibers as a function of sulfonation time and are depicted in FIG. 29A-29C. After about 2 hours of sulfonation (FIG. 29A), lower degrees of sulfonation resulted in the formation of larger mesopores from un-crosslinked PP, which are susceptible to thermal degradation. At longer sulfonation times, only micropores are present as a result of higher degrees of crosslinking (see FIGS. 29B and 29C). The carbonized PP fibers exhibited surface areas of about 389 m²/g for samples with about 2 hours of reaction time, about 486 m²/g for samples with about 4 hours of reaction time, and about 361 m²/g for samples with about 6 hours of reaction time.

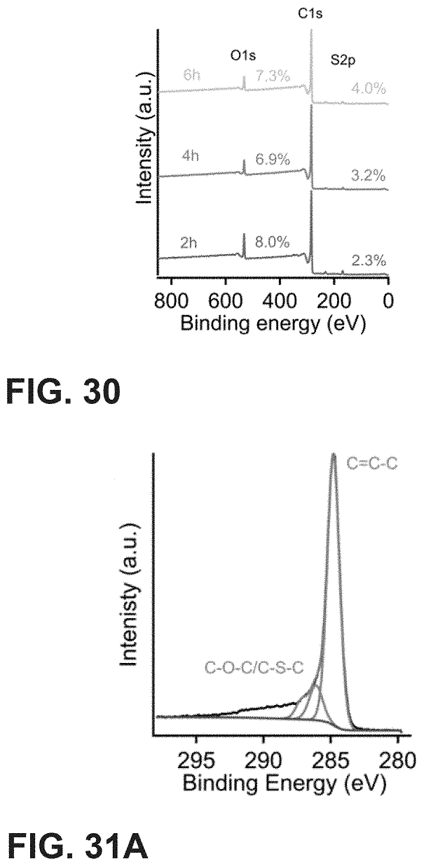

After carbonization, the heteroatom content of the carbon fibers was determined through XPS. FIG. 30 illustrates survey scans of the fibers which were carbonized after varying sulfonation times, and the corresponding heteroatom content of C, O, and S. Generally, the carbonization process resulted in the degradation of most heteroatom-containing functional groups while forming carbon frameworks. With increased reaction time, it was found that the sulfur content in the material increases while the oxygen content decreases. Carbon fibers that were initially sulfonated for about 2 hours exhibited heteroatom contents of about 8 atom % and about 2.3 atom % for oxygen and sulfur, respectively. Increasing reaction time to about 6 hours reduces the oxygen content to about 7.3 atom % and very slightly increases the amount of sulfur to about 4.0 atom %. The presence of heteroatoms is anticipated to strengthen the capability of mask-derived carbon fibers for capture CO₂ as previously discussed.

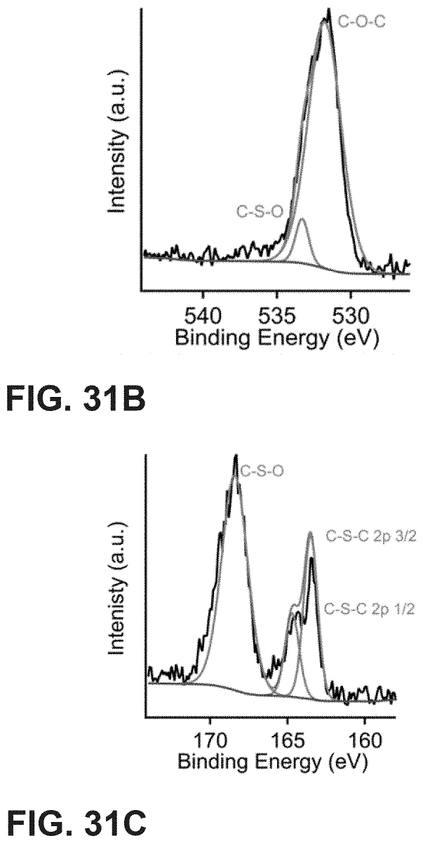

The heteroatom content of the materials is further elucidated in the high resolution XPS scans in FIG. 31. Representative carbon, oxygen, and sulfur high resolution scans are found in FIGS. 31A-31C, respectively. The most predominant bond is the C═C—C found in FIG. 31A, which corresponds to the conjugated framework of the carbonized fiber. Within the carbonized fiber, the most prevalent oxygen containing functionality are represented by the C—O—C peak at about 532.1 eV which represents epoxide groups. From the high-resolution sulfur scan, it is shown that most of the S atoms are represented by the peak at about 168.4 eV, which corresponds to C—S—O bonds. Previously, oxidized sulfur containing functional groups have been demonstrated to enhance the CO₂ adsorption performance of porous carbons due to favorable interactions between the basic groups and the polar gas molecule. As set forth in Table 3 below, the fibers that were crosslinked for about 6 hours, depicted the highest population of the C—S—O functional group when considering their elevated content.

TABLE 3

| Carbon | | | | | | Sulfur | | |
|---|---|---|---|---|---|---|---|---|
| Crosslinking | | C—O—C/ | Oxygen | | | | C—S—C | C—S—C |
| Time | C═C—C | C—S—C | C—O—C | C—S—O | C—S—O | C—S—C | 2p 3/2 | 2p 1/2 |
| 2 hours | 88.6% | 11.4% | 92.2% | 7.8% | 86.6% | 13.4% | — | — |
| 4 hours | 86.1% | 13.9% | 93.6% | 6.4% | 71.1% | — | 19.8% | 9.1% |
| 6 hours | 89.2% | 10.8% | 85.0% | 15.0% | 68.4% | — | 16.4% | 15.2% |

### EXAMPLE 11

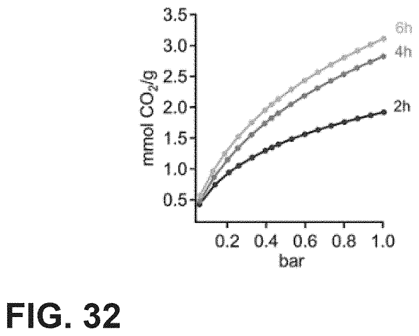

In this Example 11, carbonized samples from Example 10 were tested using a Micromeritics Tristar II instrument to determine CO₂ and N₂ sorption performance at ambient temperature. Due to the largely similar pore characteristics of the samples of Example 10, the effect of the increased presence of sulfur groups can be observed in the CO₂ adsorption isotherms in FIG. 32. The porous nature and heteroatom content of the fibers enable their use as sorbents for CO₂ capture. Notably, the maximum specific sorption capacity exhibited by the carbon fibers is 3.33 mmol/g at 1 bar.

### EXAMPLE 12

In this Example 12, the initial structure was formed of bulk SEBS with 27 vol % styrene content (amorphous polymer, Mn: 121,000 g/mol, a 1.07). Preparation of the initial structure included annealing the initial structure at a temperature of about 170° C. to about 180° C. for about 12 hours. The initial structure was sulfonated in sulfuric acid at 85° C. for 2 h. Subsequently, a de-sulfonation step was conducted by heating the initial structure at 120° C. for about 1 hour. The sulfonated initial structure was carbonized by heating the sulfonated structure from about 25° C. to a carbonization temperature of about 800° C. at a rate of about 5° C./min. The carbonization temperature of about 800° C. was maintained for about 2 hours. This process resulted in OMCs with average pores sizes of about 22 nm and an average surface area of about 513 m2/g.

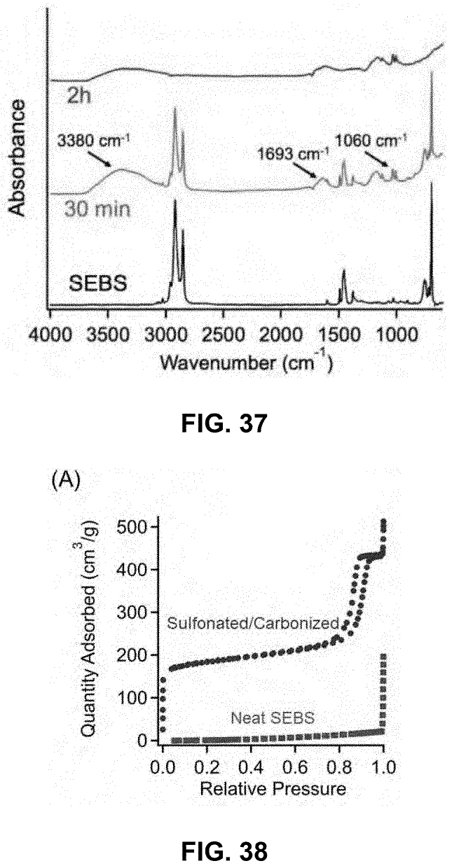

As shown in FIG. 37, FTIR spectroscopy was used to determine changes in the chemical composition of the SEBS. After sulfonation at about 155° C. for about 30 min, multiple peaks emerged at 3380 cm⁻¹, 1693 cm⁻¹, 1627 cm⁻¹, and 1060 cm⁻¹, corresponding to the formations of hydroxyl groups, carboxylic acid groups, alkene bonds, and S═O bonds from the reaction. After about 2 hours of sulfonation, the peaks between about 2800 cm⁻¹ and about 3000 cm⁻¹ disappeared, which suggests that all methyl groups from the poly(ethylene-random-butylene) matrix were completely reacted with sulfuric acids. These FTIR results clearly confirm the crosslinking of polyolefin segments in the SEBS.

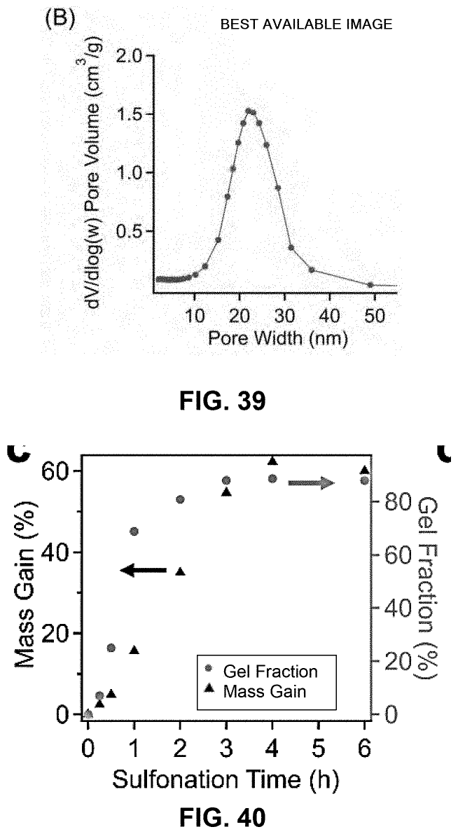

As shown in FIG. 38, neat SEBS did not exhibit porosity, and completely degraded after carbonization. After crosslinking and carbonizing, porous structures were developed within the resulting material as evidenced by the development of a type IV nitrogen physisorption isotherm. Additionally, FIG. 39 illustrates that the generated pores were highly uniform with the pore size distribution centered at about 22 nm.

In Examples, 13-19, samples were formed of materials having the properties shown in Table 4 below.

TABLE 4

| Material Name | Molecular Weight (g/mol) | Dispersity (Ð) | ϕ_{PS} |
|---|---|---|---|
| SEBS118 | 118,000 | 1.59 | ≈0.20 |
| SEBS89 | 89,000 | 1.56 | ≈0.20 |
| SEBS130 | 130,000 | 1.59 | ≈0.15 |
| SEBS100 | 100,000 | 1.67 | ≈0.18 |

Each of SEBS118, SEBS89, SEBS130, and SEBS100 may be referred to herein as a “SEBS materials”. The SEBS materials used in this study are amorphous, providing an important mechanism for facilitating the crosslinking reaction and enabling significantly shorter reaction times for bulk sample crosslinking.

### EXAMPLE 13

In this Example 13, the initial structure was formed of SEBS118 precursor material. The initial structure was annealed under a nitrogen atmosphere at a temperature of about 160° C. for about 12 hours to establish long-range ordering in the structure's nanostructures. Samples of about 0.300 grams of the respective annealed SEBS material was then submerged in about 3 grams of concentrated sulfuric acid solution at a temperature of about 150° C. for varying amounts of time. Other samples of the annealed initial structure formed of SEBS118 precursor material were sulfonated by submerging about 0.300 grams of the annealed SEBS118 material in about 3 grams of concentrated sulfuric acid solution at a temperature of either about 85° C. or about 125° C. for varying amounts of time. Measurements were taken for reaction times of about 0.25 hour, about 0.5 hour, about 1 hour, about 2 hours, about 3 hours, about 4 hours, about 6 hours, and about 8 hours. This submersion in the neat sulfuric acid crosslinked the olefinic block (PEB) of the structure of the SEBS118 precursor material. After the sulfonation was complete, the contents of the reaction vessel were passed through a glass fritted funnel, and the polymer was removed. The sulfonated material was washed with 200 mL of deionized water at least three times to completely remove the residual acid and other reaction by-products. The washed material was then dried under vacuum.

The reaction progress was monitored using measurements for mass gain and gel fraction of the sulfonated and cross-linked product. Mass gain throughout sulfonation was monitored by massing the starting material prior to sulfonation and comparing to the final mass after washing and drying. As shown in FIG. 40, the mass of the monitored SEBS118 sample steadily increased as the reaction time increased and plateaued at about 4 hours of reaction time.

To measure the gel fraction of the sulfonated material, the material was washed in hot toluene at a temperature of about 85° C. for about 12 hours to remove any uncrosslinked fractions and the mass was compared before and after. As shown in FIG. 40, the gel fraction of the material fraction reached a plateau of about 88% by weight after about 4 hours of reaction time at a temperature of about 150° C.

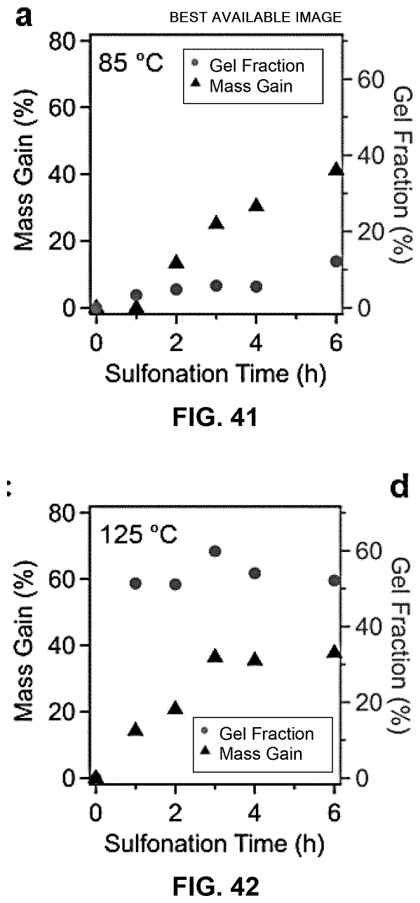

The samples sulfonated at the temperatures of about 85° C. and about 125° C. exhibited slower kinetics than the samples sulfonated at 150° C. The lower temperature samples also demonstrated lower plateau values of mass gain and gel fraction. As shown in FIGS. 41 and 42, samples sulfonated at 85° C. and 125° C. only achieve about 40% mass gain over 6 hours compared to the mass gain of about 60% for the samples sulfonated at 150° C. Similarly, the gel fractions of samples sulfonated at 85° C. and 125° C. were approximately 12% and 60%, respectively. The reduced gel fraction in comparison to the measurements of samples sulfonated at 150° C. reaction condition suggests that lower temperature sulfonation reactions result in reduced degrees of crosslinking.

### EXAMPLE 14

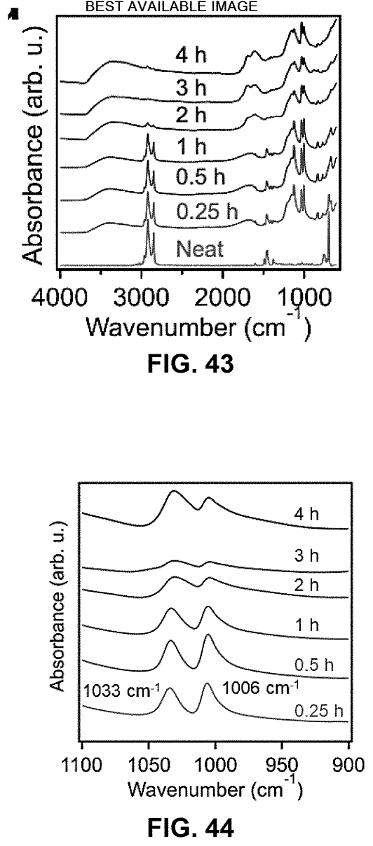

In this Example 14, the changes in chemical composition of the sulfonated polymers of Example 13 during the sulfonation reaction were further illustrated using the Fourier transform infrared (FTIR) spectra shown in FIGS. 43-47. Specifically, samples were sulfonated at temperature of about 85° C., about 125° C., or about 150° C. and were sulfonated for reaction times of about 0.25 hour, about 0.5 hour, about 1 hour, about 2 hours, about 3 hours, about 4 hours, about 6 hours, and about 8 hours before FTIR spectroscopy was performed using an attenuated total reflection FTIR spectrometer. Spectra were recorded over a range from about 4000 cm⁻¹ to about 600 cm⁻¹ with 32 scans at a resolution of 4 cm⁻¹.

For samples sulfonated at a temperature of about 150° C., rapid PS functionalization was observed as evidenced by a prominent vibration associated with the disubstituted aromatic rings of the PS block at 1006 cm⁻¹. At shorter reaction times (e.g., about 0.25 hour, about 0.5 hour, and about 1 hour), this vibration was dominant, while the alkyl stretching vibrations associated with the PEB block at 2851 cm⁻¹ and 2920 cm⁻¹ only diminished slightly. This result indicates that the primary reaction occurring at short timescales (within the first hour) is the sulfonation of PS segments.

However, as also shown in FIG. 43, the relative intensity corresponding to the alkyl stretching vibrations began to decrease more significantly after about 1 hour of sulfonation, and bands associated with the addition of sulfonic acid groups (1033 cm⁻¹) and alkenes (1615 cm⁻¹) within the backbone became more present. These results indicate that the progress of the PEB matrix crosslinking has a slower kinetics than PS sulfonation.

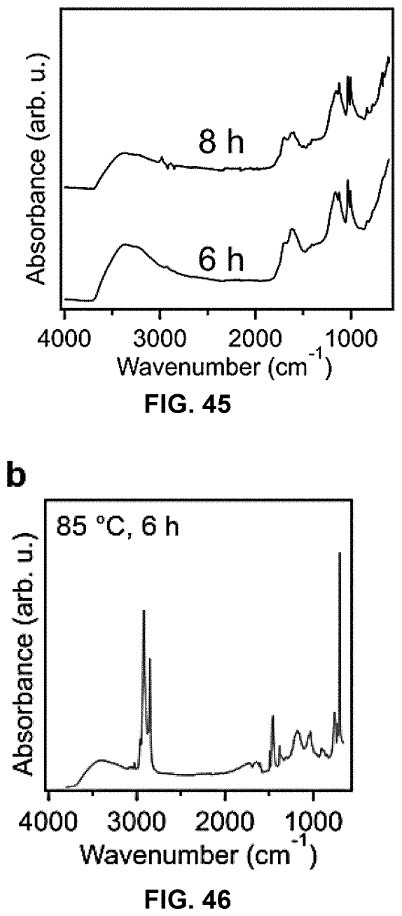

FIG. 44 illustrates the peaks associated with the addition of sulfonic acid functional groups to the poly(ethylene-ran-butylene) blocks (i.e., the polymer backbone) at a wavelength of about 1033 cm⁻¹ and the aromatic ring of polystyrene blocks at a wavelength of about 1006 cm⁻¹ to provide a qualitative understanding of the reaction progress of the distinct blocks. While a band at 1033 cm⁻¹ was present at short reaction times, it was less prominent than the peak at 1006 cm⁻¹ until about 1 hour of sulfonation. This result further confirms that the sulfonation of the olefinic backbone of the SEBS118 samples demonstrated slower reaction kinetics than the PS blocks. As reaction time increased over the 1 hour mark, the intensity of both bands increased, indicating that the presence of alkenes became more prominent, until about 4 hours of reaction time had elapsed. As shown in FIG. 45, further extending the sulfonation time results in a spectrum that remains nearly constant, indicating the completion of the reaction of SEBS118 after about 4 hours of reaction time at a temperature of about 150° C. in concentrated sulfuric acid.

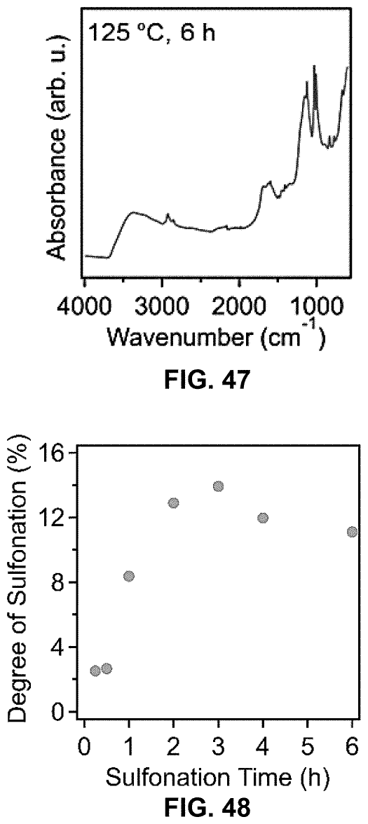

For samples sulfonated at temperatures of about 85° C. and about 125° C., the FTIR spectra indicated a reduced presence of the characteristic bands (sulfonic acids: 1033 cm⁻¹ and 1006 cm⁻¹ , alkenes: 1615 cm⁻¹) associated with the crosslinking reaction, in addition to the retention of the alkyl stretching vibrations (2851 cm⁻¹ and 2920 cm⁻¹ ), as shown in FIGS. 46 and 47. This indicates a not fully completed reaction. These results in addition to the FTIR spectra of the samples sulfonated at a temperature of about 150° C. suggest that the sulfonation temperature of SEBS precursor material is an important process parameter to control their crosslinking kinetics.

### EXAMPLE 15

In this Example 15, titration experiments were performed on samples of the sulfonated SEBS118 materials sulfonated at a temperature of about 150° C. of Example 13. The titration experiments were conducted to determine the amount of sulfonic acid groups on the polymer backbone as a function of crosslinking time (i.e., the degree of sulfonation). This was accomplished by introducing samples of about 200 mg of the sulfonated SEBS118 in about 0.1 M sodium chloride (NaCl) solutions for about 48 hours to exchange the protons of the sulfonic acid with sodium ions. The solution in which each sample was soaked was then titrated using a 0.026 M NaOH solution until a pH of 7 to determine the concentration of acid present within the solution and thus the amount of sulfonic acid that was present in the polymer after reaction.

FIG. 48 depicts the sulfonation degree of SEBS118 samples as a function of crosslinking time, corresponding to the percentage of repeat units in the polymer that contain a sulfonic acid group. The degree of sulfonation was calculated using the following equation:

$$Degree of sulfonation = \frac{{V}_{NaOH} * {M}_{NaOH}}{\frac{{m}_{SEBS}}{{M}_{w , SEBS}} * N}$$

Where V_{NaOH} is the volume of NaOH required to neutralize the solution, M_{NaOH} is the molarity of the NaOH solution, m_{SEBS} is the mass of sulfonated polymer that was added to the NaCl solution, M_{(w,SEBS)} is the molecular weight of the polymer (118,000 g/mol), and N is the number of repeat units (about 2640). Ultimately, this calculation provides the percentage of repeat units that contain sulfonic acid groups after the sulfonation reaction.

As shown in FIG. 48, the degree of sulfonation increased to about 14% after 3 hours of reaction time and then decreased slightly to about 12%. This indicates that further olefination and crosslinking of PEB can lead to reduced amount of the sulfonic acid groups on the polymer backbones.

### EXAMPLE 16

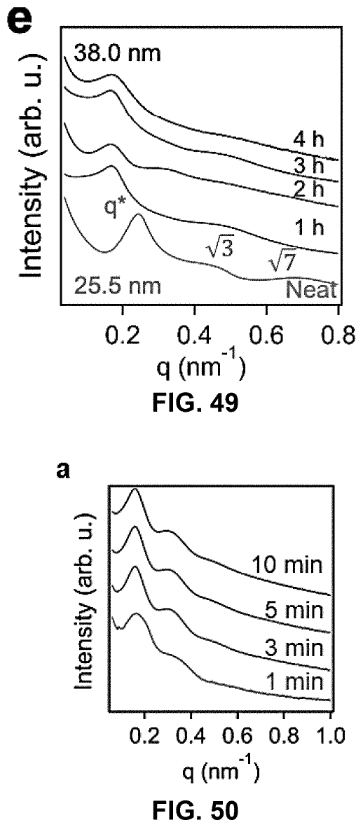

In this Example 16, the effects of the sulfonation reaction on the nanostructure of the SEBS118 material of Example 13 sulfonated at a temperature of about 150° C. were determined using small angle x-ray scattering (SAXS). As shown in FIG. 49, SAXS patterns were generated of neat SEBS118 material, SEBS118 material sulfonated for about 1 hour, SEBS118 material sulfonated for about 2 hours, SEBS118 material sulfonated for about 3 hours, and SEBS118 material sulfonated for about 4 hours. The neat SEBS118 had a primary ordering peak corresponding to a domain spacing of 25.5 nm, along with higher ordering peaks at ratios of 1:√3:√7 with respect to the primary peak position, indicating a hexagonally packed cylindrical morphology.

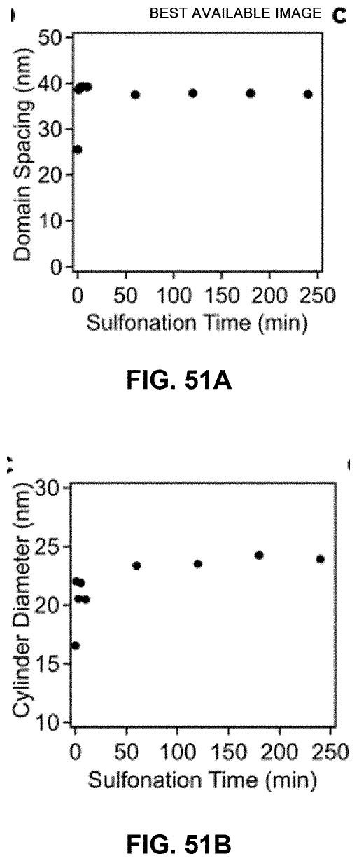

As shown in FIG. 50, SAXS patterns were also recorded for SEBS118 materials after 1 minute of sulfonation, 3 minutes of sulfonation, 5 minutes of sulfonation, and 10 minutes of sulfonation. The domain spacing increases rapidly after about 3 minutes of reaction to 38 nm and remains virtually constant throughout 4 hours of reaction, as shown in FIG. 51A. The rapid increase in domain spacing rapid the neat SEBS and the sulfonated SEBS material indicates that the nanostructure of SEBS materials may be altered almost immediately upon exposure to the sulfonating agent at 150° C.

Additionally, as shown in FIG. 51B, the scattering patterns were fit to model scattering functions which included a flexible cylinder form factor to account for scattering contributions from the size and shape of the minority cylindrical PS domains. A similar trend to the domain spacing evolution was observed where the cylinder diameter increased rapidly at short time scales from 16.6 nm to 22.0 nm within about 3 minutes of reaction, and then gradually increased throughout the reaction to 24.0 nm. These results further confirm that the nanostructure is established at very short reaction times and is only altered slightly at extended reaction times. Notably, comparing the increase in cylinder diameter throughout the reaction (˜7.4 nm) to the increase in domain spacing (˜12 nm) suggests that PS domain expansion as a result of the sulfonation reaction is the primary contributor to the altered nanostructure.

Referring again to FIG. 49, the higher ordering peaks became less distinguishable, which suggests a possible loss in the degree of ordering in the crosslinked polymer. With 14% degree of sulfonation observed in the SEBS118 sulfonated materials samples, as discussed in Example 14, the volume fraction of PS could increase up to 25%, suggesting that cylindrical phase should be maintained throughout the crosslinking process of nanostructured SEBS. Particularly, the SEBS118 nanostructure was kinetically trapped within less than 10 min of sulfonation reaction, further limiting the possibility of an order-to-order transition to occur.

### EXAMPLE 17

In this Example 17, thermogravimetric analysis (TGA) experiments were conducted on samples of the SEBS118 materials of Example 13 using a Discovery Series TGA 550 from TA instruments. Samples were heated in N₂ atmosphere at ramp rates of 10° C./min. Samples included neat SEBS118 and SEBS118 materials after sulfonation for 4 hours at a temperature of about 150° C. Samples of sulfonated PS were also tested.

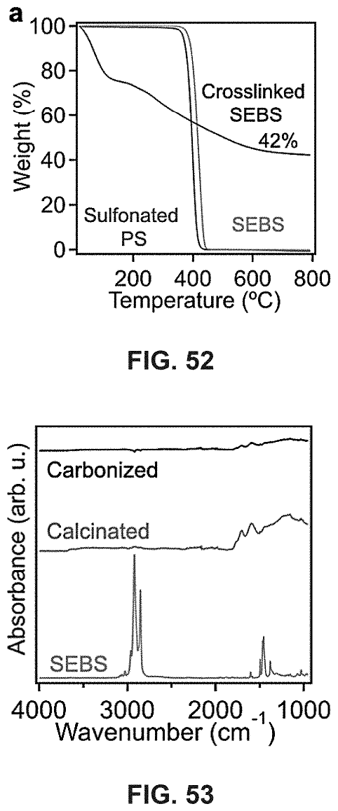

FIG. 52 depicts the TGA results of testing of the samples. Neither the neat SEBS118 polymer samples nor the sulfonated PS samples exhibited any carbon yield above ˜400° C. in a N₂ atmosphere. The sulfonated SEBS118 samples, however, resulted in roughly 42% residual mass, suggesting a carbon yield of about 67% by weight in comparison to the initial mass of the polymer prior to obtaining the mass gain from sulfonation. These results indicate that a) sulfonation induced crosslinking is required to produce carbon from the SEBS118 polymer and b) sulfonation of PS proceeds solely through the reaction with the aromatic ring of the repeat unit, which does not yield carbon products upon pyrolysis.

### EXAMPLE 18

In this Example 18, sulfonated samples of SEBS118 materials were calcinated after washing. The washed structures were heated in a tube furnace under a N₂ atmosphere at about 400° C. for about 3 hours with a ramp rate of about 10° C./min to form calcinated SEBS118 samples. Samples of the sulfonated and/or crosslinked SEBS118 materials were also carbonized by pyrolyzing the materials in a tube furnace by first heating to about 600° C. with a ramp rate of about 1° C./min followed by increasing the temperature to either a) about 800° C., b) about 1000° C., or c) about 1200° C. at a ramp rate of about 5° C./min.

As shown in FIG. 53, FTIR spectra were created of the calcinated SEBS118 materials and the carbonized SEBS118 materials at 800 C. The removal of PS segments can be confirmed by the diminished bands associated with the alkyl stretches of the polymer backbone, as many were reacted to form crosslinks during the sulfonation process, and the alkene stretching vibration at 1603 cm⁻¹ is present as a result of the formation of double bonds during the crosslinking reaction. Additionally, the secondary band at 1704 cm⁻¹ can be attributed to the presence of various oxygen containing functional groups, such as ketone and aldehydes, that are a result of side reactions during the crosslinking process. Similarly, the broad band shown in FIG. 53 from about 1000 cm⁻¹ to 1500 cm⁻¹ was a result of multitudes of sulfur and oxygen containing functional groups installed into the polymer network through crosslinking. The prevalent functional groups indicate that the mesoporous material contains polymer characteristic after the calcination process.

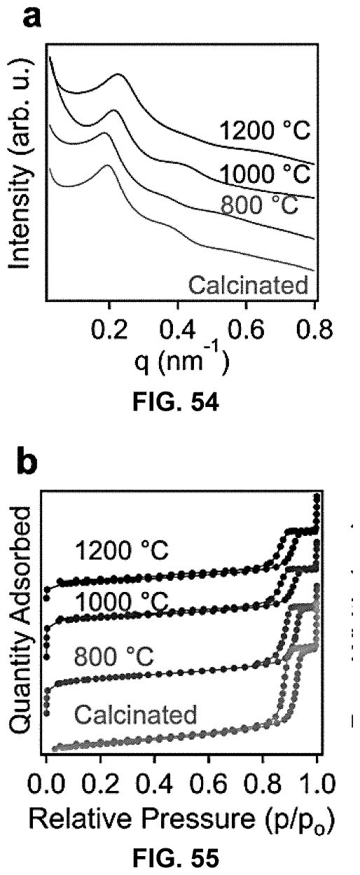

SAXS patterns were generated of the calcinated SEBS118 materials as well as the carbonized SEBS118 materials. As shown in FIG. 54, after calcination at about 400° C. for about 3 hours, the domain spacing decreases to 32.7 nm. After carbonization at 800° C., the domain spacing of the sample sulfonated for about 4 hours at a temperature of about 150° C. slightly increased to about 33.9 nm, which shrinks to 29.4 nm and 27.9 nm by increasing pyrolysis temperature to 1000° C. and 1200° C., respectively. Additionally, the SAXS patterns of these samples all exhibit secondary ordering peaks, indicating the presence of long-range ordering within the hexagonally packed cylindrical morphology. The emergence of these high ordering peaks in the OMCs, compared to crosslinked samples, is likely due to the enhanced scattering contrast between pore voids and the carbon/polymer framework. After carbonizing at 800° C., no distinct vibrations are present in the FTIR spectrum, due to the absence of functional groups.

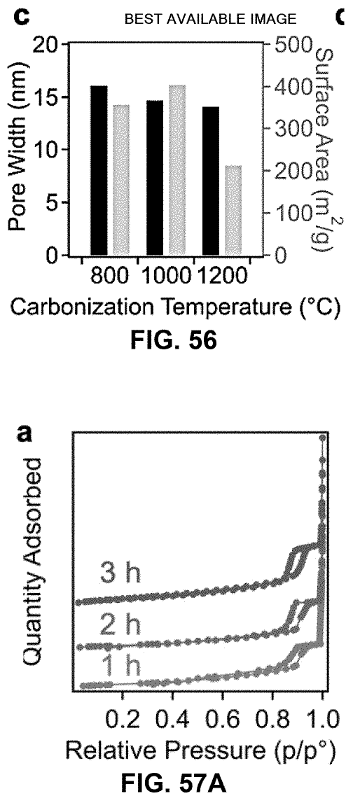

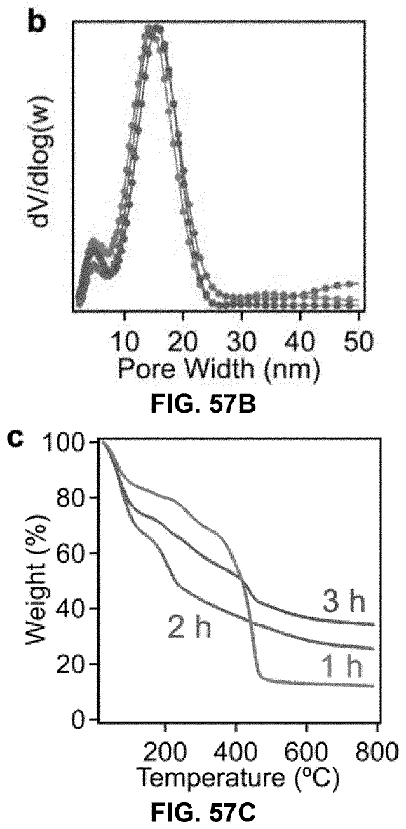

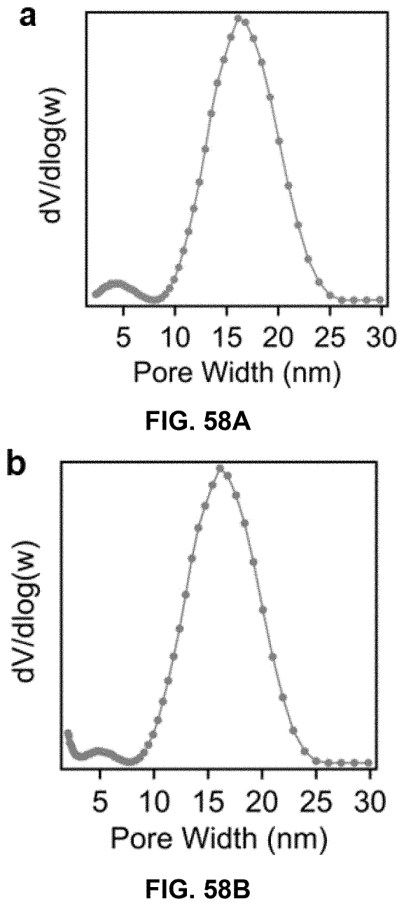

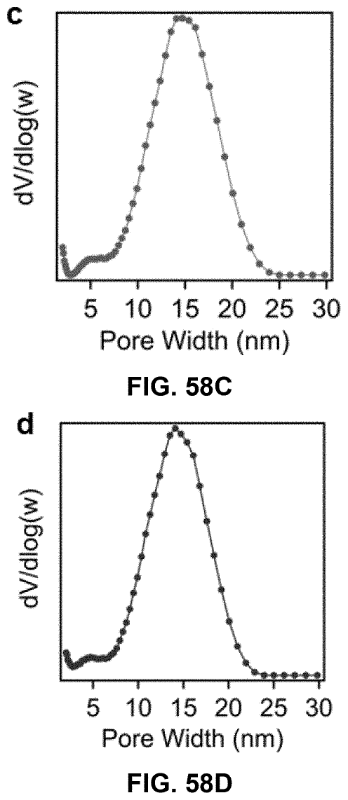

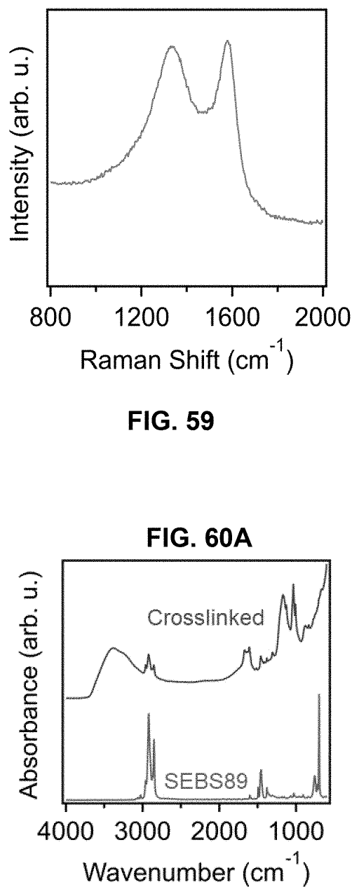

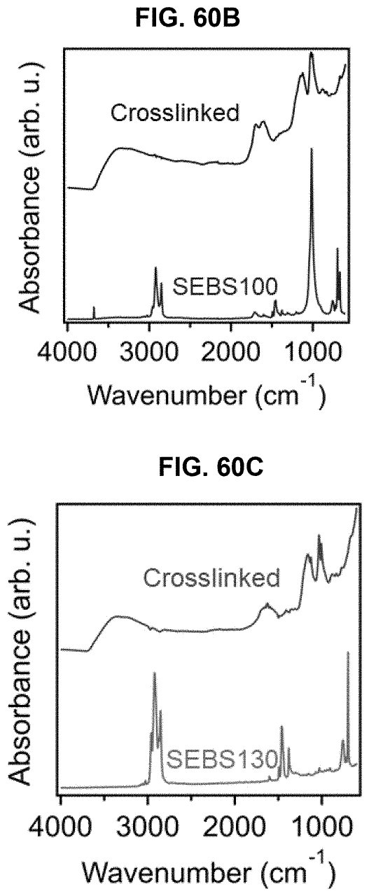

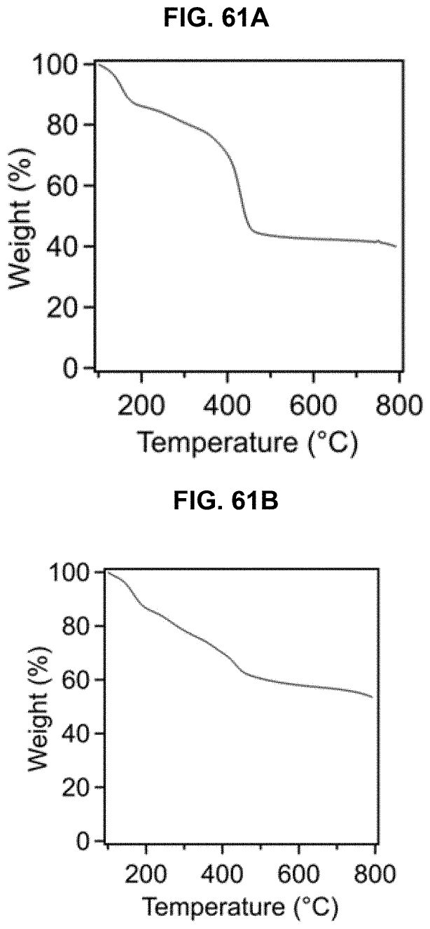

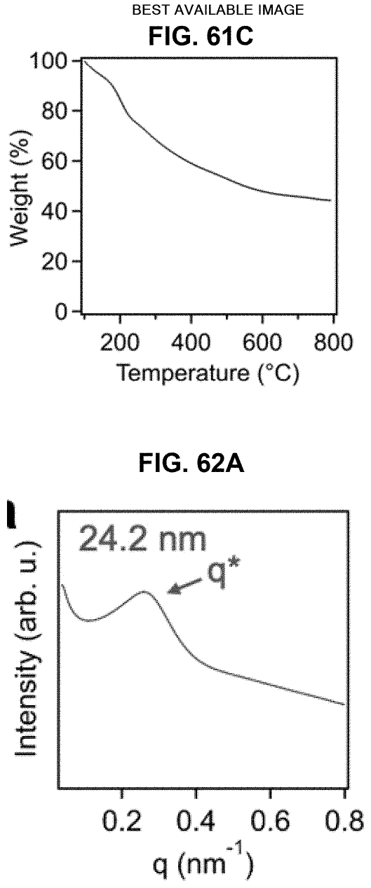

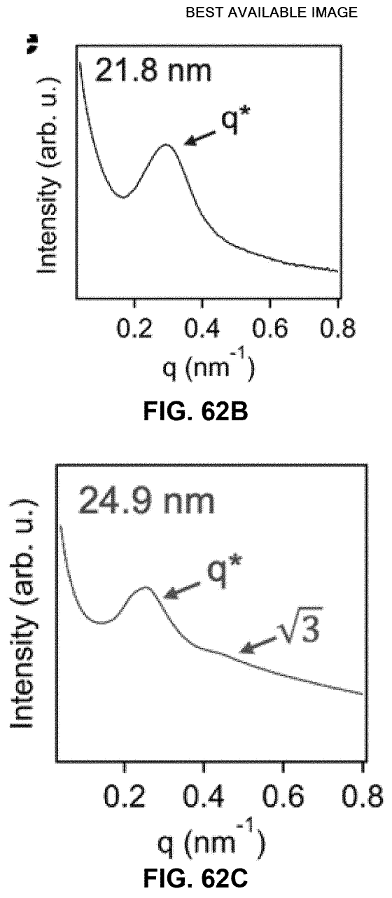

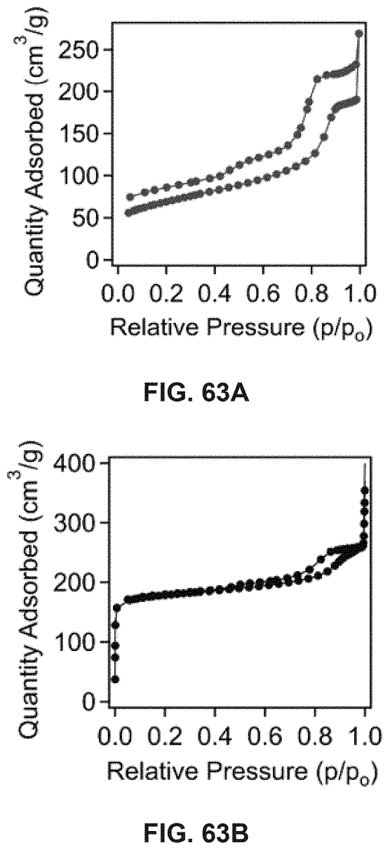

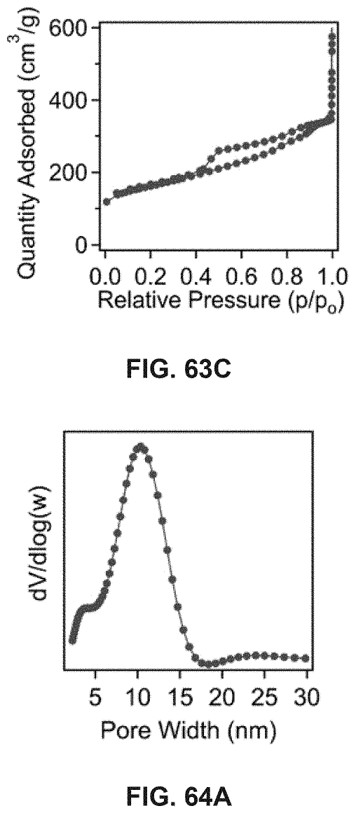

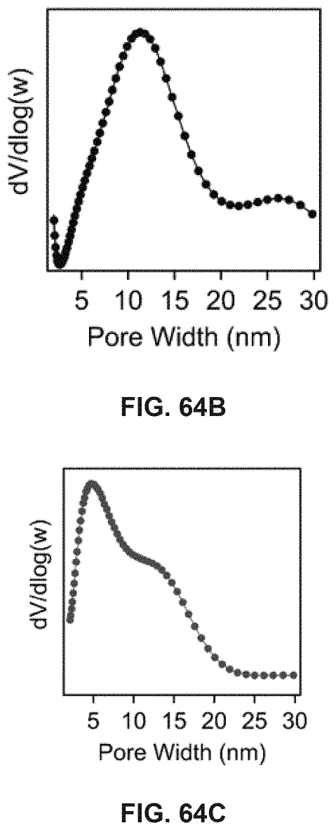

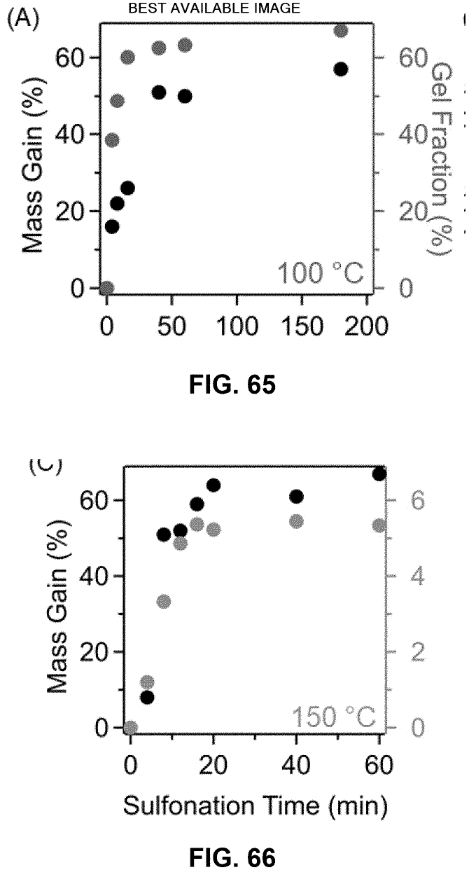

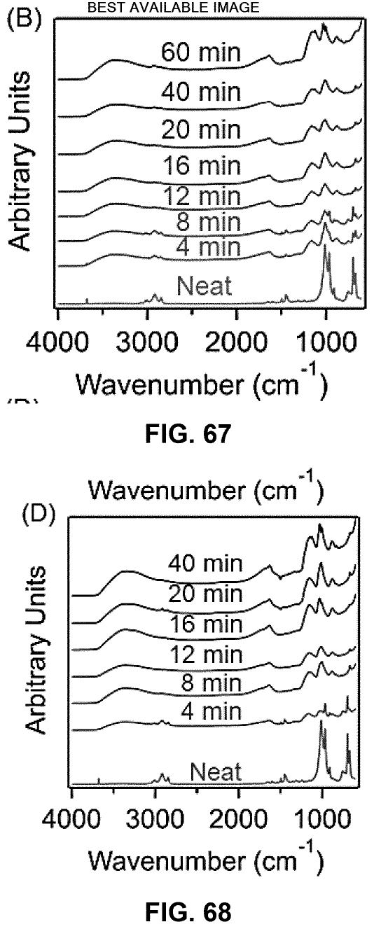

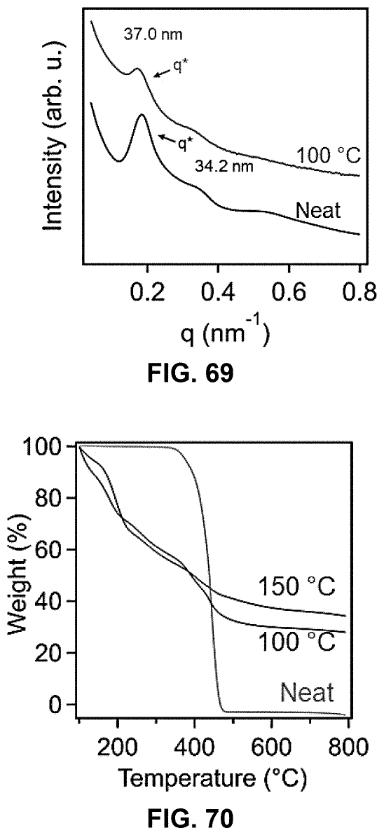

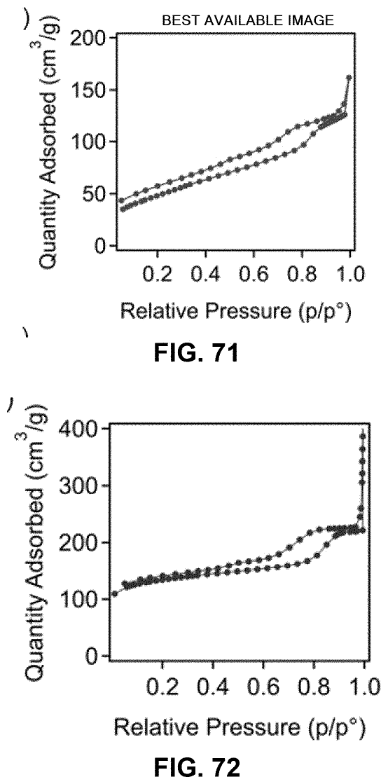

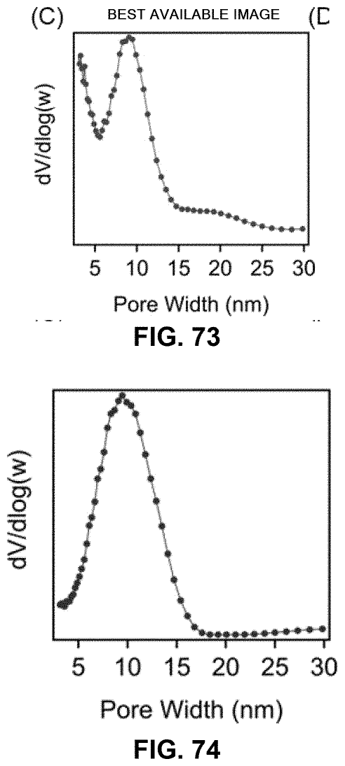

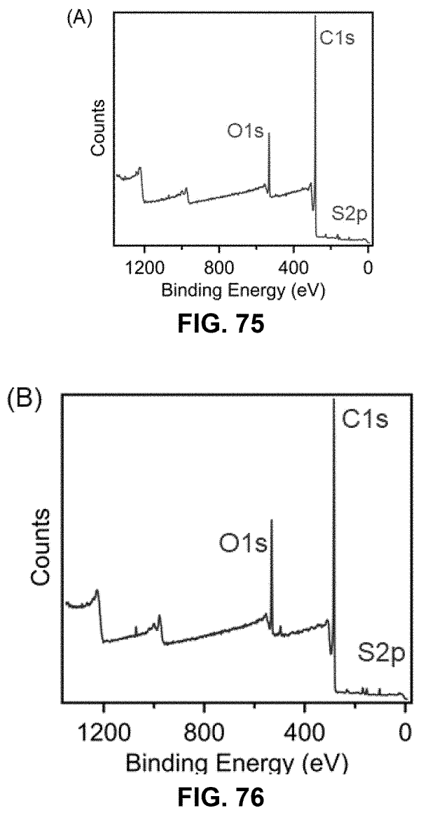

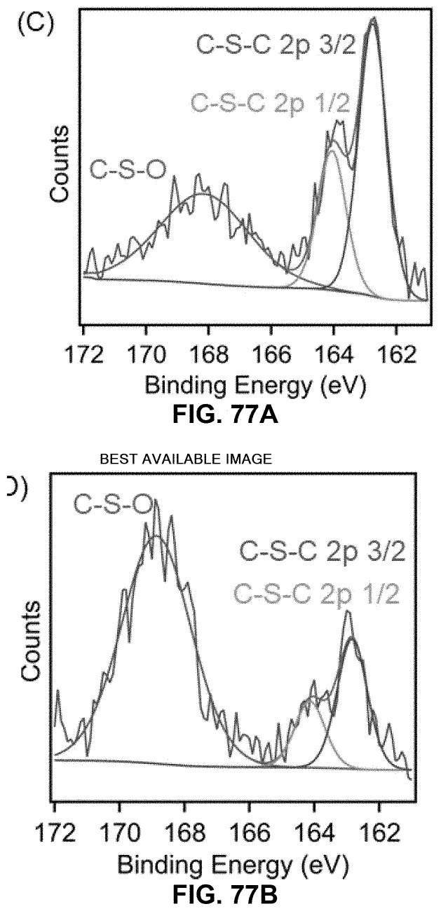

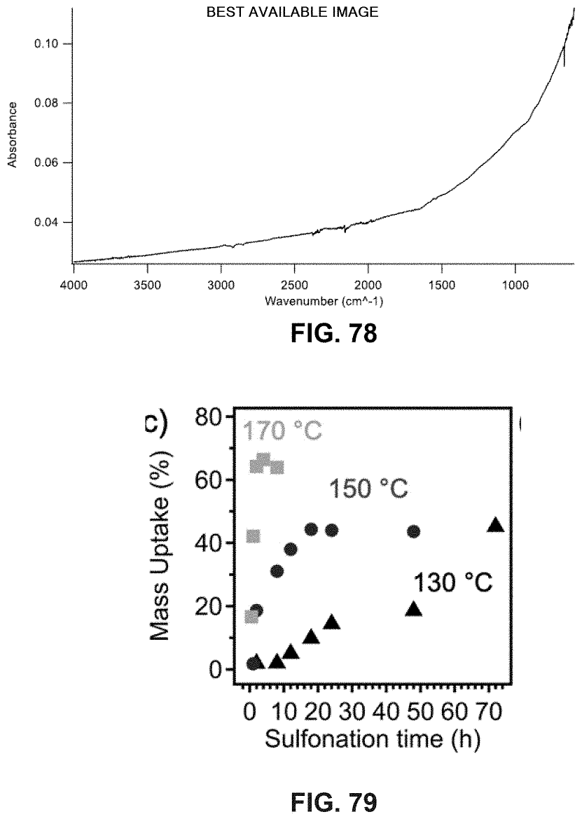

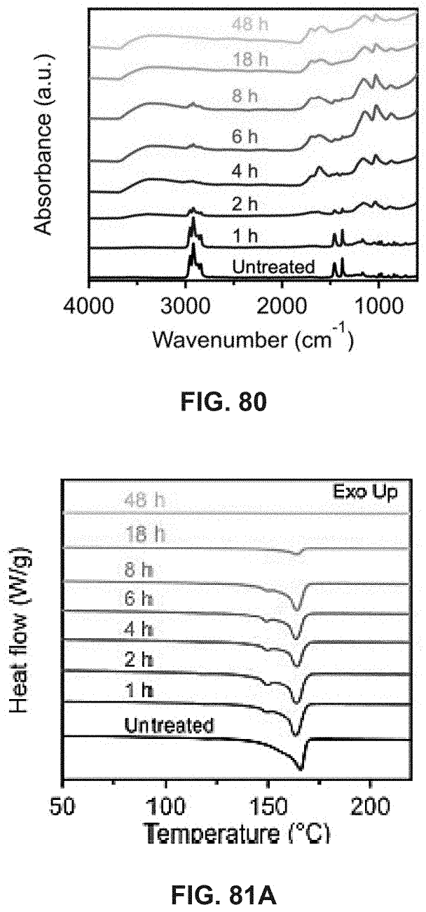

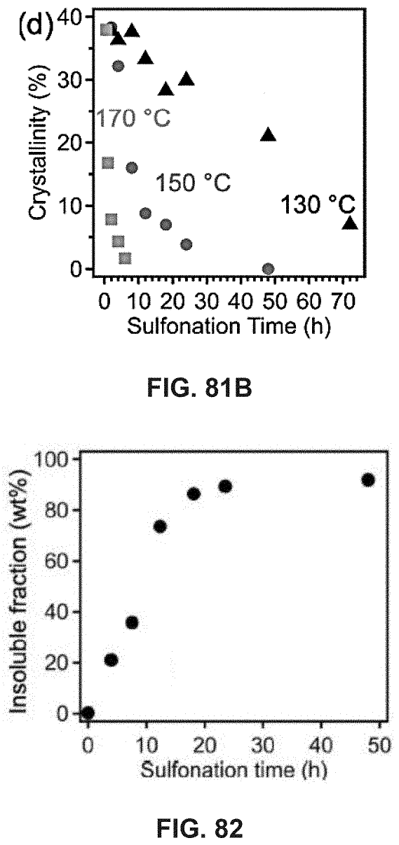

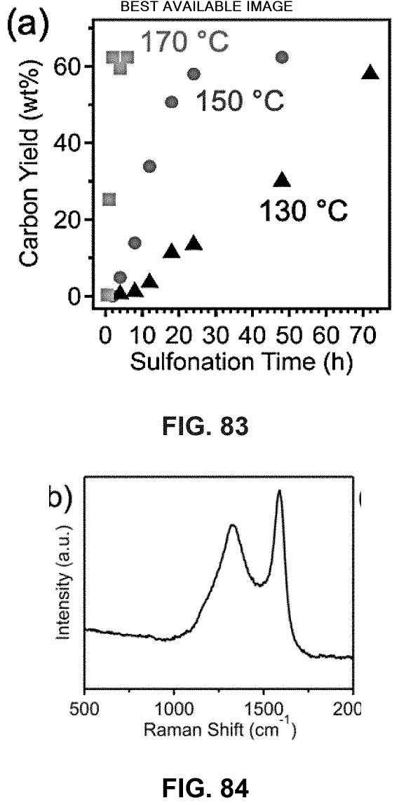

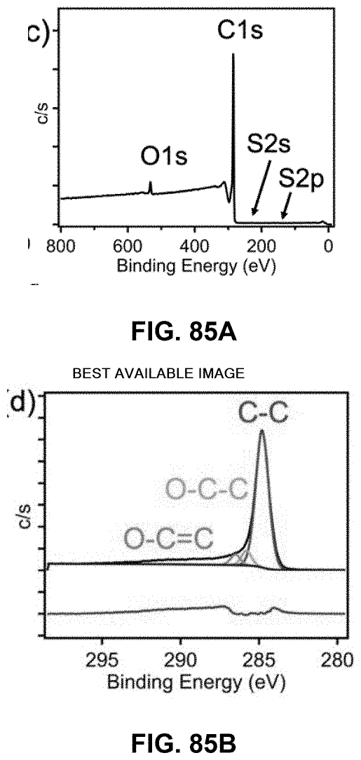

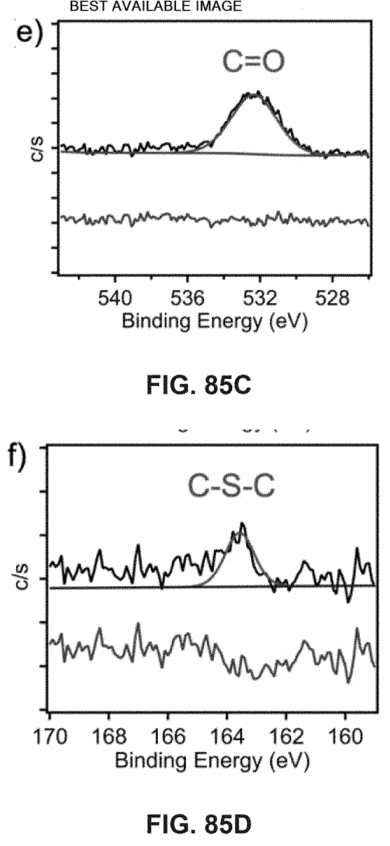

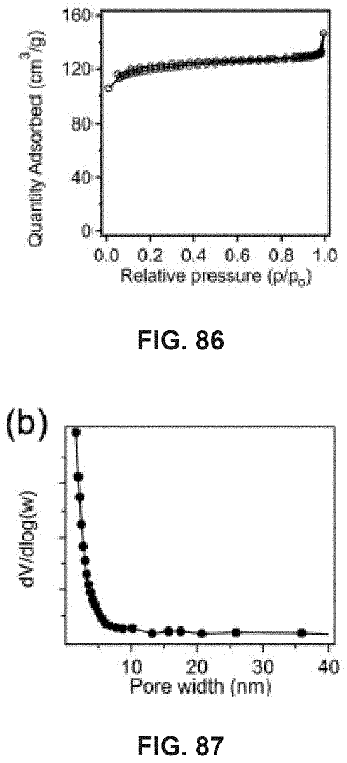

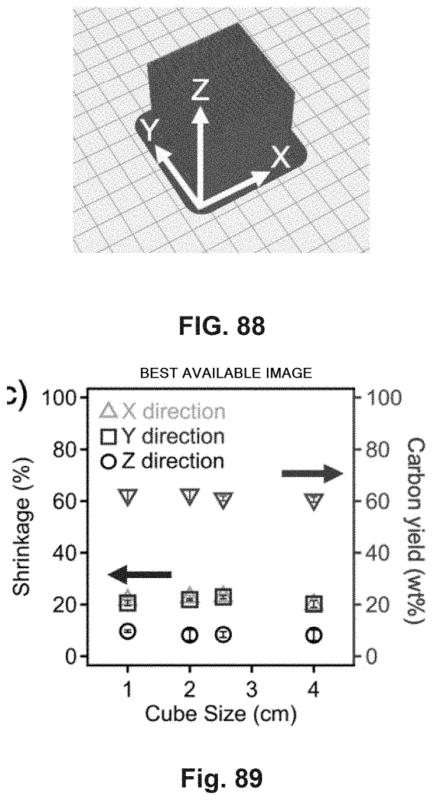

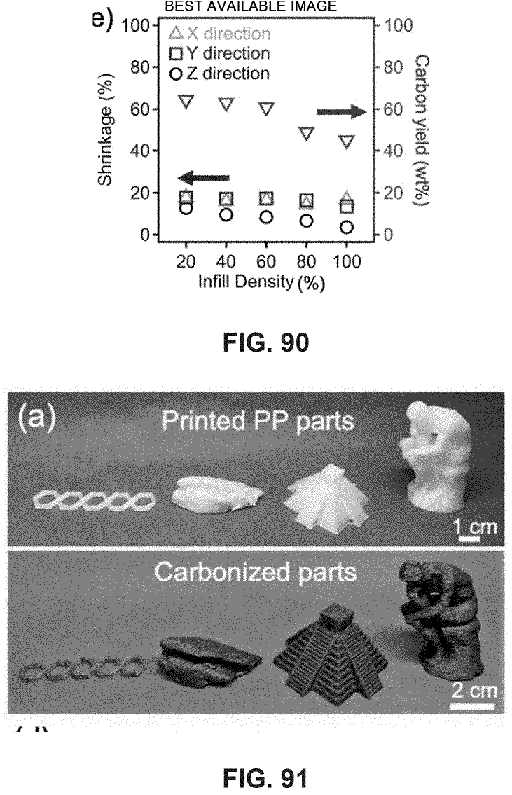

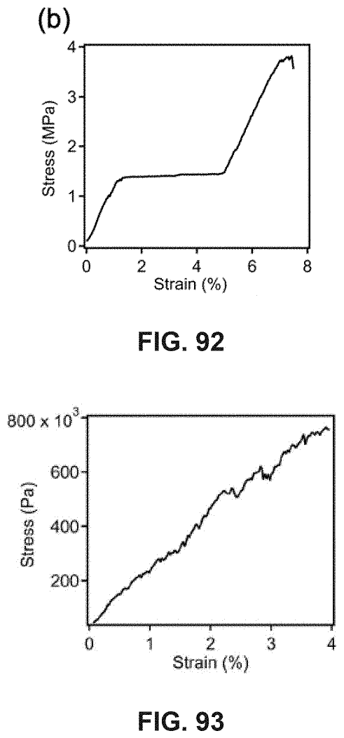

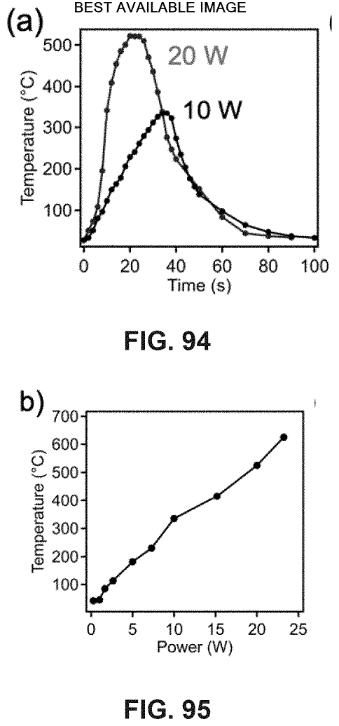

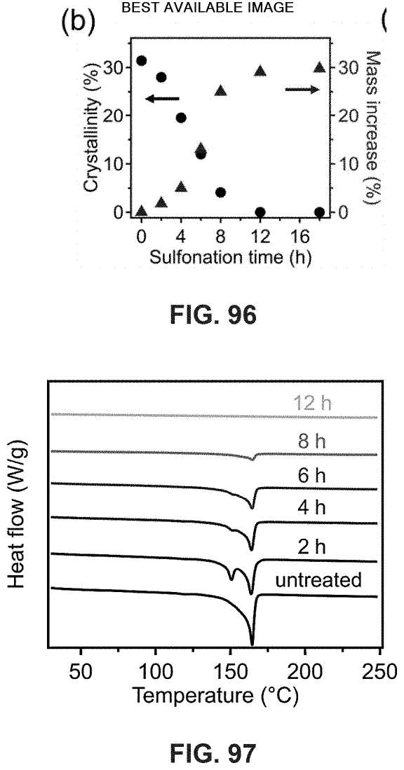

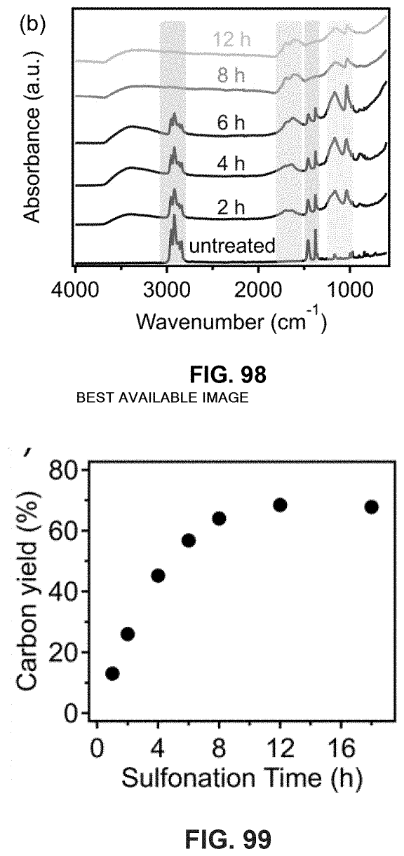

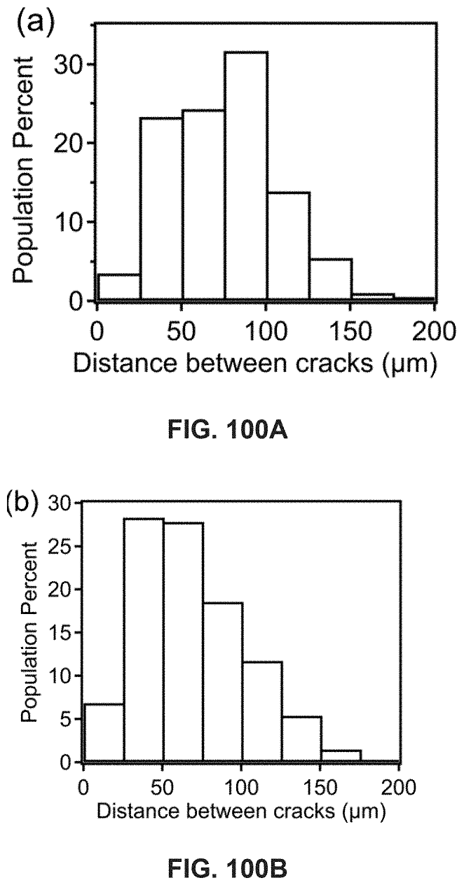

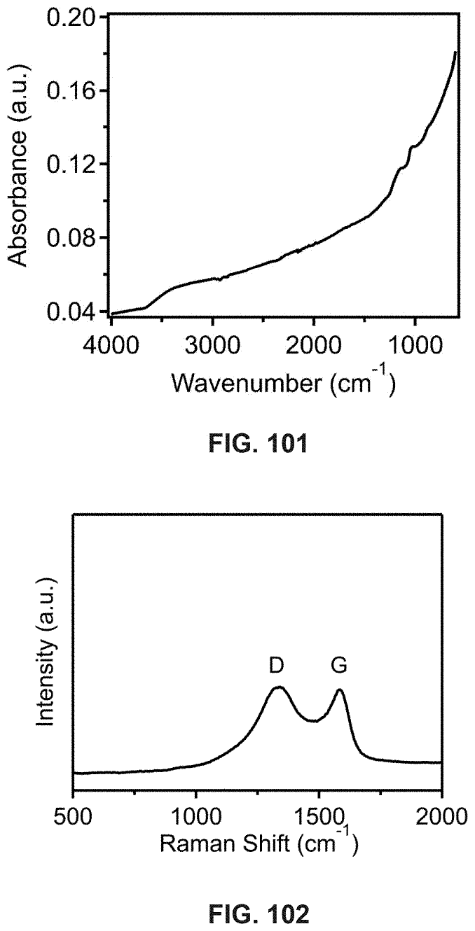

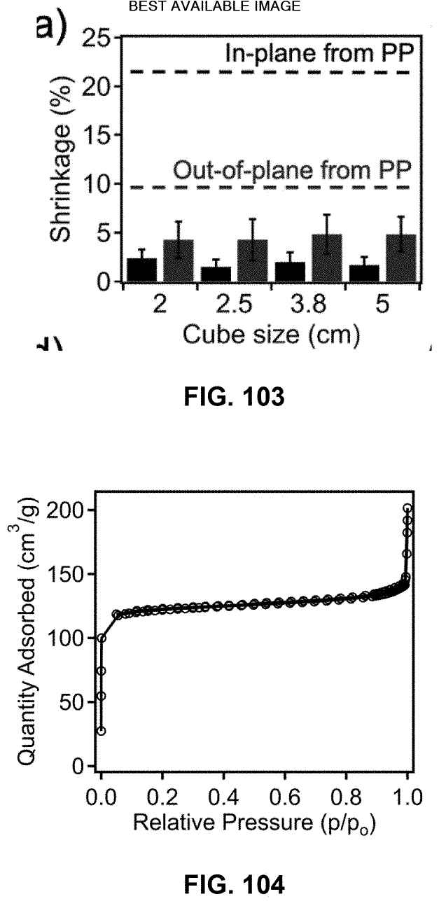

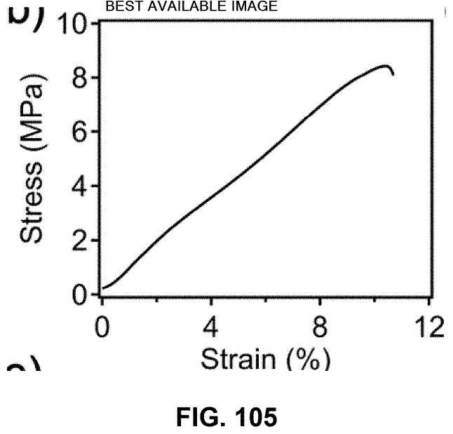

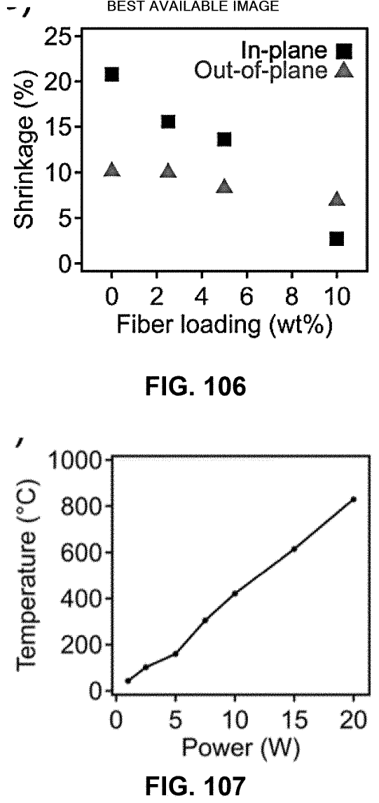

Nitrogen adsorption and desorption isotherms were recorded at 77 K through the use of a Tristar II 3020 (Micromeritics). As shown in FIG. 55, a typical type IV nitrogen adsorption isotherm was observed, confirming the formation of ordered mesoporous structures. Pore size distributions and pore volumes were calculated using non-local density functional theory (NLDFT) models for carbon slit pores at 77 K and surface areas were determined through Brunauer-Emmett-Teller (BET) analysis. As shown in FIG. 56, the average pore size distribution of the mesoporous polymer determined by non-local density functional theory (NLDFT) modeling is approximately about 16.1 nm in diameter, and the BET surface area is about 133 m²/g.

### EXAMPLE 19

In this Example 19, samples of the SEBS118 materials sulfonated for about 1 hour, about 2 hours, and about 3 hours were carbonized at a temperature of about 800° C. under N₂ atmosphere. These results indicate that sulfonation times are still sufficient for producing relatively well-ordered porous carbon materials and confirm the presence of ordered mesopore structures.

As shown in FIG. 57A, nitrogen physisorption isotherms were created for the carbonized SEBS118 samples of this Example 19. As shown in FIG. 57B, pore size distributions were found for the carbonized SEBS118 samples of this Example 19. The samples demonstrated a gradual increase in the averaged pore size from about 14.1 nm for samples sulfonated for about 1 hour before carbonization to about 15.6 nm for samples sulfonated for about 3 hours before carbonization. These results suggest that SEBS118-derived OMC can have process-tunable pore textures, enabling controlled pore sizes by varying crosslinking conditions. The pore size distributions of all SEBS118-derived OMC samples are included in FIGS. 58A-58D. Specifically, the SEBS118 derived OMCs exhibited the averaged pore sizes of 16.1 nm, 14.7 nm, and 14.1 nm, when they were carbonized at 800° C., 1000° C., and 1200° C., respectively. Notably, when comparing the calcinated mesoporous polymer to the SEBS-OMC carbonized 1200° C., only ˜9% shrinkage was observed in pore diameters, which is significantly lower than surfactant-templated mesoporous materials (-48%). Furthermore, BET surface areas of these OMC materials are 357 m2/g (carbonized at 800° C.), 404 m2/g (1000° C.), and 212 m2/g (1200° C.) (see FIG. 53).

As shown in FIG. 57C, a TGA thermogram was also created for the carbonized SEBS118 samples of this Example 19. The thermogram reveals that increased reaction times are required for maximizing the carbon yield of the material after carbonization. Samples sulfonated for about 1 hour before carbonization exhibited only 12 wt % yield while samples sulfonated for about 2 hours before carbonization and samples sulfonated for about 3 hours before carbonization increased to about 26 wt % and about 34 wt %, respectively. In samples sulfonated for about 4 hour before carbonization, the yield was maximized at about 42 wt %.

Scanning electron microscopy images (SEM) were recorded on a Zeiss Ultra 60 field-emission SEM with an accelerating voltage of 17 kV and samples were carbon sputtered coated prior to imaging. Pore size analysis of SEM images was conducted using ImageJ software. X-ray photoelectron spectroscopy experiments were carried out using an ESCALAB Xi+ spectrometer (Thermo Fisher) equipped with a monochromatic Al X-ray source (1486.6 eV) and a MAGCIS Ar+/Arn+ gas cluster ion sputter gun. All spectra were recorded with a takeoff angle of 90° with respect to the surface, and the base pressure during spectral acquisition was 3×10-7 mbar. High resolution scans were fit using Avantage software from Thermo Fisher. Values determined using the SEM images are found in Table 5 below.

TABLE 5

| | | | Average | | |
|---|---|---|---|---|---|
| | Domain | Surface | Pore | Pore | Sulfur |
| | Spacing | Area | Width | Volume | Content |
| Material | (nm) | (m²/g) | (nm) | (cm³/g) | (at %) |
| SEBS118-400 | 32.7 | 133 | 16.1 | 0.20 | 1.8 |
| SEBS118-800 | 33.9 | 357 | 16.1 | 0.41 | 1.5 |
| SEBS118-1000 | 29.4 | 404 | 14.7 | 0.38 | 0.9 |
| SEBS118-1200 | 27.9 | 212 | 14.1 | 0.42 | 0.7 |

Specifically, Table 5 includes values for domain spacings, pore textures and sulfur content of SEBS derived mesoporous materials determined through SAXS, nitrogen adsorption/desorption isotherms and XPS, respectively. Samples are named using the following naming convention which consists of two parts X-Y, where X represents the identity of the polymer precursor and Y represents the calcination/carbonization temperature. SEBS118-OMS is an exception and represents ordered mesoporous silica produced using SEBS118-800 as a template.

These XPS results of the calcinated mesoporous polymer, and the SEBS118-derived OMCs carbonized up to 1200° C., indicate the presence of sulfur doping in the mesoporous products. Specifically, the mesoporous polymer and SEBS118-OMC carbonized at 800° C. exhibited sulfur contents of about 1.8 at % and about 1.5 at %, respectively. Increasing carbonization temperature to about 1000° C. and about 1200° C. decreased the sulfur content to about 0.9 at % and about 0.7 at % as the heteroatoms are eliminated from the framework at elevated temperatures.

Raman spectroscopy experiments were conducted using a 328i spectrometer (Andor Kymera) with 600 I/mm gratings centered around 532 nm. The system was equipped with an Andor Newton camera, and the laser was operated at 532 nm with a power of ˜20 mW. As shown in FIG. 59, after carbonization at 800° C., the material exhibits a D/G ratio of 1.73, indicating that the carbon framework is largely amorphous in nature.

### EXAMPLE 20

In this Example 20, to show that the third method described above can be used with various TPEs to produce OMCs with different pore sizes, additional samples were sulfonated, crosslinked and carbonized. These samples each has an initial structure formed of one of SEBS89 precursor materials, SEBS100 precursor materials, and SEBS130 precursor materials. The initial structures were annealed under a nitrogen atmosphere at a temperature of about 160° C. for about 12 hours to establish long-range ordering in the structure's nanostructures. Each sample of the respective annealed SEBS material (about 0.300 grams each) was then submerged in about 3 grams of concentrated sulfuric acid solution at a temperature of about 150° C. for varying amounts of time. Measurements were taken for reaction times of about 0.25 hour, about 0.5 hour, about 1 hour, about 2 hours, about 3 hours, about 4 hours, about 6 hours, and about 8 hours. After the sulfonation was complete, the contents of each reaction vessel were passed through a glass fritted funnel, and the resulting polymer was removed. Each sample of sulfonated material was then washed with 200 mL of deionized water at least three times to completely remove the residual acid and other reaction by-products. The washed materials were then dried under vacuum.

The changes in chemical composition of the sulfonated polymers during the sulfonation reaction were illustrated using the FTIR spectra shown in FIGS. 61A-61C. Spectra were recorded over a range from about 4000 cm⁻¹ to about 600 cm⁻¹ with 32 scans at a resolution of 4 cm⁻¹. The characteristic bands corresponding to the addition of sulfonic acids to the polymer backbone, as well as the formation of double bonds are present, indicating the success of the crosslinking reaction. As shown in FIGS. 62A-62C, TGA thermograms for each material were also taken and demonstrate residual masses in the range between 40% and 54%, respectively.

The sulfonate and/or crosslinked samples were then carbonized by pyrolyzing the materials in a tube furnace by first heating to about 600° C. with a ramp rate of about 1° C./min followed by increasing the temperature to about 800° C. at a ramp rate of about 5° C./min. This carbonization formed the samples into samples of OMCs derived from their respective precursors (e.g., SEBS100-derivce OMCs).

SAXS profiles were generated of the carbonized samples, with results shown in FIGS. 62A-62C. Nitrogen adsorption and desorption isotherms were also recorded at 77 K through the use of a Tristar II 3020 (Micromeritics). The nitrogen isotherms are shown in FIGS. 63A-63C. Pore size distributions and pore volumes were calculated using non-local density functional theory (NLDFT) models for carbon slit pores at 77 K and surface areas were determined through Brunauer-Emmett-Teller (BET) analysis. These results can be seen for each material in FIGS. 64A-64C.

A summary of the resulting properties shown in FIGS. 61A-C can be found in Table 6 below,

TABLE 6

| | Domain | Surface | Average | Pore | Sulfur |
|---|---|---|---|---|---|
| | Spacing | Area | Pore Width | Volume | Content |
| Material | (nm) | (m2/g) | (nm) | (cm3/g) | (at %) |
| SEBS89-800 | 24.2 | 216 | 10.4 | 0.36 | 0.3 |
| SEBS130-800 | 24.9 | 501 | 4.7 | 1.33 | 1.6 |
| SEBS100-800 | 21.8 | 475 | 11.3 | 0.33 | — |
| SEBS118-OMS | 24.9 | 343 | 14.7 | 0.61 | 0 |

These results show that controlling the molecular weight of the precursor provides the ability to manipulate the pore texture of the final porous product. For instance, the domain spacing of the OMC. prepared using SEBS89, is reduced to about 24.2 nm as compared to the SEBS118-derived counterpart of Example 19 (33.9 nm). This is also confirmed through the nitrogen adsorption/desorption isotherm in FIG. 63A, which indicated an average pore size of 10.4 nm. The surface area of this material was 216 m²/g after carbonized at 800° C.

These results further demonstrate the versatility of this process through successful extension to a SEBS precursor (SEBS100) which is grafted with maleic anhydride (2 wt %). The samples of SEBS100 were successfully crosslinked, as determined through FTIR spectroscopy shown in FIG. 60B, and yielded about 44% residual mass after exposure to 800° C. in a N₂ atmosphere as shown in FIG. 61B. The samples of SEBS100-derived OMCs contained pores with an average pore size of 11.3 nm and a domain spacing of 21.8 nm. This further demonstrates the tunability of the structures which can be achieved through leveraging the sulfonation induced crosslinking reaction. Moreover, these results show that, while the samples of SEBS130 had a higher molecular weight than the samples of SEBS89, the respective derived OMCs still exhibit similar domain spacings. These results may be attributed to 1) a lower PS volume fraction, and thus reduced degree of domain swelling upon sulfonation, and 2) a higher volume fraction of polyolefin matrix in SEBS precursors potentially leading to a larger degree of shrinkage upon conversion to OMCs. The limited swelling of PS domains in SEBS130 upon crosslinking is further evidenced by the majority pore size ranging from 4-5 nm as shown in FIGS. 62C, 63C, and 64C. These results suggest that the pore wall is much thicker in the SEBS130-derived OMCs. Additionally, the presence of secondary ordering peak in shown in FIG. 62C confirms the SEBS130-derived OMC displayed ordered cylindrical morphology, while exhibiting an enhanced surface area of 501 m²/g. It is found that the pore size distribution of SEBS130-derived OMCs is broader than their counterpart from the other SEBS precursors, which may be attributed to the slower ordering dynamics during sulfonation-induced structural rearrangement associated with its higher molecular weight nature, and a higher degree of pore size shrinkage disrupting the morphology of resulting OMCs during carbonization process.

### EXAMPLE 21

In this Example 21, samples of initial structures were polystyrene-block-polybutadiene-block-polystyrene (SBS) pellets having an average diameter of about 8 nm to about 20 nm and having a molecular weight of about 118,000 g/mol, Ð of about 1.59, and ϕ_{PS}≈0.20. Samples of the pellets were placed in a reaction vessel containing about 3 g of sulfuric acid, which was then heated at either a temperature of about 100° C. or about 150° C. for varying amounts of time. Following sulfonation, the crosslinked samples were removed and washed with DI water three times to remove byproducts and residual acid. Subsequently, the samples were then dried overnight at 125° C. The progress of the sulfonation reaction was monitored through recording mass gain, gel fraction, and the evolution of functional groups in the polymer through FTIR spectroscopy, the results of which are provided in FIGS. 65-68.

The extent of crosslinking was investigated by gel fraction testing where samples were vigorously stirred in toluene for 60 min, and sample mass before and after extraction was compared. As shown in FIG. 65, samples of the pellets that were sulfonated at a temperature of about 100° C. resulted in gradual increases in both mass gain and gel fraction, which began to plateau around 60 minutes of reaction time at about 50% and about 62%, respectively. In comparison, as shown in FIG. 66, samples of the pellets that were sulfonated at a temperature of about 150° C. had a more rapid increase in mass gain and gel fraction, where the values began to plateau after about 20 minutes. This indicates that enhanced reaction kinetics at elevated temperatures.

These results are further supported through FTIR spectra provided in FIGS. 67 and 68. Chemical compositions of the initial structures and the sulfonated samples were probed using a Frontier attenuated total reflection Fourier transform infrared (FTIR) spectrometer. Spectra were collected at a wavenumber range of 4000-600 cm⁻¹ with an average of 32 scans at a resolution of 4 cm⁻¹. As shown in the FTIR spectra, the alkyl stretching vibrations (3130 cm⁻¹-2824 cm⁻¹) which correspond to reactive sites along the polymer backbone diminished as the reaction occurs. Similarly, the strong IR band at around 1013 cm⁻¹ in the spectrum of neat sample is associated with the alkenes present within the PB units of the polymer. Because these functional groups are reacted during the crosslinking reaction, the associated band diminished greatly after reacting at about 100° C. for about 8 minutes and at about 150° C. for about 4 minutes. A band at 1009 cm⁻¹ was found for both reaction conditions, which corresponds to the in-plane skeletal vibrations of aromatic rings in the PS repeat units that are substituted with sulfonic acids. As the reaction progressed, a secondary band at 1030 cm⁻¹ evolved, which is representative of increased sulfonation degree of the PB backbone. Similar to the mass gain and gel fraction results, the FTIR showed that the reaction at 150° C. resulted in more rapid evolution of the chemical structure, indicating faster kinetics. The enhanced reaction kinetics can be attributed to the presence of alkenes within the SBS precursor. These functionalities can readily react to form intermolecular crosslinks, as double bonds are known to be more reactive than single bonds due to their more electron rich nature, which can also facilitate the installation of sulfonic acid groups along the polymer backbone. In turn, diffusion of the concentrated sulfuric acid crosslinking agent is greatly encouraged resulting in are more rapid reaction.

Small angle x-ray scattering (SAXS) measurements were taken of neat samples of the SBS pellets and of the samples sulfonated at a temperature of about 100° C. As shown in FIG. 69, sulfonation at 100° C. results in swelling of the SBS domains from 34.2 nm to 37.0 nm after 60 min of the crosslinking reaction. This indicates that crosslinking of SBS resulted in a slight increase in their domain spacings.

### EXAMPLE 22

In this Example 22, samples of the sulfonated materials of Example 20 were carbonized by heating the samples under a N₂ atmosphere at a rate of 1° C./min to 600° C. and thereafter 5° C./min to 800° C. using a tube furnace.

Thermal degradation profile of sulfonated SBS was further characterized by thermogravimetric analysis (TGA) under a nitrogen environment to 800° C. at a rate of 20° C./min. The TGA was used to study the decomposition of the SBS precursors and their carbon yield. The TGA results shown in FIG. 70 indicate carbon yields of about 28 wt % for the samples which were sulfonated at about 100° C. for about 60 minutes and carbon yields of about 34 wt % for the samples which were sulfonated at about 150° C. for about 20 minutes. Accounting for the mass gain of the precursor during the sulfonation process, these carbon yields are equivalent to about 44 wt % and about 56 wt %, with respect to the mass of the neat precursor. The diminished carbon yield of the sample sulfonated at 100° C. is potentially due to insufficient crosslinking which is evidenced by the significant degradation step at ˜350° C.

### EXAMPLE 23

In this Example 23, the structure of the SBS-derived OMCs after carbonization of the materials used to form the samples examined in Example 22 were studied through a suite of characterization measurements. Nitrogen physisorption experiments were employed to investigate the surface area, porosity and PSD of the SBS-derived OMCs at varied reaction temperatures. The liquid nitrogen physisorption isotherms of OMC samples (at 77 K) were characterized on a Micromeritics Tristar II 3020. As shown in FIGS. 71 and 72, both samples exhibit a typical Type IV isotherm representative of mesoporous materials, which was further analyzed.

Surface areas were found through Brunauer-Emmett-Teller (BET) analysis. BET surface areas of SBS100 and SBS150 were found to be about 176 m²/g and about 373 m²/g, respectively. As shown in FIGS. 73 and 74, nonlocal density functional theory (NLDFT) models were used to determine the PSD of the SBS-OMCs. Both materials exhibited a very similar averaged pore size of 9.1 nm and 9.5 nm for SBS100 and SBS150, respectively.

An ESCALAB Xi⁺spectrometer (Thermo Fisher) equipped with a monochromatic A1 X-ray source (1486.6 eV) and a MAGCIS Ar⁺/Arn⁺ gas cluster ion sputter gun was used for X-ray photoelectron spectroscopy (XPS) characterization. A base pressure in the analysis chamber of 3×10⁻⁷ mbar and a takeoff angle of 90° from the surface was set for spectral acquisition. As shown in FIGS. 75 and 76, the XPS survey scans depict sulfur contents of 0.6 at % and 1.4 at % for SBS100 and SBS150 samples, respectively, which are in a similar range compared to SEBS-derived OMCs, as well as many other polyolefin precursors including polypropylene and polyethylene. The high resolution S2p scans shown in FIGS. 77A and 77B indicate the presence of these two bonding environments of sulfur heteroatoms in carbon frameworks. SBS150 contains a larger ratio of the C—S—O bonds (77 at %) than SBS100 (38 at %). These XPS results confirmed the successful incorporation of sulfur heteroatoms into the carbon framework of the SBS-derived OMCs and suggest that additional handles in controlling sulfur doping type and content by altering the crosslinking conditions.

### EXAMPLE 24

In this Example 24, the initial structure was a 3D-printed structure formed from PP-CF precursor materials. The CF content of the initial structure was about 15 wt %. The initial structure was printed into a gyroid-shaped following the recommended procedure from the manufacturer (0.4 mm print head, 0.2 mm layer height, bed temp 80° C., nozzle temp 225° C.). The initial structure was soaked in concentrated sulfuric acid (98%) at about 155° C. for about 6 hours. During sulfonation, a cracked, sulfur-doped carbon framework was created including cracking that occurs during sulfonation to assets in the diffusion of the sulfuric acid. After sulfonation was completed, the sulfonated initial structure was removed from the acid and washed with water. The sulfonated structure was then carbonized by heating the sulfonated structure to a temperature of about 800° C. at a heating ramp of 1° C./min.

To confirm the mass retention, FTIR spectroscopy was performed on the resulting carbonized structure. As shown in FIG. 78, the initial structure is formed entirely of carbon. Moreover, the resulting carbonized structure resulted in a mass retention of over 70% and dimensional shrinkage of less than 0.65%. The complex gyroid structures can be completely retained with very minimal shrinkage after carbonization. Additionally, the framework density of the resulting OMC fibers is low (0.6-0.7g/m3).

The ability to easily produce complex shapes may have applications such as heat sink, where large surface area is required for heat dissipation. Current heat sink technology has an over $10 billion USD market, but is largely limited to material selection (aluminum), and shape (only block-type shape can be produced). Our fabricated material will be well-suited for such application due to following advantages, 1) high thermal conductivity of our graphitic carbons; 2) large surface area from our unique printed structure; 3) significantly reduced materials and energy cost compared to metal fabrication; 4) no post-manufacturing waste being generated; 5) lightweight nature of our materials.

### EXAMPLE 25

In this Example 25, 3D printed initial structures were generated using an Ultimaker S5 FDM 3D printer. Commodity PP was used as starting materials, which can be directly converted to structured carbon. Each initial structure sample was formed of a gyroid cube with 1.65 cm in dimension, a wall thickness of about 0.6 mm, and a 20% infill density. The initial structure samples were printed using a nozzle temperature of 220° C., a bed temperature of 80° C. with Magigoo PP bed adhesive. A printing speed of 40 mm/s and a 20% fan speed were used during printing. The mass of printed structures, as well as parts after crosslinking, gel fraction test, and carbonization was obtained using a balance.

The initial printed structure samples were transferred to glass containers and submerged in 150 mL of concentrated sulfuric acid. The printed structures were completely submerged in sulfuric acid throughout the reaction. The containers were placed into a muffle furnace and heated to either 130° C., 150° C., or 170° C. at a ramp rate of about 1° C./min for crosslinking reactions to occur. The sulfonation process was held under isothermal conditions for a controlled amount of time. Upon sulfonation, the initial printed structure samples were removed from the muffle furnace and passively cooled to room temperature. The initial printed structure samples were then removed from the glass containers and rinsed by deionized water at least three times to completely remove the residual acid and other reaction by-products. The neutralization of acid wastes was confirmed using pH papers. Each of the initial printed structure samples was then rinsed with acetone to facilitate drying and placed in a vacuum oven for overnight.

These results indicated that the sulfonation temperature not only directly dictates the kinetics of PP crosslinking, but also influence the ability of a part to retain its printed geometry.

The sulfonation kinetics of PP can be elucidated by understanding their mass uptake as a function of time and reaction temperature, as shown in FIG. 79. The time for reaching a plateau value of mass increase in PP samples is dependent on reaction temperature, which decreased from about 18 hours to about 2 hours by increasing the sulfonation/crosslinking temperature from 150° C. to 170° C. For the samples crosslinked at 130° C., a continued mass increase was observed until the samples were reacted for about 72 hours. This suggests a sluggish reaction process. However, while 130° C. is lower than the PP melting temperature, the crosslinking reaction can still proceed, which can be explained by the highly exothermic nature of sulfonation.

An attenuated total reflection Fourier transform infrared (FTIR) spectrometer was used to monitor changes in the chemical composition of sulfonated printed structure samples as a function of time. The scan range was 4000 cm⁻¹-600 cm⁻¹ with 32 scans and a resolution of 4 cm⁻¹. FIG. 80 shows the FTIR spectra of the samples of sulfonated PP as a function of crosslinking time at 150° C. It is found that the reaction can be monitored by the formation of double bonds and sulfonic acid groups in the PP sample. Untreated PP exhibit bands indicative of C—H at 2920 cm⁻¹, which diminish as the sulfonation/crosslinking reaction progresses and almost completely disappear after about 18 hours. Additionally, three separate peaks indicative of reaction progress can be monitored. The broad —OH stretching band at 3300 cm⁻¹ emerged after about 2 hours and increased in intensity with reaction time. Peaks from 1250 to 1000 cm⁻¹ are attributed to the presence of sulfonic acid groups and the addition of alkenes into the PP backbone is demonstrated by the band at 1600 cm⁻¹.

Differential scanning calorimetry (DSC) was performed using a Discovery 250 (TA Instruments). A heat-cool-heat cycle was employed with an initial heating cycle from 20° C. to 220° C. at a rate of 10° C./min to erase thermal history. Samples were cooled to 20° C. at a rate of 5° C./min and then heated back to 220° C. at a rate of 10° C./min. Data analysis was performed using Trios software and results are shown in FIG. 81A. Furthermore, the progress of the sulfonation reaction was tracked using DSC measurements, in which the change in the degree of crystallinity of sulfonated PP was monitored as a function of time. Specifically, the degree of crystallinity was determined by comparing the measured enthalpy of melting events to that of a theoretical value from 100% crystalline polymer. As shown in FIG. 81B, characterizing the enthalpy of PP melt as a function of sulfonation time and temperature, it was found that reaction at 170° C. causes full loss of crystallinity after about 8 hours while at least about 48 hours and about 72 hours are required for samples crosslinked at 150° C. and 130° C., respectively. The functionalization and crosslinking of PP chains hinder their ability to crystallize due to the presence of bulky side groups and/or limited chain mobility. Therefore, the crystallinity of PP after sulfuric acid treatment is directly related with mass fraction of un-reacted portions in the samples.

A gel fraction test was performed by soaking crosslinked printed structure samples in hot xylene at 120° C. for about 24 hours and comparing the mass before and after extraction for determining the content of insoluble fractions. Additionally, as shown in FIG. 82, gel content (or insoluble fraction) was obtained for PP crosslinked at 150° C., which can reach a plateau value of 88 wt %. A control sample, neat PP, was completely dissolved after soaking in xylene at 120° C. for about 24 hours.

A Zeiss Ultra 60 field-emission scanning electron microscope (SEM) was also used to understand morphological changes in the printed structure samples after sulfonation for various amounts of time and after the carbonization process, with an accelerating voltage of 10 kV. In our 3D printed parts, PP with approximately 0.6 mm wall thicknesses of each layer were employed and a full degree of crosslinking was obtained within about 48 hours. This phenomenon cannot be simply explained by sluggish diffusion of sulfuric acid within polyolefin matrix, which would take much longer time for achieving complete penetration (more than several days). A close examination of the morphology of these gyroid parts after crosslinking for various times using SEM revealed that micro-size cracks are generated through the reaction process. These cracks provided an important mechanism for significantly facilitated diffusion and crosslinking kinetics, through which the acid can penetrate into these cracking-channels within printed parts for furthering the reaction. These cracks were observed to develop over time and their initiations have a strong dependence on reaction temperature. Since the reaction of PP is from outside in, the chemical changes on the outer layers of the printed parts directly alter their thermal expansivity and hydrophobicity.

Using SEM, we found that the crosslinking was completely penetrated through thick, printed PP parts after crosslinking at 150° C. for about 48 hours, confirmed by solid PP structures after rigorous solvent extraction using hot xylene. The averaged crack-to-crack distances for samples were slightly reduced to 108 μm at 150° C. For samples that were crosslinked at 170° C., significant disruption to the layered microstructure was observed and the averaged crack-to-crack distance increased to 208 μm. Additionally, at 170° C. the formation of pores within the printed structure was observed. These voids were resulted from the release of gaseous byproducts from the sulfonation reaction developing within the softened polymer structure, causing framework expansion and disruption to the overall structure. For PP samples crosslinked at 150° C., approximately 4% of dimensional expansion was observed in the printing directions after about 48 hours.

### EXAMPLE 26

In this example 26, carbonization of the sulfonated printed structure samples of Example 26 was performed using a tube furnace under a N₂ atmosphere at a rate of about 1° C./min to 600° C. and thereafter at a rate of about 5° C./min to 800° C. Various samples were heated to a higher carbonization temperature of 1400° C. to be used to confirm the geometry stability and mass yield of carbon products.

Carbon yield was calculated for each of the samples having various sulfonation conditions, as shown in FIG. 83. It was revealed that these PP parts can achieve up to a reproducible 62% product yield compared with the mass of their starting materials. These results also further confirm that a full degree of PP crosslinking (from thick, 3D printed parts) was obtained through our sulfuric acid treatment at elevated temperatures, while the crosslinking time necessary to reach the maximum carbon yield was highly dependent on the sulfonation temperature. It was found that reaction at 170° C. allows for maximum carbon yield to be achieved after only about 2 hours, while lower temperatures require extended necessary reaction times of about 48 hours and about 72 hours to reach the same yield for 150° C. and 130° C., respectively.

Raman spectroscopy was performed using a Andor Kymera 328i spectrometer (with 600 l/mm gratings centered on 532 nm) equipped with Andor Newton camera. The laser was operated at 532 nm, with ˜20 mW power. As shown in FIG. 84, Raman spectroscopy was used to characterize the degree of graphitization of FDM printed PP-derived carbon. The resulting ratio (I_{D}/I_{G}) of intensities between characteristic disordered and graphitic peaks was found to be 1.30, suggesting the resulting carbon was dominantly amorphous in structure. X-ray photoelectron spectroscopy (XPS) was performed using a Thermo Fisher ESCALAB Xi+ spectrometer equipped with a monochromatic Al X-ray source (1486.6 eV) and a MAGCIS Ar+/Arn+ gas cluster ion sputter gun.

Since our method inherently incorporates sulfur groups into the carbon framework, XPS was used to assess the heteroatom content present in the final carbon structures, as shown in FIGS. 85A-85D. XPS measurements were performed with the standard magnetic lens mode and charge compensation using a base pressure in the analysis chamber during acquisition of 3×10⁻⁷ mbar. Spectra were collected at a takeoff angle of 90° from the plane of the surface. The pass energy of the analyzer was set at 150 eV for survey scans with an energy resolution of 1.0 eV; the total acquisition time was 220 s. Binding energies were calibrated with respect to C1 s at 284.8 eV. All spectra were recorded using the Thermo Scientific Avantage software; data files were translated to VGD format and processed using the Thermo Advantage package v5.9904. FIG. 85A depicts an XPS survey scan while FIGS. 85B-85D depict high resolution XPS spectrums for C1s, O1s, and S2p, respectively. It was found that oxygen was present in the final carbon products at 3.4 at % and sulfur heteroatom was also observed with less than 0.5 at %. It was found that further carbonization at 1400° C. led to a slight decrease in mass (˜5 wt %) and increase in dimensional shrinkage (˜additional 3%).

SEM was used to elucidate the impact of carbonization conditions on the microstructures of PP-derived carbons. Nitrogen physisorption experiments were conducted using a Tristar II 3020 surface area and pore size analyzer (Micromeritics). The sorption measurements using N₂ at 77 K confirmed that only very limited pores (within the range of p/p₀ from 0.01 to 0.05) were generated, as shown in FIGS. 86 and 87.

### EXAMPLE 28

In this Example 28, dimensional shrinkage between the initial prints and the final carbon structures was assessed through the measurement of critical dimensions (including length, width, and height) of as printed and carbonized samples. A variety of gyroids were prepared with a unit dimension between about 1 cm and about 4 cm. Each of these sample gyroids were sulfonated at 150° C. for about 48 hours and carbonized at 800° C. FIG. 88 shows the gyroid cube geometry used to study the scalability of our process. The indicated X and Y directions represent the length and width of the part in the direction of extrusion, while the Z direction represents the height dimension of the part and the direction of layer deposition. The final dimensions and masses of samples after carbonization were compared to those of the initial printed parts as show in FIG. 89. It was found that, across all scales, the carbon yield was consistent, and the greatest shrinkage was always observed in the X and Y dimensions of the part, which were about approximately 20%-dimensional shrinkage. Our materials exhibit less than 25% variation in parts dimension from as printed to after carbonized. In the Z-direction, shrinkage was found to be consistently much smaller than the X or Y, limited to only 9%. Shrinkage across size scales was also observed to be consistent with a slight increasing trend as the structures increased in size, increasing from 1 cm to 4 cm in length of a model cubic part. Anisotropic shrinkage in these parts was likely the result of the inherent anisotropy of the specimens prepared by FDM printing. The resulting carbon products with different sizes, consisting of relatively complex gyroid structures, indicated that our method is effective and scalable in preparing structured carbons.

### EXAMPLE 29

In this Example 29, cubic gyroid structures with 2 cm in dimension, and a range of packing densities from 20% to 100%, were prepared. A control PP sample was also prepared by compression molding (2 mm in thickness). A first set of samples and the control sample were sulfonated at 150° C. for about 48 hours and carbonized at 800° C. The control sample was unable to be sufficiently crosslinked and resulted in structural collapse after carbonization. A second set of samples were sulfonated at 150° C. for about 72 hours and carbonized at 800° C.

The dimensional shrinkage and carbon yield were systematically assessed using the same approach set forth in Example 28. As shown in FIG. 90, samples with in-fill density up to 60%, it was found that a similar degree of carbon yield was obtained, following similar trends to that of the scaled cube study of Example 28. The shrinkage in the X and Y directions had the dominant effect and a reduced shrinkage was observed in the Z direction. At higher infilling densities (e.g. 80% and 100% in-fill densities), lower carbon yields (˜45 wt %) were observed for sulfonation at 150° C. for about 48 hours. This is likely due to the tightly packed printed structures slowing the diffusion of sulfuric acid into the part leading to the final carbon structures having a strong outer shell with a hollow interior.

Upon increasing the sulfonation time to about 72 hours, the yield achieved with these specimens was found to increase up to 55% with an 80% infill density and 50% with a 100% infill density. The degree of shrinkage in these densely packed parts was found to reduce overall with increasing in-fill density. Furthermore, in the 3D printed parts, inherent void channels were still observed even with 100% in-fill density). These channels can play an important role for encouraging sulfuric acid diffusion for PP crosslinking.

### EXAMPLE 30

In this Example 30, a variety of carbon products (as well as printed PP parts as starting materials) with relatively complex shapes (including hexagonal structures, wing-shape, pyramid, and The Thinker) were printed using PP starting materials as shown in FIG. 91. These samples were crosslinked at a temperature of 150° C. for 48 hours and then carbonized at 800° C. The hexagonal sample had a 100% infill density with a thickness of 2 mm. The complex wing, pyramid and The Thinker structures shown in were designed to an open cell gyroid infill pattern (infill density at 30%). This open cell structure also allowed for gaseous products to evolve and easily leave the system without disrupting the outer surface of the part. For these samples, the complex shapes from FDM printing were all successfully retained (see FIG. 91) with consistent dimensional shrinkage and mass yield, as shown in Table 7 below.

TABLE 7

| | Print- | Print- | Print- | Car- | Car- | Car- |
|---|---|---|---|---|---|---|
| | ed | ed | ed | bonized | bonized | bonized |
| | Length | Width | Height | Length | Width | Height |
| Sample | (mm) | (mm) | (mm) | (mm) | (mm) | (mm) |
| Hexagon | 69.6 | 14.3 | 2.1 | 50.6 | 10.8 | 1.82 |
| line | | | | | | |
| Wing | 36.4 | 20.7 | 17.5 | 30.2 | 16.9 | 14.2 |
| Pyramid | 50.1 | 49.9 | 23.7 | 40.3 | 40.0 | 20.5 |
| Thinker | 30.3 | 27.0 | 62.3 | 22.9 | 19.9 | 52.1 |

### EXAMPLE 31

In this Example 31, the mechanical properties of carbon structures from Example 28 were systematically investigated using compressive testing methods, to elucidate how the mechanical property anisotropy inherent to the FDM process impacts the final properties of carbon structures. Compressive mechanical testing was performed in accordance with a modified ASTM D695 standard using an MTS Insight test frame with a 5k N load cell and compression grips. A strain rate of 1 mm/min was used. Mechanical property data was analyzed using Igor Pro 8 to identify compressive yield strength by the point of zero slope in the stress strain curve and compressive modulus through the initial slope of the linear elastic regime. As shown in FIG. 92, it was found that normal to the Z direction, the resulting carbon (converted from PP with an in-fill density of 50%) displayed a yield strength of 3.3±0.4 MPa and an elastic modulus 118±20 MPa, while being lightweight with a bulk density of 0.4 g/cm³. Additionally, a complex yielding behavior occurred during compressive testing in the Z direction, where a plateau was observed between yield and failure.

FIG. 93 shows that a reduction in mechanical properties was observed normal to the X direction, with a yield strength of 0.6±0.1 MPa and an elastic modulus of 19±5 MPa. From these results, it was observed that the cracked microstructure within these carbon products led to lower mechanical properties. However, these printed carbon structures display high strength to weight ratios. A 1.5 g gyroid structured carbon product was able to support several aluminum blocks (with a total of 8 kg in mass), suggesting these materials can withstand at least 5300 times its weight. To further demonstrate the versatility of our process, and the mechanical properties of resulting carbon products, a carbon spring was prepared, which shows deformable properties, up to 20% compression strain was obtained.

### EXAMPLE 32

In this Example 32, model heating elements having a W-shape were sulfonated at a temperature of 150° C. for about 48 hours and then carbonized at a temperature of 800° C. were prepared and attached to a power source. The Joule heating capabilities of the carbonized elements were determined by connecting the carbonized elements to a DC power supply (from Dr. Meter) using a ceramic block as a support. The voltage was increased in increments of 1 V, and the temperature was measured using a thermal camera (from HTI) and/or a thermocouple until the equilibrium state was reached. The temperature of a heating element was tracked as a function of time for two defined power settings as shown in FIG. 94.

As shown in FIG. 94, under 10 W, the carbon reached an equilibrium temperature of 335° C. after 40 s. Upon increasing the applied power to 20 W, the time to reach equilibrium reduced to 20 s, while the equilibrium temperature was 525° C. These results confirm the rapid Joule-heating capability of these carbonized elements. Once the power was removed, the heating element was capable of being cooled to room temperature within two minutes, indicating a full control of heating and cooling through applying and removing the electrical current.

The relationship between power supplied and the temperature of the element was further demonstrated by incrementally increasing the power. As shown in FIG. 95, at 3 W of applied power the temperature of the part was seen to reach 100° C. and upon subsequent increase reached 613° C. at 25 W. Notably, the energy consumption in these systems (up to 35 W) is very low compared to other Joule-heating materials, showing a great advantage of our materials to be further used for electrifying industrial process and/or civilian applications.

### EXAMPLE 33

In this Example 33, recycled 3D filament was prepared by washing and drying PP from used disposal cups, which were granulated and subsequently extruded using a Filabot EX2 filament extruder with Filabot Puller at a barrel temperature of 225° C. and a screw speed of 15 rpm. The recycled filament was sulfonated at a temperature of 150° C. for about 48 hours and then carbonized at a temperature of 800° C. The specimens prepared from recycled PP filament exhibited an average carbon yield of ˜57 wt % and consistent shrinkage with that of commercially available, virgin PP filaments. The values of commercially available, virgin PP filaments are shown below in Table 8.

TABLE 8

| | Length | Width | Height | |
|---|---|---|---|---|
| | Shrinkage | Shrinkage | Shrinkage | Carbon Yield |
| Part | (%) | (%) | (%) | (wt %) |
| Cross cube | 19.8 | 19.9 | 9.2 | 60.8 |
| Ring | 22.2 | 21.5 | 11.9 | 56.3 |
| Gyroid cube | 21.8 | 20.6 | 9.1 | 60.4 |
| Gyroid | 19.7 | 20.6 | 9.5 | 54.3 |

This demonstrates that the process of the fourth method used in this Example 33 has potential as a plastic upcycling approach, creating value to post-consumer waste for addressing the challenges of massive PP waste.

### EXAMPLE 34

In this Example 34, sample initial structures were formed of a polypropylene-based filament, containing 15 wt % chopped carbon fiber fillers (PP-CF), was printed using the fused deposition modeling (FDM) method. The initial structures were each a model gyroid-shape sample (˜16 mm in all dimensions). Each initial structure was fully submerged in concentrated sulfuric acid within beakers. They were then transferred to a muffle furnace and the temperature was increased by 2° C./min until the sulfonation temperature of about 150° C. was reached. For crosslinking of PP-CF, isothermal conditions were maintained for a controlled time. Specimens were then removed from the glass containers and washed three times with DI water to completely remove residual acid and other reaction by-products. The neutralization of acid waste was confirmed using pH paper. Samples were then rinsed with acetone to accelerate drying and placed under vacuum in a vacuum oven overnight.

FIG. 96 illustrates the mass gain (due to the addition of bulky sulfur-containing functional groups into PP backbones) and the change in PP crystallinity (due to the transformation from linear polymer a crosslinked system) as a function of crosslinking time. However, as shown in FIG. 97, when the reaction time was extended to about 8 hours, a sharp increase in mass and a decrease in PP crystallinity were found, suggesting enhanced PP crosslinking kinetics across the entire part. After about 12 hours, both values reach a plateau, suggesting that a full degree of crosslinking was obtained. These results are consistent with Fourier transform infrared spectroscopy (FTIR) measurement shown in FIG. 98.

Sulfonation and crosslinking of the initial structures resulted in cracks generating after about 2 hour of reaction time, which is earlier than when PP counterparts with the absence of fillers demonstrated cracks under an identical crosslinking condition (i.e. 150° C.). The directionality of these microcracks in PP-CF systems can be attributed to the anisotropically enhanced mechanical properties in printed parts due to the presence of CFs, which were aligned by the extrusion shear force involved during the FDM process along with the printing direction.

Completely dried sulfonated samples were placed in an tube furnace tube furnace under an inert nitrogen environment for carbonization. A ramp rate of 1° C./min was used from ambient temperature up to 600° C. after which a 5° C./min rate was used until 800° C. was reached. Once the carbonization temperature was reached the procedure was finished and the furnace was allowed to cool naturally to ambient temperature, which took about 4 hours (from 800° C. to 25° C.). .

Upon pyrolysis, at least 67 wt % carbon yield, compared with the initial printed parts, was achieved for samples crosslinked for about 12 hours and longer, as shown in FIG. 99. Additionally, the crack distances were very similar between crosslinked and carbon parts, as shown by the graphs of FIGS. 100A and 100B. These results are consistent with their very minimal structural change at a macroscopic scale. Completion of carbonization was confirmed through FTIR (see FIG. 101) and Raman spectroscopy (see FIG. 102).

### EXAMPLE 35

In this Example 35, a series of cube shaped PP-CF parts were prepared, with sizes ranging from 2 to 5 cm and an in-fill density of 50%. Each cube was crosslinked at 150° C. for 24 hours and carbonized at 800° C. to quantitatively assess the shrinkage degree upon polymer-to-carbon conversion.

FIG. 103 illustrates dimensional shrinkage of the PP-CF gyroid cubes with dashed lines representing unfilled PP shrinkages in the X/Y directions (22%) and the Z direction (9%) As shown in FIG. 103, after carbonization, all samples exhibited only an average of 2% shrinkage in the in-plane directions (X and Y directions, along FDM deposition direction) and an average of 4% in the out-of-plane direction (Z direction, normal to deposition direction), relative to the as-printed PP-CF parts.

Carbon morphology at a nanoscale was found to be rough and porous as confirmed by SEM and nitrogen phisiosorption BET (see FIG. 104). This may contribute to the reduced shrinkage in this system as small uncrosslinked domains are able to evolve into gaseous products but do so without disrupting the surrounding macrostructure. PP-CF derived carbon was found to possess a surface area of 317.5 m2/g with an average pore diameter of 2.01 nm by BET analysis.

Additionally, carbon parts produced through this method exhibit substantially enhanced mechanical performance (FIG. 105), with an increased compressive strength of 8.5 MPa, compared to their counterpart derived from unfilled PP filaments (3.3 MPa). The feature of excellent mechanical robustness was further displayed by a lightweight (1.3 g) PPCF-derived carbon sample successfully supporting over 12.5 kg of mass, representing a strength-to-weight ratio of at least 9,600 in the final carbon material.

### EXAMPLE 36

In this Example 36, a variety of initial structures were printed using PP-CF precursor material, including a rhombic dodecahedral lattice, a golden eagle, a motorcycle helmet, and a koi. All parts successfully preserved their printed geometry with a consistent shrinkage of less than 5% across all directions and a carbon yield of more than 65 wt %, as shown in Table 9 below. These results further confirm that the described method is broadly applicable to various sample sizes and geometries.

TABLE 9

| | Print- | Print- | Print- | Car- | Car- | Car- | |
|---|---|---|---|---|---|---|---|
| | ed | ed | ed | bonized | bonized | bonized | Carbon |
| | Length | Width | Height | Length | Width | Height | yield |
| Sample | (mm) | (mm) | (mm) | (mm) | (mm) | (mm) | (%) |
| Lattice | 52.63 | 50.31 | 40.54 | 50.45 | 48.74 | 38.37 | 66.42 |
| Eagle | 43.81 | 36.27 | 61.22 | 41.62 | 35.23 | 58.65 | 65.46 |
| Helmet | 65.01 | 82.12 | 64.83 | 79.90 | 63.66 | 60.97 | 67.17 |
| Fish | 64.12 | 25.07 | 18.04 | 61.05 | 23.61 | 16.80 | 66.36 |

### EXAMPLE 37

In this Example 37, to further investigate the generalizability of using fiber fillers to enhance structure retention upon PP to carbon conversion, a series of FDM PP filaments were prepared containing different CF loading from 0 to 10 wt %. These filaments were printed into identical specimens and their shrinkage behaviors were examined. The results of shrinkage measurements are shown in FIG. 106. A clear trend was observed in the in-plane direction where increasing fiber loading, reduced shrinkage from 16% to 14% and 3%, when the CF content increased from 2.5% to 5% and 10%.

Joule heating performance was also assessed to further demonstrate the application of 3D printed carbons from PP-CF filaments. The results are shown in FIG. 107, which indicates that the carbonized structures exhibit joule heating performance which can reach temperatures above 800° C. with only 20 W of supplied power.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A structure comprising:
one or more carbonized materials having a shape based on a polymer based template structure and formed of a chemical compound having the chemical structure: 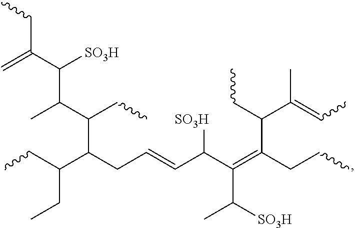
wherein each carbonized material has been crosslinked and has an average pore size diameter of about 10 nm to about 50 nm.

2. The structure of claim 1, wherein each carbonized material has an average pore size diameter of about 15 nm to about 35 nm.

3. The structure of claim 1, wherein the one or more carbonized materials are formed of carbonized polystyrene-block-poly(ethylene-ran-butylene)-block-polystyrene materials.

4. The structure of claim 1, wherein each carbonized material is an ordered mesoporous structure.

5. The structure of claim 1, wherein each carbonized material has a pore structure comprising an average pore size diameter of about 16 nm and an average surface area of about 130 m²/g to about 135 m²/g.

6. The structure of claim 1, wherein each carbonized material has a pore structure comprising an average surface area of greater than about 200 m²/g.

7. The structure of claim 1, wherein the one or more carbonized materials have cylindrical mesopores.

8. The structure of claim 1, wherein the one or more carbonized materials have a CO² adsorption capacity of about 15 cm²/g at 1 bar.

9. A structure comprising:
one or more carbonized materials each formed of a chemical compound having the structure: 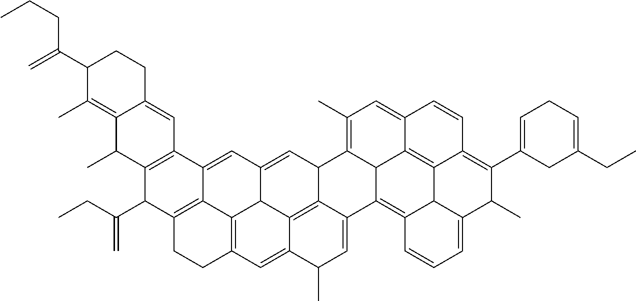 [SMILES: C=C(CCC)C1CCC2=CC3=C(C(C)C2=C1C)C(C(=C)CC)C1=C2C3=CC3=CC4C5=C6C(=CC(=C2C36)CC1)C(C)C=C5C1=C2C=CC=C3C(C)C(C5=CCC=C(CC)C5)=c5ccc6c(c5C32)C1C4=C(C)C=6]
wherein each of the carbonized materials is retains a shape and structure of a template material, wherein each carbonized material has a pore structure comprising an average surface area greater than about 200 m²/g.

10. The structure of claim 9, wherein the template structure is one of a 3D printed structure, a fiber, a porous scaffold, an injection molded structure, an extruded structure, or a compression molded structure formed of a polymer-based material.

11. The structure of claim 10, wherein the polymer-based material is polypropylene-carbon nanofibers.

12. A method of manufacturing carbonized materials comprising the steps of:
preparing a precursor material;
sulfonating the precursor material at a temperature of about 140° C. to about 160° C. to form a sulfonated material for about 2 hours to about 12 hours; and
carbonizing the precursor material at a temperature of about 600° C. to about 800° C. to form a carbonized material.

13. The method of claim 12, further comprising the step of:
calcinating the sulfonated material at a temperature of about 400° C. for about 3 hours.

14. The method of claim 12, wherein carbonizing the sulfonated material further includes:
heating the sulfonated material to a first temperature of about 600° C. at a ramp rate of about 1° C./min; and
heating sulfonated material to a second temperature of about 800° C. at a ramp rate of about 5° C./min.

15. The method of claim 12, wherein preparing the precursor material includes 3D printing an initial structure using polypropelene materials.

16. The method of claim 12, wherein preparing the precursor material includes thermally annealing a SEBS-based material.
